(19) United States
(12) Patent Application Publication
(10) Pub. No.: US 2015/0127317 A1
(43) Pub. Date: May 7, 2015

(54) Method for in silico Modeling of Gene Product Expression and Metabolism

(71) Applicant: The Regents of the University of California, Oakland, CA (US)

(72) Inventors: Daniel R. Hyduke, San Diego, CA (US); Joshua A. Lerman, La Jolla, CA (US); Bernhard O. Palsson, San Diego, CA (US); Edward O'Brien, San Diego, CA (US)

(21) Appl. No.: 14/399,129

(22) PCT Filed: May 9, 2013
(86) PCT No.: PCT/US13/40351

§ 371 Date: Nov. 5, 2014

Related U.S. Application Data
(60) Provisional application No. 61/644,924, filed on May 9, 2012.

(51) Int. Cl. G06F 19/12

(52) U.S. Cl. CPC G06F 19/12
USPC 703/11

(57) ABSTRACT

The present invention provides an integrated model of metabolic and macromolecular expression (ME-Model), and a method for reconstructing an ME-Model from biological data. Specifically, the present invention provides a ME-Model which uses a biochemical knowledgebase of an organism to accurately determine the metabolic and macromolecular phenotype of the organism under different conditions. Further, the present invention provides a method to determine the most efficient conditions for producing a product from an organism.

### BACKGROUND OF THE INVENTION

1. Field of the Invention

The present invention relates generally to biochemical models of living organisms and more specifically to modeling of metabolism and macromolecular expression, and microbial systems biology.

2. Background Information

The genotype-phenotype relationship is fundamental to biology. Historically, and still for most phenotypic traits, this relationship is described through qualitative arguments based on observations or through statistical correlations. Studying the genotype-phenotype relationship demands an appreciation that the relationship is multi-scale, ranging from the molecular to the whole cell. Reductionist approaches to biology have produced ‘parts lists’, and successfully identified key concepts (e.g., central dogma) and specific chemical interactions and transformations (e.g., metabolic reactions) fundamental to life. However, reductionist viewpoints, by definition, do not provide a coherent understanding of whole cell functions. Cellular phenotypes have been programmed into the genome over millions of years based on governing selection pressures. Accordingly, organisms have evolved highly intricate coordinated responses to external signals; these responses include regulated changes in gene expression and enzymatic activity needed to execute the growth process.

An understanding of the biophysical (i.e. physical, spatial, chemical, genetic, thermodynamic, etc.) constraints, both natural and artificial, placed on cellular functions at the genome-scale combined with in silico optimization of cellular fitness allows for approximating phenotypes even in the absence of complete regulatory knowledge. Constraints bridge the gap between system architecture (the cellular reaction network) and system behavior (biological phenotypes), but their definition requires a deep theoretical understanding of interactions among cellular components (including emergent phenotypes). Constraint-based modeling allows one to make testable predictions about biological phenotypes from limited knowledge.

The purpose of modeling a cell is to provide predictions about what will happen when it gets perturbed, either through changes in the environment or genetically through evolution or targeted mutation (i.e. predict response to both natural and artificial perturbations). Escherichia coli (E. coli) is a workhorse for fundamental microbiological studies and various biotechnological applications. Predictive models for E. coli are therefore of great commercial and scientific value. Our earlier experience demonstrated that coupling multiple cellular processes into a single constraint-based model leads to an ability to predict emergent and multi-scale phenotypes.

A goal of systems biology is to provide comprehensive biochemical descriptions of organisms that are amenable to mathematical inquiry. The biochemical descriptions are knowledgebases that are assembled from various biological data sources, including but not limited to biochemical, genetic, genomic, and metabolic; these knowledgebases may then be converted to mathematical models. These models may then be used to investigate fundamental biological questions, guide industrial strain design and provide a systems perspective for analysis of the expanding ocean of “omics” data. Omics data are high-throughput surveys of the molecular components of an organism, including but not limited to mRNA, proteins, and metabolites. Over the past decade, there has been steady progress in developing and applying biochemically-accurate genome-scale models of metabolism (M-Models) for basic research and industrial applications.

M-Models have proved foundational to the development of the field of microbial metabolic systems biology. M-Models have enabled a variety of basic and applied studies. M-Models provide a solution space that contains all possible molecular phenotypes underlying a global phenotype. Because M-Models do not explicitly account for all cellular processes, such as the production of macromolecular machinery of the target cell the M-Model solution space contains a substantial number of biologically-implausible predictions in additional to biologically-plausible predictions. If the production and degradation of the macromolecular machinery is taken into account in chemically accurate terms then we can effectively provide a full genetic basis for every computed molecular phenotype and compare outcomes of computation directly to omics data. The cellular processes of transcription and translation are comprised of a series of elementary chemical transformations that can be reconstructed from available data for target organisms and making them amenable to constraint-based modeling.

The cellular processes of transcription and translation are a series of elementary chemical transformations that depend on metabolism for raw materials and energy, but they create the macromolecular machinery responsible for all cellular functions, including metabolism. A modeling approach that accounts for the production and degradation of a cell's macromolecular machinery in chemically accurate terms will effectively provide a full genetic basis for every computed molecular phenotype (FIG. 1). Such computations in turn enable the direct comparison of simulation to omics data and the simulation of variable expression and enzyme activity. In other words, an integrated model of metabolism and macromolecular expression (ME-Model) will afford a genetically consistent description of a self-propagating organism at the molecular level.

### SUMMARY OF THE INVENTION

The present invention provides an integrated model of metabolic and macromolecular expression (ME-Model), and a method for reconstructing an ME-Model from biological data. Specifically, the present invention provides a ME-Model which uses a biochemical knowledgebase of an organism to accurately determine the metabolic and macromolecular phenotype of the organism under different conditions. Further, the present invention provides a method to determine the most efficient conditions for producing a product from an organism.

The present invention uses two model laboratory microbial organisms, Thermotoga maritima (T. maritima) and E. coli K-12 MG1655, as illustrative examples. T. maritima was chosen due to its small genome size, wide-availability of structural data, and the presence of an M-Model. E. coli was chosen due to the large amount of experimental data available, including, but not limited to, transcription unit architecture, omics data, an M-Model, and a model of gene expression (E-Model). The ME-Model for T. maritima was reconstructed by correcting and updating the available M-Model, reconstructing the processes underlying macromolecular expression, and then coupling the metabolic and macromolecular expression processes. The ME-Model for E. coli K-12 MG1655 was reconstructed by correcting and updating the extant M-Model and E-Model and then coupling the models. Next, constraints were imposed as balances and bounds on the activity and flow of biomolecules through this integrated network. To compute cellular phenotypes with the constrained model, a scalable optimization procedure was developed, which allowed for the prediction of multi-scale phenotypes underlying cellular phenotypes, such as growth control and product formation. This model computes the functional proteome that is required to execute the cellular phenotypes. It computes a variety of data types that are available and provides unity in the field microbial systems biology by reconciling a variety of theories and principles related to cellular growth at various scales of complexity.

In one embodiment, the present invention provides a method for generating a model for determining the metabolic and macromolecular phenotype of an organism. The method includes generating a biochemical knowledgebase of an organism including metabolic and macromolecular synthetic pathways; generating a computational model from the biochemical knowledgebase by applying at least one coupling constraint; using the model to determine the metabolic and macromolecular phenotype of the organism or organisms as a function of genetic and environmental parameters; and computing metabolic and macromolecular changes associated with a perturbation of the organism or the organism's environment, thereby generating a model. The computational model assimilates the metabolic and macromolecular changes caused by the perturbation and then determines the metabolic and macromolecular phenotype of the organism.

In one aspect of the invention, the biochemical knowledgebase includes information regarding the organisms genome, proteome, RNA, metabolic pathways and reactions, biochemical pathways and reactions, energy sources and uses, reaction by-products, protein complexes, reactions to post-translationally modify/functionalize protein complexes, macromolecular synthesis machinery, transcription units, lipid content, metalio-ions, amino acid content, covalent modifications, and non-covalent modifications, or any combination thereof. In another aspect, the knowledgebase includes calculation of a structural reaction using lipid content, metal ion content, energy requirements of the organism, dNTP requirements for production of the organism's genome, ribosome production and doubling time, or any combination thereof. The relative composition of the structural reaction is derived from empirical measurements.

In an additional aspect, the perturbation of the organism or its environment is a change in genetic or environmental parameters. In one aspect, the change in genetic or environmental parameters includes change in the composition of growth media, sugar source, carbon source, growth rate, ribosome production, antibiotic presence, oxygen level, efficiency of macromolecular machinery, subjection to a chemical compound, genetic alteration, forced overproduction of a network component, and inhibition or hyperactivity of at least one enzyme, or any combination thereof. In one aspect, the efficiency of macromolecular machinery includes, but is not limited to, transcription and translation rates, enzyme catalytic rates and transport rates, or any combination thereof. In an aspect, the inhibition or hyperactivity of an enzyme may be caused by an environmental change or genetic perturbation. Further, the environmental change may be the presence or absence of antibiotics and the genetic perturbation may be directed protein engineering of specific chemical residues leading to modulated catalytic efficiency. In another aspect, the inhibition or hyperactivity of an enzyme may be a decrease or increase to an efficiency parameter. In a further aspect, the change in genetic parameters is the addition of heterologous and/or synthetic genetic material.

In certain aspects, the perturbations are subsequently related to the endogenous regulatory network of an organism to determine regulators that may facilitate or interfere with the process of achieving a desired phenotype. In other aspects, the perturbations are related to the endogenous regulatory network to discover new regulatory capacities in the organism.

In a further aspect, the perturbation is at least one change in basic model parameters to characterize the robustness of predictions to changes in the model parameters and determine the most relevant parameters.

In an aspect, the metabolic and macromolecular changes include alterations in gene expression, protein expression, RNA expression, translation, transcription, pathway activation or inactivation, production of metabolic by-products, energy use, growth rate, proteome changes and transcriptome changes or any combination thereof. In specific aspects, metabolic by-products include acetate secretion and hydrogen production; the proteome changes include amino acid incorporation rate, protein production, macromolecular synthesis, ribosomal protein expression, expression of peptide chains, enzyme expression, enzyme activity, RNA to protein mass ratio, protein degradation, post translational protein modification, proteome fluxes, translation and protein expression profile or any combination thereof and the transcriptome changes include gene expression, transcription, functional RNA expression, transcriptome fluxes, transcription rate, gene expression profile, or any combination thereof.

In one aspect of the invention, the coupling constraints may be applied to system boundaries, maximal transcriptional rate for stable RNA and mRNA; relaxing of the requirement that all synthesized components need to be used within the network; mRNA dilution; mRNA degradation or complex dilution; hyperbolic ribosomal catalytic rate; ribosomal dilution rate; RNA polymerase dilution rate; hyperbolic mRNA rate; coupling of mRNA dilution, degradation and translation reactions; coupling of tRNA dilution and charging reactions; macromolecular synthesis machinery dilution rate; and metabolic enzyme dilution rate, or any combination thereof. System boundaries include, but are not limited, to the external environment, interfaces between cellular compartments, interfaces between multi-scale processes, and biophysical limits on the lifetime and efficiency for cellular machinery.

In specific non-limiting examples, the coupling constraint for mRNA dilution is V_{mRNA Dilution}≧aₘₐₓ*V_{mRNA Degradation}; wherein aₘₐₓ is T_{mRNA}/T_{d}; the coupling constraint for mRNA degradation is V_{mRNA Degradation}≧bₘₐₓ*V_{Translation}; wherein bₘₐₓ=1/kₜᵣₐₙₛₗₐₜᵢₒₙ*T_{mRNA}; the coupling constraint for complex dilution is V_{Complex Dilution}≧cₘₐₓ*V_{Complex Usage}; wherein cₘₐₓ=1/k_{cat}*T_{d}; the coupling constraint for the hyperbolic ribosomal catalytic rate is

$${k}_{ribo} = \frac{{c}_{ribosome} \text{?} μ}{μ + {r}_{o} \text{?}} ;$$

$$\text{?} \text{indicates text missing or illegible when filed}$$

the coupling constraint of the ribosomal dilution rate is

$${V}_{Ribosome Dilution} \geq {\sum }_{i} ( \frac{length ( {peptide}_{i} )}{{k}_{ribo} / μ} * {V}_{Translation of {peptide}_{i}} ) ;$$

the coupling constraint of the RNA polymerase dilution rate is

$${V}_{RNAP Dilution} \geq {\sum }_{i} ( \frac{length ( {peptide}_{i} )}{\text{?} / μ} * {V}_{Transcription of {TU}_{i}} ) ;$$

$$\text{?} \text{indicates text missing or illegible when filed}$$

the coupling constraint of coupling of mRNA dilution, degradation and translation reactions is dil_{mRNA}≧α₁deg_{mRNA} and deg_{mRNA}≧α₂trsl_{mRNA}, wherein

$${α}_{1} = \frac{{dil}_{mRNA}}{{deg}_{mRNA}} = \frac{μ [ mRNA ]}{{k}_{deg}^{mRNA} [ mRNA ]} = \frac{μ}{{k}_{deg}^{mRNA}} and$$

$${α}_{2} = \frac{3 {deg}_{mRNA}}{{trsl}_{mRNA}} = \frac{3 {k}_{deg}^{mRNA} [ mRNA ] {m}_{aa}}{μ P} = \frac{3 {k}_{deg}^{mRNA} {Rf}_{mRNA} {m}_{aa}}{μ {Pm}_{nt}} ;$$

the coupling constraint of the hyperbolic mRNA rate is

$${k}_{mRNA} = \frac{{c}_{mRNA} \text{?} \text{?}}{μ + \text{?} \text{?}} ;$$

$$\text{?} \text{indicates text missing or illegible when filed}$$

the coupling constraint of the hyperbolic tRNA efficiency rate is

$${k}_{tRNA} = \frac{{c}_{tRNA} \text{?} \text{?}}{μ + \text{?} \text{?}} ;$$

$$\text{?} \text{indicates text missing or illegible when filed}$$

the coupling constraint of the coupling of tRNA dilution and charging reactions is dil_{tRNA}≧αchg_{tRNA}, wherein

$$α = \frac{{dil}_{tRNA}}{{chg}_{tRNA}} = \frac{{Rf}_{tRNA} {m}_{aa}}{{Pm}_{tRNA}} ;$$

the coupling constraint of the macromolecular synthesis machinery dilution rate is

$${V}_{{Machinery}_{i} Dilution} \geq {\sum }_{i} ( \frac{1}{{k}_{cat} / μ} * {V}_{Use of {Machinery}_{i}} ) ;$$

and the coupling constraint of the metabolic enzyme dilution rate is

$${V}_{Metabolic {Enzyme}_{i} Dilution} \geq {\sum }_{i} ( \frac{1}{\frac{{sasa}_{Metabolic {Enzyme}_{i}}}{μ}} * {V}_{Use of Metabolic {Enzyme}_{i}} )$$

(where, T_{mRNA} is the measured, or assumed, half-life for the mRNA molecule; T_{d} is the organism's doubling time; kₜᵣₐₙₛₗₐₜᵢₒₙ is the rate of translation; k_{cat} is the enzyme's turnover constant; and, V_{mRNA} Dilution, V_{mRNA Degradation}, V_{Translation}, V_{Complex Dilution}, and V_{Complex usage} are reaction fluxes whose values are determined during the simulation procedure; k_{ribo} is the effective ribosomal rate; c_{ribosome} is

$$\frac{{m}_{rr}}{{m}_{aa} {f}_{rRNA}} ;$$

rₒ is the value of the vertical intercept if growth rate and the RNA/protein ratio are plotted (growth on the x-axis and RNA/protein ratio on the y-axis); k_{τ} is the inverse of the slope of the relationship when growth and the RNA/protein ratio are plotted as for determination of rₒ; μ is growth rate; k_{RNAP} is RNA polymerase (RNAP) transcription rate; V_{Ribosome Dilution} is dilution of ribosome; V_{RNAP dilution} is the dilution of RNAP; V_{translation of peptide} is the translation of peptide; V_{transcription of TUi} is the transcription of TUᵢ; length (peptide)i is the length of peptideᵢ; length is the number of nucleotides in TUᵢ; dil_{tRNA} is μ[tRNA] chg_{tRNA} is

$$\frac{μ P}{{m}_{aa}} ;$$

[tRNA] is

$$\frac{{Rf}_{tRNA}}{{m}_{tRNA}} ;$$

dil_{tRNA} is the dilution of mRNA; deg_{mRNA} is the degradation of mRNA; trsl_{mRNA} is translation of protein from mRNA; [mRNA] is mRNA concentration; k_{mRNA} is the mRNA catalytic rate; c_{mRNA} is

$$\frac{{m}_{n t}}{{f}_{mRNA} {m}_{aa}} ;$$

chg_{mRNA} is the charging of tRNA; dil_{tRNA} is the dilution of tRNA; [tRNA] is the tRNA concentration; k_{tRNA} is the tRNA catalytic rate; c_{tRNA} is

$$\frac{{m}_{tRNA}}{{m}_{aa} {f}_{tRNA}} ;$$

V_{machineryi dilution} is the flux of the reaction leading to dilution of machine i; V_{metabolic enzymei dilution} is the flux of the reaction leading to dilution of metabolic enzyme i, V_{use of machineryi} is the sum of all fluxes using machine i; V_{use of metabolic enzymei} is the sum of all fluxes using metabolic enzyme i). The coupling constraint is applied to one or more system boundary conditions resulting in a change in environmental conditions for the organism. The change in environmental conditions includes carbon source, sugar source, nitrogen source, metal source, phosphate source, oxygen level, carbon dioxide level, change in growth media, and the presence of another organism (of the same or different species) or any combination thereof.

In a further aspect, the coupling constraint is a component's efficiency of use. The efficiency of use may be determined by relating the rate of use of a component by the integrated network to its rate of dilution or degradation. The component maybe the ribosome, RNA Polymerase, mRNA, tRNA, or metabolic enzymes. Additionally, the efficiency of use is may be determined using properties of the component including molecular weight, solvent-accessible surface area, number of catalytic sites, kinetic parameters of its catalytic and allosteric sites, and elemental composition or any combination thereof. Additionally, the efficiency of use maybe determined by using the macromolecular composition of the cell. In a further aspect, the mRNA constraint includes the ratio of mRNA dilution/mRNA degradation, the ratio of mRNA degradation/translation rate, and the ratio of mRNA dilution/translation rate, or any combination thereof. Further, the efficiency of use for the mRNA maybe determined using mRNA half-life data, proteomics and transcriptomics data, a ribosome flow model, and ribosome profiling, or any combination thereof.

In one aspect, the coupling constraints provide lower and/or upper bounds on flux ratios.

In one aspect, the organism is a microbial organism. In one aspect, the organism is genetically modified. In non-limiting examples, the organism includes Thermotoga maritima (T. maritima) and Escherichia coli (E. coli).

In an additional aspect, the generation of the model comprises high-precision arithmetic by an optimization solver. Further, the model predicts the organism's maximum growth rate (μ*) in the specified environment, substrate uptake/by-product secretion rates at μ*, biomass yield at μ*, central carbon metabolic fluxes at μ*, and gene product expression levels (both in terms of mRNA and protein) at μ* or any combination thereof.

In another embodiment, the invention provides a model for determining the metabolic and macromolecular phenotype of an organism. The model includes a data storage device which contains a biochemical knowledgebase of the organism; a user input device wherein the user inputs perturbation of the organism or the organism's environment information; a processor having the functionality to compare the biochemical knowledgebase and the perturbation information, then apply at least one coupling constraint thereto to determine the metabolic and macromolecular phenotype of the organism; a visualization display which displays the results of the determination; and an output which provides the metabolic and macromolecular phenotype of the organism. The perturbation information includes metabolic and macromolecular changes.

In one aspect, the biochemical knowledgebase includes information regarding the organism's genome, proteome, DNA, RNA, metabolic pathways and reactions, biochemical pathways and reactions, energy sources and uses, reaction by-products, protein complexes, macromolecular synthesis machinery, transcription units, lipid content, metalio-ions, amino acid content, covalent modifications, and non-covalent modifications, or any combination thereof. In another aspect, the biochemical knowledgebase includes calculation of a structural reaction using lipid content, metal ion content, energy requirements of the organism, ribosome production and doubling time, or any combination thereof.

In an aspect, the perturbation of the organism or its environment is a change in genetic or environmental parameters. In one aspect, the change in genetic or environmental parameters includes change in the composition of growth media, sugar source, carbon source, growth rate, ribosome production, antibiotic presence, oxygen level, efficiency of macromolecular machinery, subjection to a chemical compound, genetic alteration, forced overproduction of a network component, and inhibition or hyperactivity of at least one enzyme or any combination thereof. In one aspect, the efficiency of macromolecular machinery includes, but is not limited to transcription and translation rates, enzyme catalytic rates and transport rates, or any combination thereof. In an aspect, the inhibition or hyperactivity of an enzyme may be caused by an environmental change or genetic perturbation. Further, the environmental change may be the presence or absence of antibiotics and the genetic perturbation is directed protein engineering of specific chemical residues leading to modulated catalytic efficiency. In another aspect, the inhibition or hyperactivity of an enzyme is a decrease or increase to the efficiency parameter. In a further aspect, the change in genetic parameters is the addition of heterologous and/or synthetic genetic material.

In certain aspects, the perturbations are subsequently related to the endogenous regulatory network of the organism to determine regulators that may facilitate or interfere with the process of achieving a desired phenotype. In other aspects, the perturbations are related to the endogenous regulatory network to discover new regulatory capacities in the organism.

In an additional aspect, the metabolic and macromolecular changes include alterations in gene expression, protein expression, RNA expression, translation, transcription, pathway activation or inactivation, production of metabolic by-products, energy use, growth rate, proteome changes and transcriptome changes or any combination thereof. In specific aspects, the metabolic by-products include acetate secretion and hydrogen production; the proteome changes include amino acid incorporation rate, protein production, macromolecular synthesis, ribosomal protein expression, expression of peptide chains, enzyme expression, enzyme activity, RNA to protein mass ratio, protein degradation, post translational protein modification, proteome fluxes, translation and protein expression profile or any combination thereof; and the transcriptome changes include gene expression, transcription, functional RNA expression, transcriptome fluxes, transcription rate, gene expression profile or any combination thereof.

In a further aspect, the coupling constraints may be applied to system boundaries; maximal transcriptional rate for stable RNA and mRNA; relaxing of the requirement that all synthesized components need to be used within the network; mRNA dilution; mRNA degradation or complex dilution; hyperbolic ribosomal catalytic rate; ribosomal dilution rate; RNA polymerase dilution rate; hyperbolic mRNA rate; coupling of mRNA dilution, degradation and translation reactions; coupling of tRNA dilution and charging reactions; macromolecular synthesis machinery dilution rate; and metabolic enzyme dilution rate, or any combination thereof. System boundaries include, but are not limited to the external environment, interfaces between cellular compartments, interfaces between multi-scale processes, and biophysical limits on the lifetime and efficiency for cellular machinery.

The coupling constraint is applied to one or more system boundary conditions resulting in a change in environmental conditions for the organism. Additionally, the change in environmental includes carbon source, sugar source, nitrogen source, metal source, phosphate source, oxygen level, carbon dioxide level, change in growth media, and the presence of another organism (of the same or different species) or any combination thereof.

In a further aspect, the coupling constraint is a component's efficiency of use. The efficiency of use may be determined by relating the rate of use of a component by the integrated network to its rate of dilution or degradation. The component maybe the ribosome, RNA Polymerase, mRNA, tRNA, or metabolic enzymes. Additionally, the efficiency of use is may be determined using properties of the component including molecular weight, solvent-accessible surface area, number of catalytic sites, kinetic parameters of its catalytic and allosteric sites, and elemental composition or any combination thereof. The efficiency of use maybe determined by using the macromolecular composition of the cell. In a further aspect, the mRNA constraint includes the ratio of mRNA dilution/mRNA degradation, the ratio of mRNA degradation/translation rate, and the ratio of mRNA dilution/translation rate, or any combination thereof. Additionally, the efficiency of use for the mRNA maybe determined using mRNA half-life data, proteomics and transcriptomics data, a ribosome flow model, and ribosome profiling, or any combination thereof.

In one aspect, the coupling constraints provide lower and/or upper bounds on flux ratios.

In a further embodiment, the present invention provides a method to determine the metabolic and macromolecular phenotype of an organism. The subject method includes generating a biochemical knowledgebase of the organism; introducing a perturbation to the organism or the organism's environment; using the biochemical knowledgebase to determine the metabolic and macromolecular changes associated with the perturbation and applying at least one coupling constraint; and determining of the metabolic and macromolecular phenotype of the target organism.

In one embodiment, the present invention provides a model for performing a cost estimate analysis of producing a product in an organism. The model includes a data storage device which contains a biochemical knowledgebase of the organism, costs associated with producing the product and price of the product; a user input device wherein the user inputs parameters for producing the product; a processor having the functionality to compare the biochemical knowledgebase and the parameters to determine metabolic and macromolecular changes; apply at least one coupling constraint and perform cost benefit analysis thereto; a visualization display which displays the results of the analysis; and an output which provides the cost estimate analysis.

In a one aspect, the output is a graph or a chart depicting profitability estimate, estimates of key bioprocessing parameters such as feedstock consumption, reactor volume and production formation. In one aspect, the product is a naturally occurring or a recombinant protein. In another aspect, the product is a molecule, such as hydrogen or acetate.

### BRIEF DESCRIPTION OF THE DRAWINGS

FIG. 1 shows that the ME-Models enable new applications of constraint-based modeling. ME-Models afford direct integration of knowledge of organizational structures underlying the transcriptome and proteome. Example non-limiting applications enabled by the subject ME-Modeling approach: (1) modeling recombinant protein production, (2) modeling processes underlying antibiotic-mediated cell death, since the integrated model accounts for the majority of antibiotic targets, and (3) interpreting regulatory circuits in terms of economic efficiency.

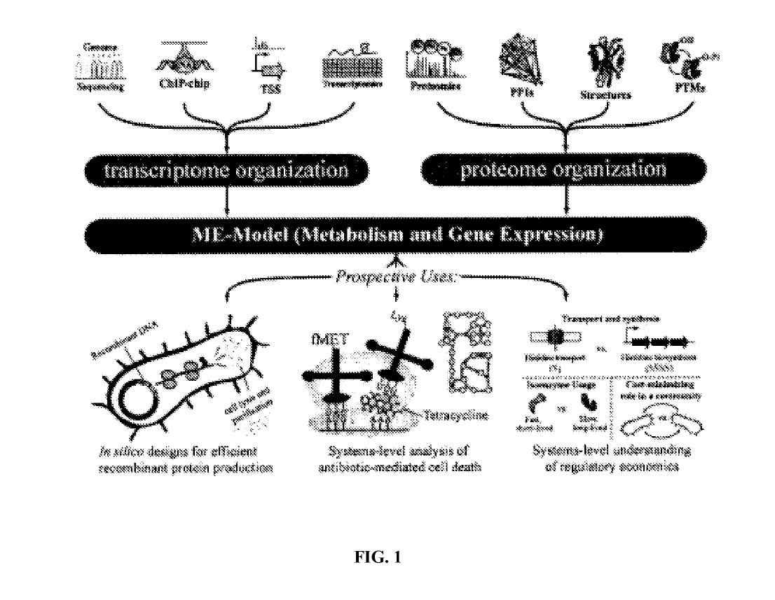

FIGS. 2 (a-d) show genome-scale modeling of metabolism and expression. FIG. 2 (a) Modern stoichiometric models of metabolism (M-models) relate genetic loci to their encoded functions through causal Boolean relationships. The gene and its functions are either present or absent. The dashed arrow signifies incomplete and/or uncertain causal knowledge, whereas solid arrows signify mechanistic coverage. FIG. 2 (b) ME-Models provide links between the biological sciences. With an integrated model of metabolism and macromolecular expression, it is possible to explore the relationships between gene products, genetic perturbations and gene functions in the context of cellular physiology. FIG. 2 (c) Models of metabolism and expression (ME-Models) explicitly account for the genotype phenotype relationship with biochemical representations of transcriptional and translational processes. FIG. 2 (d) When simulating cellular physiology, the transcriptional, translational and enzymatic activities are coupled to doubling time (T_{d}) using constraints that limit transcription and translation rates as well as enzyme efficiency. τ_{mRNA}, mRNA half-life; k_{cat}, catalytic turnover constant; kₜᵣₐₙₛₗₐₜᵢₒₙ, translation rate; ν, reaction flux.

FIGS. 3(a-b) show characteristics of M- and ME-Models objective functions and assumptions. FIG. 3 (a) M-Models simulate constant cellular composition (biomass) as a function of specific growth rate (μ), whereas ME-Models simulate constant structural composition with variable composition of proteins and transcripts. FIG. 3 (b) Linear programming simulations with M-Models are designed to identify the maximum μ that is subject to experimentally measured substrate uptake rates. Only biomass yields are predicted as μ enters indirectly as an input through the supplied substrate uptake rate (see the measurement column for M-Models).

FIGS. 4 (a-e) show that the ME-Model accurately simulates variable cellular composition and efficient use of enzymes. FIG. 4 (a) With the ME-model, the RNA/protein ratio increases linearly with growth rate and with a slope proportional to translational capacity in amino acids per second (circles: 5 AA/s, squares: 10 AA/s, triangles: 20 AA/s). FIG. 4 (b) Ribosomal RNA (rRNA) synthesis increases, relative to total RNA synthesis, with growth rate (symbols as in a). FIG. 4 (c) Ribosomal protein promoter activity increases, relative to total RNA synthesis, with growth rate (symbols as in a). FIG. 4 (d) Random sampling of the M-Model solution space indicates that the M—FIG. 4 (e) Smooth estimate of the density of the flux ranges for the metabolic enzymes that may be simulated while maintaining the objective for efficient growth with a 1% tolerance (M-Model: lower line, ME-Model: upper line). The shaded area denotes biologically unrealistic flux values.

FIGS. 5 (a-c) demonstrated the metabolic reactions required for efficient growth with the ME-Model but not the M-Model. FIG. 5 (a) Recycling of by-products of RNA modifications. Dark arrows: reactions required for optimally efficient growth with the ME-Model, but not the M-Model. Light arrows: active reactions in a single maltose minimal medium simulation shown to put results into pathway context. FIG. 5 (b) CMP produced during mRNA degradation is recycled to CTP using cytidylate kinase (CMPK) and nucleoside-diphosphate kinase (NDK-CDP). Dark arrows: reactions required for optimally efficient growth with the ME-Model, but not the M-Model. FIG. 5 (c) The ME-model uses the canonical glycolytic pathway, whereas with the M-Model can circumvent portions during optimal growth simulations. Dark arrows: reactions required for optimally efficient growth with the ME-Model, but not the M-Model. Light arrows: alternate optimal pathways in the M-Model.

FIGS. 6 (a-d) show that the ME-Model accurately simulates molecular phenotypes during log-phase growth. FIG. 6 (a) The ME-Model accurately simulates H₂ and acetate secretion with maltose uptake when constrained with a measured growth rate (n=2). Experiment: light bars, simulation: dark bars. FIG. 6 (b) The in silico ribosome incorporates the 20 amino acids at rates proportional (Pearson correlation coefficient=0.79; P<4.1×10⁻⁵ t-test) to the bulk amino-acid composition of a T. maritima cell as measured by high-performance liquid chromatography (n=1). FIG. 6 (c) Simulated transcriptome fluxes are significantly (P<2.2×10−16 t-test) and positively correlated (Pearson correlation coefficient=0.54) with semiquantitative in vivo transcriptome measurements (n=4). RNAs containing ribosomal proteins (light circles) were expressed stoichiometrically in simulations but exhibited variability in measurements. FIG. 6 (d) Simulated translation fluxes are significantly (P<2.2×10−16 t-test) and positively correlated (Pearson correlation coefficient=0.57) with semiquantitative in vivo proteomic measurements (n=3). Ribosomal proteins (light circles) were expressed stoichiometrically in simulations but exhibited variability in measurements.

FIGS. 7 (a-d) demonstrate in silico transcriptome profiling drives biological discovery. FIG. 7 (a) In silico comparative transcriptomics identifies sets of genes that are differentially regulated for growth in L-arabinose (L-Arab) versus growth in cellobiose minimal media. FIG. 7 (b) In vivo transcriptome measurements (n=2) confirm the in silico transcriptomics predictions for differential expression of genes when metabolizing L-Arab or cellobiose. FIG. 7 (c) Two distinct putative TF-binding motifs are present upstream of the TUs containing genes differentially expressed in silico when simulating growth in L-Arab versus cellobiose minimal media. Genes (light: not in the model, dark: upregulated by L-arabinose, very dark: upregulated by cellobiose) organized into TUs involved in the shift are shown. Each TU contains a promoter region (circle) arbitrarily taken to be 75 base pairs upstream of the first gene in the TU. Promoters found to contain the AraR or CelR motifs are dark circles and light circles, respectively. FIG. 7 (d) Searching T. maritima 's genome for additional AraR and CelR motifs results in new biological knowledge.

FIGS. 8 (a-c) show the profitability estimate graph for the production of spider silk. FIG. 8(a) shows that in the short term (less than 50 hr) maximum production and profitability occur when the organism is designed to dedicate most of its resources to spider silk production and specific growth rate is less than 0.01 hr⁻¹. FIG. 8(b) shows a substantial decrease in net profits at the higher specific growth rates over an extended period of time. FIG. 8(c) shows that the reduction in profits is due to an exponential increase in the amount of feedstock required to support the microbial population at these later time points.

FIGS. 9 (a-h) show that applying empirically-derived growth demands and coupling constraints leads to accurate predictions of growth rate-dependent changes in ribosome efficiency, qualitatively accurate changes in growth rates as a function of substrate uptake, and qualitatively accurate product yields as a function of growth rate. FIG. 9 (a) Three growth rate-dependent demand functions derived from empirical observations determine the basic requirements for cell replication. FIG. 9 (b) Coupling constraints link gene expression to metabolism through the dependence of reaction fluxes on enzyme concentrations. FIG. 9 (c) RNA:protein ratio predicted by the ME-Model with two different coupling constraint scenarios, one for variable translation rate vs. growth rate (upper line) and one for constant translation rate (lower line). Experimental data in obtained from (Scott et al., 2010, Science, 330, 1099-102). FIG. 9 (d) Phosphotransferase system (PTS) transient activity following a glucose pulse in a glucose-limited chemostat culture (upper triangles) and glucose uptake before the glucose pulse (lower triangles) is plotted as a function of growth rate. FIG. 9 (e) Data from FIG. 9 (d) is used to plot glucose uptake as a fraction of PTS activity. The resulting value is the fractional enzyme saturation (solid line). The fractional enzyme saturation predicted by the ME-Model is plotted as a function of growth rate under carbon-limitation (dotted line). FIG. 9 (f) shows predicted growth rate is plotted as a function of the glucose uptake rate bound imposed in glucose minimal media. Three regions of growth are labeled Strictly Nutrient-Limited (SNL), Janusian, and Batch (i.e., excess of substrate) based on the dominant active constraints (nutrient- and/or proteome-limitation). The behavior of a genome-scale metabolic model (M-Model) is depicted with an arrow. FIG. 9 (g) Experimental (triangle) and ME-Model-predicted (circle) acetate secretion in Nitrogen- (light) and Carbon- (dark) limited glucose minimal medium are plotted as a function of growth rate. Data obtained from (Zhuang et al., 2011, Mol Syst Biol, 7, 500). FIG. 9 (h) Experimental (triangle) and ME-Model-predicted (circle) predicted carbon yield (gDW Biomass/g Glucose) in Carbon- (dark) and Nitrogen- (light) limited glucose minimal medium are plotted as a function of growth rate.

FIG. 10 (a-c) show how ME-Model predictions may be compared to fluxomics data and to assess the flux of substrate carbon source directed towards specific biological processes. FIG. 10 (a) compares nutrient-limited model solutions to chemostat culture conditions. FIG. 10 (b) compares nutrient-limited model solutions to chemostat culture conditions for faster growth. FIG. 10 (c) compares the batch ME-Model solution to batch culture data. Insets show the main flux changes under increasing glucose concentrations. Flux splits shown as insets were computed using the ME-Model.

FIGS. 11 (a-b) show predictions of dynamic changes in gene expression as a function of cellular phenotypes and how these predictions may be investigated to identify coordinated changes in biological functions and proteome composition. FIG. 11 (a) shows ME-Model-computed relative gene-enzyme pair expression is plotted as a function of growth rate; the normalized in silico expression profiles are clustered hierarchically. Solid lines are expression profiles of individual gene-enzyme pairs and dotted black lines are the centroid of each cluster. Each leaf node is qualitatively labeled by function. Asterisks indicate clusters with monotonic expression changes that significantly match the directionality observed in expression data (Wilcoxon signed-rank test, p<1×10−4). FIG. 11 (b) ME-Model-computed fold changes (as a fraction of total proteome content) for all genes expressed in glucose minimal media from growth rates of 0.45 h⁻¹ to 0.93 h⁻¹ (chosen to span the Strictly Nutrient-Limited region) are plotted in rank order (grey points). The error bar for each indicates the median absolute deviation (MAD) from the median fold change, provided this error is at least 2% of the median. Grey labels denote gene groups that are not regulons.

FIGS. 12 (a-e) show how predicted changes in gene expression as a function of time can be visualized to show coordinated changes in biological processes, provide a graphical representation of dynamic changes to specific pathways, and identify transcription factors that may be responsible for shaping the changes in gene expression. FIG. 12 (a) Gene expression changes predicted by the ME-Model to occur in the Janusian growth region indicated in the shaded region under glucose limitation in minimal media are analyzed. FIG. 12 (b) Simulated expression profiles are clustered using signed power (13=25) correlation similarity and average agglomeration. Eleven clusters resulted. Two small clusters were removed because they represented stochastic expression of alternative isozymes. The first principal component of the remaining nine clusters are displayed and grouped qualitatively by function. FIG. 12 (c) Many of the expression modules correspond to genes of central carbon energy metabolism. FIG. 12 (d) Hypergeometric test results for over-representation of transcriptional regulators within a given module compared to a background of all expressed model genes. FIG. 12 (e) Measured changes in the citrate synthase-pyruvate dehydrogenase flux split from ¹³C experiments after transcription factor knockout in glucose batch culture are plotted. Grey points are all experimental values and black points correspond to transcription factors significantly associated with modules in (d). The grey star denotes the wild type flux split.

FIGS. 13(a-b) show how perturbing ME-Model parameters can aid the development of hypotheses to explain discrepancies between the ME-Model and experimental data. FIG. 13 (a) shows how ME-Model parameter analyses can be used to identify biological parameters that explain transcriptome remolding after evolution. The directionality of the change during evolution is shown with arrows. Five different global parameters that affect the maximum growth rate achievable in ME-Model simulations were simulated. FIG. 13 (b) Simulation results combined with gene expression and physiological data from wild-type and evolved strains support an increase in whole-cell k_{eff}.

FIGS. 14 (a-d) show how perturbations to environmental and organismal parameters reshape the metabolic and macromolecular phenotypes and how the simulations can be compared to data or omics data can be used to constrain the simulations. FIG. 14(a) shows simulated changes in fluxes in two different growth media. FIG. 14(b) shows simulated changes in fluxes when simulating production of threonine. Large dots indicate genes that were modulated in a previously engineered strain that produces threonine. FIG. 14(c) shows simulated changes in fluxes when simulating production of a non-natural compound (1,4-butanediol (BDO)) by genetically manipulated E. coli. Large dots indicate enzymes that were modulated in a previously engineered strain that produces BDO. FIG. 14 (d) shows the resulting comparison of the modeled and measured gene expression levels. Genes that are off of the diagonal indicate genes that cannot match measured experimental values with the enzyme kinetic parameters used.

### DETAILED DESCRIPTION OF THE INVENTION

The present invention provides an integrated model of metabolic and macromolecular expression (ME-Model), and a method for reconstructing an ME-Model from biological data. Specifically, the present invention provides a ME-Model which uses a biochemical knowledgebase of an organism to accurately determine the metabolic and macromolecular phenotype of the organism under different conditions. Further, the present invention provides a method to determine the most efficient conditions for producing a product from an organism.

Before the present compositions and methods are described, it is to be understood that this invention is not limited to particular compositions, methods, and experimental conditions described, as such compositions, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”, “an”, and “the” include plural references unless the context clearly dictates otherwise. Thus, for example, references to “the method” includes one or more methods, and/or steps of the type described herein which will become apparent to those persons skilled in the art upon reading this disclosure and so forth.

Unless defined otherwise, all technical and scientific terms used herein have the same meaning as commonly understood by one of ordinary skill in the art to which this invention belongs. Although any methods and materials similar or equivalent to those described herein can be used in the practice or testing of the invention, the preferred methods and materials are now described.

Here, it is shown that the integration of the metabolic and macromolecular expression networks leads to ME-Models that effectively describe the molecular biology of the target cell at a genome-scale along with its metabolic requirements, thus enabling the direct and mechanistic interpretation of omics data. ME-Models are biochemical knowledgebases of the genomic, genetic, biochemical, metabolic, transcriptional, translational, and ancillary biological and chemical processes that necessary to represent metabolism and macromolecular expression for a self-propagating organism. ME-Models allow the full reconciliation of the simultaneous cellular processes that underlie to the function of a cell. The subject ME-Models may be used for (1) modeling recombinant protein production, (2) modeling processes underlying antibiotic-mediated cell death, since the integrated model accounts for the majority of antibiotic targets, and (3) interpreting regulatory circuits in terms of economic efficiency. The ME-Model approximates the content of the transcriptome and proteome in the absence of regulatory constraints with failures being indicative of regulatory constraints.

Thermotoga maritima (T. maritima) is a hyperthermophillic bacterium that is found in one of the deepest branches of Eubacteria. There is substantial interest in developing T. maritima as a model organism for industrial engineering processes due to its ability to metabolize a wide variety of feedstocks into valuable products, including hydrogen gas, H₂. T. maritima is able to produce H₂ near the Thauer limit of 4 moles per mole of glucose, however, H₂ inhibits growths. T. maritima has a small 1.8 Mb genome and supports relatively few transcriptional regulatory states, with only 53 predicted transcription factors. The existence of a few regulatory states may simplify the addition of synthetic capabilities by reducing unexpected and irremediable side-effects and facilitate metabolic engineering efforts. In other words, starting with a minimal genome as a chassis for cellular design will reduce the potential that the features added to the organism will trip an unexpected signal, thus simplifying the addition of synthetic circuits to convert waste streams into valuable products. Efforts are underway to establish genetic tools to facilitate the manipulation of T. maritima and potentially increase growth while sustaining high hydrogen yields, however, no efficient tools exist to date. Quantitative computer models are the basis for large-scale biological design.

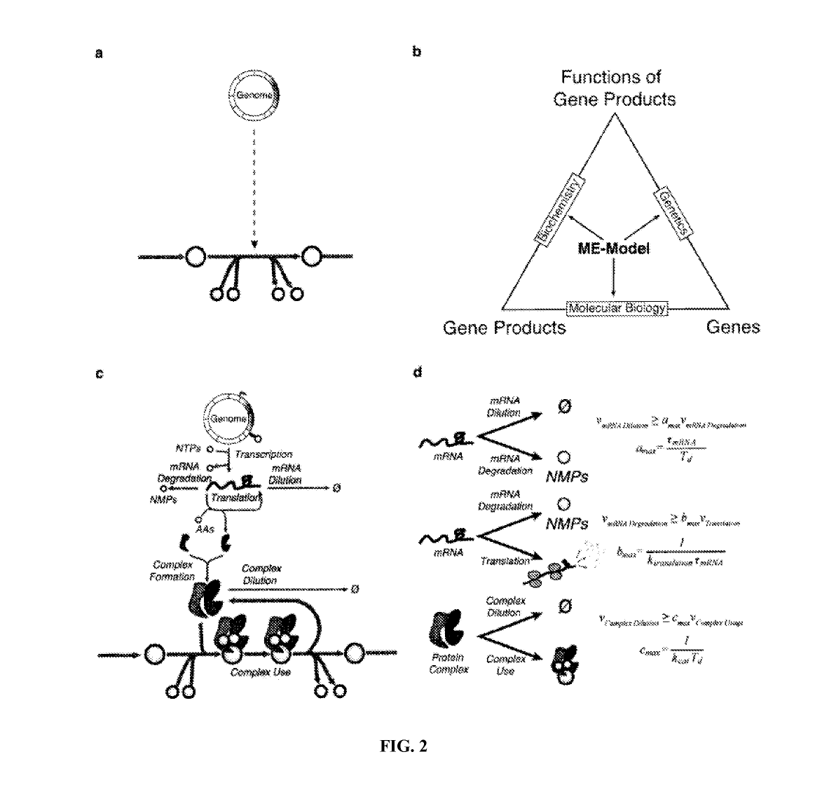

A first step in the establishment of computational tools for modeling T. maritima metabolism was accomplished with the integration of structural genomics data with a metabolic network knowledgebase. The knowledgebase of Biochemically, Genetically, and Genomically (BiGG) consistent knowledgebase of metabolism is an established four step procedure that has been extensively automated. Here, the network knowledgebase procedure was extended to include macromolecular synthesis and post-transcriptional modifications (FIG. 2c). Specifically, the extended knowledgebase accounts for the production of transcription units, stable RNAs (tRNAs, rRNAs, etc.), and peptide chains, as well as the assembly of multimeric proteins and dilution of macromolecules to daughter cells during growth. The scope of cellular behaviors that can be computed for T. maritima has significantly broadened, now that the functions of 653 of its 1,014 annotated genes (−64%) are mechanistically linked.

A similar ME Model was developed using E. coli. The most recent metabolic knowledgebase (M-Model) of E. coli accounts for function of 1366 metabolic genes, which represents approximately 30% of the open reading frames (ORF) in E. coli's genome. Recently, the first genome-scale, stoichiometric network of the transcriptional and translational (tr/tr) machinery of E. coli was constructed (E-Model). The knowledgebase accounts for 303 gene products, including ribosomal proteins, RNA polymerase, tRNA and rRNA. The method prototyped on T. maritima was employed to integrate updated versions of the E. coli M-Model and E-Model into an ME-Model.

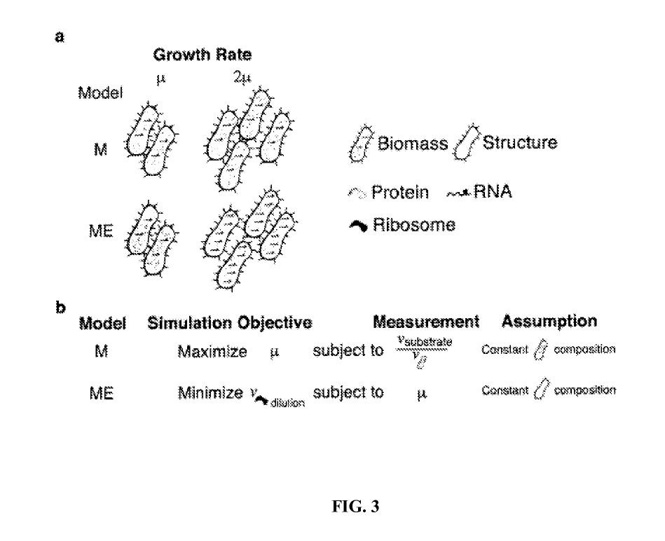

With the formulation of an ME-Model, it is no longer necessary to include gross amino-acid and ribonucleotide compositions in the biomass reaction. In the ME-Model, the biomass requirements are simplified and only contains lipids, metal ions, and energy requirements, that together can be thought of as a structural maintenance requirement. Instead of employing the gross biomass requirement as the optimization target when computationally simulating log-phase growth, ribosome production was employed as the optimization target for the ME-Model (FIG. 3a-b). Ribosome production has been shown to be linearly correlated with growth rate in E. coli. To approximate dilution of transcripts and proteins to daughter cells and prevent infinite translation of peptides from an mRNA we devised a series of coupling constraints. ME-Model optimization targets include all targets accessible to M-Models and a range of new targets, including, but not limited to, ribosome production, synthesis of single or multiple macromolecules, and secretion of byproducts.

As used herein, the terms “omics”, “omics data” and “multi-omics data” includes information from genomics, transcriptomics, proteomics, metabolomics, snpomics, and fluxomics, and other high-throughput measurements of biological components or chemical or physical modifications to the components.

Metabolic models (M-models) represent metabolism in biochemical detail and at a genome-scale, but they do not quantitatively describe gene expression thus do not afford quantitative interpretation of omics data. In M-models an enzyme may carry infinite fluxes, unless vₘₐₓ constraints are imposed, and a simple monomeric enzyme is equivalent to a complex multimeric isozymes. Successful applications of M-models have often focused on numerically simulating the overall production of cellular components required for cell growth's. The organism's gross lipid, nucleotide, amino acid, and cofactors, as well as growth-associated and maintenance ATP usage, are experimentally measured. Then, these measurements are integrated with the organism's doubling time (T_{d}) to define a biomass reaction that approximates the dilution of cellular materials during formation of daughter cells. By employing the biomass formation as an optimality target, it has been possible to simulate quantitatively accurate global phenotypes (e.g., log-phase growth rates, substrate consumption, product formation) for microbes on a variety of carbon sources. As the biomass reaction only provides a gross approximation of cellular components, M-model simulations do not provide explicit predictions for which RNAs and proteins are active and thus causal for the global phenotype.

Metabolic and macromolecular expression models (ME-Models) allow for the explicit analysis and simulation of transcriptomes and proteomes in the context of the underlying reaction network. The incorporation of metabolic and macromolecular analysis reduces the dependence on artificial objective functions, such as the biomass objective function, which do not have a strict biological basis. ME-Models that effectively describe the molecular biology of the target cell at a genome-scale along with its metabolic requirements, thus enabling the direct and mechanistic interpretation of omics data. ME-Models allow the full reconciliation of the simultaneous cellular processes that underlie to the function of a cell. The incorporation of biochemical reactions underlying the expression of gene products within a metabolic network knowledgebase allowed the removal of artificial Boolean gene-protein-reaction and facilitated the simulation of variable enzyme concentrations. This type of model allows the explicit representation of transcription and translation provided an opportunity to directly employ quantitative transcriptomic and proteomic measurements as model constraints.

As used herein the term “metabolic and macromolecular phenotype” refers to metabolic, genetic, biochemical or macromolecular status. This includes, but is not limited to, gene expression, protein expression, enzyme activity, pathway activity, metabolic by-product formation, energy usage or any combination thereof.

As used herein, a structural reaction is used to account for the dilution of structural materials (e.g., DNA, cell wall, lipids, etc.) during cell division and the energy cost associated with the cellular maintenance of the structure. Conceptually, this structural reaction approximates the production of a cell whose composition varies as a function or environment and growth rate. M-models often focus on numerically simulating the overall production of cellular components required for cell growth. The organisms gross lipid, nucleotide, amino acid and cofactors as well as growth-maintenance ATP usage are experimentally measured and then integrated with the organisms doubling time (T_{d}) to define a biomass reaction. In contrast, the subject ME-Model does not require gross amino acid and ribonucleotide compositions in the biomass reaction. The ME-Model relies on a structural reaction using only DNA, lipid, metal ions and energy requirements. As the scope of the knowledgebase increases the number of components in the structural reaction decreases. For example, the structural reaction for T. maritima ME-Model included metal ions, whereas, the structural reaction for the recent E. coli ME-Model did not.

In one embodiment, the present invention provides a method for generating a model for determining the metabolic and macromolecular phenotype of an organism. The method includes generating a biochemical knowledgebase of an organism including metabolic and macromolecular synthetic pathways; generating a computational model from the biochemical knowledgebase by applying at least one coupling constraint; using the model to determine the metabolic and macromolecular phenotype of the organism or organisms as a function of genetic and environmental parameters; and computing metabolic and macromolecular changes associated with a perturbation of the organism or the organism's environment, thereby generating a model. The computational model assimilates the metabolic and macromolecular changes caused by the perturbation and then determines the metabolic and macromolecular phenotype of the organism.

In one aspect of the invention, the biochemical knowledgebase includes information regarding the organism's genome, proteome, RNA, metabolic pathways and reactions, biochemical pathways and reactions, energy sources and uses, reaction by-products, protein complexes, reactions to post-translationally modify/functionalize protein complexes, macromolecular synthesis machinery, transcription units, lipid content, metalio-ions, amino acid content, prosthetic cofactors, covalent modifications, and non-covalent modifications, or any combination thereof. In another aspect, the biochemical knowledgebase includes calculation of a structural reaction using lipid content, metal ion content, energy requirements of the organism, dNTP requirements for production of the organism's genome, ribosome production and doubling time, or any combination thereof. The relative composition of the structural reaction is derived from empirical measurements.

The biochemical knowledgebase contains all known genes, gene products and proteins of an organism. In addition, metabolic reactions are associated with protein complexes. Additionally, the biochemical knowledgebase contains reactions including, but not limited to, transcription, mRNA degradation, translation, protein maturation, RNA processing, protein complex formation, ribosomal assembly, rRNA modification, tRNA modification, tRNA charging, aminoacyl-tRNA synthetase charging, charging EF-Tu (elongation factor), cleavage of polycistronic mRNA to release stable RNA products, demands, tRNA activation and metabolism. The model also includes transcription units (TU), stable RNAs (tRNA, rRNA, etc.) peptide chains, prosthetic groups, covalent modifications, non-covalent modifications, and assembly of multimeric proteins and dilution of macromolecules during cell growth and division. Further, the model accounts for reaction by products and energy usage.

In an additional aspect, the perturbation of the organism or its environment is a change in genetic or environmental parameters. In one aspect, the change in genetic or environmental parameters includes changes in the composition of growth media, sugar source, carbon source, growth rate, ribosome production, antibiotic presence, oxygen level, efficiency of macromolecular machinery, subjection to a chemical compound, genetic alteration, forced overproduction of a network component, and inhibition or hyperactivity of at least one enzyme, or any combination thereof. In one aspect, the efficiency of macromolecular machinery includes, but is not limited to, transcription and translation rates, enzyme catalytic rates and transport rates, or any combination thereof. In an aspect, the inhibition or hyperactivity of an enzyme may be caused by an environmental change or genetic perturbation. Further, the environmental change may be the presence or absence of antibiotics and the genetic perturbation may be directed protein engineering of specific chemical residues leading to modulated catalytic efficiency. In another aspect, the inhibition or hyperactivity of an enzyme may be a decrease or increase to an efficiency parameter. In a further aspect, the change in genetic parameters is the addition of heterologous and/or synthetic genetic material.

In certain aspects, the perturbations are subsequently related to the endogenous regulatory network to determine regulators that may facilitate or interfere with the process of achieving a desired phenotype, such as production of a small metabolite. In other aspects, the perturbations are related to the endogenous regulatory network to discover new regulatory capacities in the target organism.

In a further aspect, the perturbation is at least one change in basic model parameters to characterize the robustness of predictions to changes in the model parameters and determine the most relevant parameters.

In an additional aspect, the metabolic and macromolecular changes include alterations in gene expression, protein expression, RNA expression, translation, transcription, pathway activation or inactivation, production of metabolic by-products, energy use, growth rate, proteome changes and transcriptome changes or any combination thereof. In specific aspects, metabolic by-products include acetate secretion and hydrogen production; the proteome changes include amino acid incorporation rate, protein production, macromolecular synthesis, ribosomal protein expression, expression of peptide chains, enzyme expression, enzyme activity, RNA to protein mass ratio, protein degradation, post translational protein modification, proteome fluxes, translation and protein expression profile or any combination thereof and the transcriptome changes include gene expression, transcription, functional RNA expression, transcriptome fluxes, transcription rate, gene expression profile or any combination thereof.

These changes include increased or decreased expression of enzymes, proteins, genes, RNA or peptide chains; increase or decrease in by-product formation; increase or decrease in enzyme activity; increase or decrease in protein degradation or post translational modification; increase or decrease on transcription or translation; increase or decrease in proteome or transcriptome fluxes and changes in overall transcriptome and proteome profiles and activities.

In a further aspect, the coupling constraints may be applied to system boundaries, maximal transcriptional rate for stable RNA and mRNA; relaxing of the requirement that all synthesized components need to be used within the network; mRNA dilution; mRNA degradation or complex dilution; hyperbolic ribosomal catalytic rate; ribosomal dilution rate; RNA polymerase dilution rate; hyperbolic mRNA rate; coupling of mRNA dilution, degradation and translation reactions; coupling of tRNA dilution and charging reactions; macromolecular synthesis machinery dilution rate; and metabolic enzyme dilution rate, or any combination thereof. System boundaries include, but are not limited to the external environment, interfaces between cellular compartments, interfaces between multi-scale processes, and biophysical limits on the lifetime and efficiency for cellular machinery.

In specific non-limiting examples, the coupling constraint for mRNA dilution is V_{mRNA Dilution}≧aₘₐₓ*V_{mRNA Degradation}; wherein aₘₐₓ is T_{mRNA}/T_{d}; the coupling constraint for mRNA degradation is V_{mRNA Degradation}≧bₘₐₓ*V_{Translation}; wherein bₘₐₓ=1/kₜᵣₐₙₛₗₐₜᵢₒₙ*T_{mRNA}; the coupling constraint for complex dilution is V_{Complex Dilution}≧cₘₐₓ*V_{Complex Usage}; wherein cₘₐₓ=1/k_{cat}*T_{d}; the coupling constraint for the hyperbolic ribosomal catalytic rate is

$${k}_{ribo} = \frac{{c}_{ribosome} \text{?} μ}{μ + \text{?} \text{?}} ;$$

$$\text{?} \text{indicates text missing or illegible when filed}$$

the coupling constraint of the ribosomal dilution rate is

$${V}_{Ribosome Dilution} \geq {\sum }_{i} ( \frac{length ( {peptide}_{i} )}{{k}_{ribo} / μ} * {V}_{Translation of {peptide}_{i}} ) ;$$

the coupling constraint of the RNA polymerase dilution rate is

$${V}_{RNAP Dilution} \geq {\sum }_{i} ( \frac{length ( {TU}_{i} )}{{k}_{rnap} / μ} * {V}_{Transcription of {TU}_{i}} ) ;$$

the coupling constraint of coupling of mRNA dilution, degradation and translation reactions is dil_{mRNA}≧α₁deg_{mRNA} and deg_{mRNA}≧α₂trsl_{mRNA}, wherein

$${α}_{1} = \frac{{dil}_{mRNA}}{{deg}_{mRNA}} = \frac{μ [ mRNA ]}{{k}_{deg}^{mRNA} [ mRNA ]} = \frac{μ}{{k}_{deg}^{mRNA}} and$$

$${α}_{2} = \frac{3 {deg}_{mRNA}}{{trsl}_{mRNA}} = \frac{3 {k}_{deg}^{mRNA} [ mRNA ] {m}_{aa}}{μ P} = \frac{3 {k}_{deg}^{mRNA} {Rf}_{mRNA} {m}_{aa}}{μ {Pm}_{n t}} ;$$

the coupling constraint of the hyperbolic mRNA rate is

$${k}_{m RNA} = \frac{{c}_{mRNA} \text{?} μ}{μ + \text{?} \text{?}} ;$$

$$\text{?} \text{indicates text missing or illegible when filed}$$

the coupling constraint of the hyperbolic tRNA efficiency rate is

$${k}_{tRNA} = \frac{{c}_{tRNA} \text{?} μ}{μ + \text{?} \text{?}} ;$$

$$\text{?} \text{indicates text missing or illegible when filed}$$

the coupling constraint of the coupling of tRNA dilution and charging reactions is dil_{tRNA}≧αchg_{tRNA}, wherein

$$α = \frac{{dil}_{tRNA}}{{chg}_{tRNA }} = \frac{{Rf}_{tRNA} {m}_{aa}}{{Pm}_{tRNA}} ;$$

the coupling constraint of the macromolecular synthesis machinery dilution rate is

$${V}_{{Machinery}_{i} Dilution} \geq {\sum }_{i} ( \frac{1}{{k}_{cat} / μ} * {V}_{Use of {Machinery}_{i}} ) ;$$

and the coupling constraint of the metabolic enzyme dilution rate is

$${V}_{Metabolbic {Enzyme}_{i} Dilution} \geq {\sum }_{i} ( \frac{1}{\frac{{sasa}_{Metabolic {Enzyme}_{i}}}{μ}} * {V}_{Use of Metabolic {Enzyme}_{i}} )$$

(where, T_{mRNA} is the measured, or assumed, half-life for the mRNA molecule; T_{d} is the organism's doubling time; kₜᵣₐₙₛₗₐₜᵢₒₙ is the rate of translation; k_{cat} is the enzyme's turnover constant; and, V_{mRNA} Dilution, V_{mRNA Degradation}, V_{Translation}, V_{Complex Dilution}, and V_{Complex Usage} are reaction fluxes whose values are determined during the simulation procedure; k_{ribo} is the effective ribosomal rate; c_{ribosome} is

$$\frac{{m}_{rr}}{{m}_{aa} {f}_{rRNA}} ;$$

rₒ is the value of the vertical intercept if growth rate and the RNA/protein ratio are plotted (growth on the x-axis and RNA/protein ratio on the y-axis); k_{τ} is the inverse of the slope of the relationship when growth and the RNA/protein ratio are plotted as for determination of rₒ; μ is growth rate; k_{RNAP} is RNA polymerase (RNAP) transcription rate; V_{Ribosome} Dilution is dilution of ribosome; V_{RNAP dilution} is the dilution of RNAP; V_{translation of peptide} is the translation of peptide; V_{transcription of TUi} is the transcription of TUᵢ; length (peptide)i is the length of peptideᵢ; length is the number of nucleotides in TUᵢ; dil_{tRNA} is μ[tRNA]; chg_{tRNA} is

$$\frac{μ P}{{m}_{aa}} ;$$

[tRNA] is

$$\frac{{Rf}_{tRNA}}{{m}_{tRNA}} ;$$

dil_{mRNA} is the dilution of mRNA; deg_{mRNA} is the degradation of mRNA; trsl_{mRNA} is translation of protein from mRNA; [mRNA] is mRNA concentration; k_{mRNA} is the mRNA catalytic rate; c_{mRNA} is

$$\frac{{m}_{n t}}{{f}_{mRNA} {m}_{aa}} ;$$

chg_{mRNA} is the charging of tRNA; dil_{tRNA} is the dilution of tRNA; [tRNA] is the tRNA concentration; k_{tRNA} is the tRNA catalytic rate; c_{tRNA} is

$$\frac{{m}_{tRNA}}{{m}_{aa} {f}_{tRNA}} ;$$

V_{machineryi dilution} is the flux of the reaction leading to dilution of machine i; V_{metabolic enzymei dilution} is the flux of the reaction leading to dilution of metabolic enzyme i, V_{use of machineryi} is the sum of all fluxes using machine i; V_{use of metabolic machineryi} is the sum of all fluxes using metabolic enzyme i). The coupling constraint is applied to one or more system boundary conditions resulting in a change in environmental conditions for the organism. The change in environmental conditions includes carbon source, sugar source, nitrogen source, metal source, phosphate source, oxygen level, carbon dioxide level, change in growth media, and the presence of another organism (of the same or different species) or any combination thereof.

In a further aspect, the coupling constraint is a component's efficiency of use. The efficiency of use may be determined by relating the rate of use of a component by the integrated network to its rate of dilution or degradation. The component maybe the ribosome, RNA Polymerase, mRNA, tRNA, or metabolic enzymes. Additionally, the efficiency of use is may be determined using properties of the component including molecular weight, solvent-accessible surface area, number of catalytic sites, kinetic parameters of its catalytic and allosteric sites, and elemental composition or any combination thereof. The efficiency of use maybe determined by using the macromolecular composition of the cell. In a further aspect, the mRNA constraint includes the ratio of mRNA dilution/mRNA degradation, the ratio of mRNA degradation/translation rate, and the ratio of mRNA dilution/translation rate, or any combination thereof. Additionally, the efficiency of use for the mRNA maybe determined using mRNA half-life data, proteomics and transcriptomics data, a ribosome flow model, and ribosome profiling, or any combination thereof.

In one aspect, the coupling constraints provide lower and/or upper bounds on flux ratios.

Coupling constraints are added to more accurately reflect the metabolic state of the organism. The subject ME-Model uses a mRNA dilution constraint which requires that one mRNA must be removed from the cell for every T_{d}/T_{mRNA} times it is degraded; a mRNA degradation constraint which requires that one mRNA must be degraded every kₜᵣₐₙₛₗₐₜᵢₒₙ*T_{mRNA} times it is translated; and a complex dilution constraint which requires that one complex must be removed from the cell for every k_{cat}*T_{d} times it is used in the network. Other coupling constraints include, but are limited to, constrains on the exchange reactions to simulate different environmental conditions, constraints on the maximal transcription rate for stable and mRNA (vᵢ: vᵢₘᵢₙ≦vᵢ≦vᵢₘₐₓ) and coupling constrains on reactions in the form of v₄−cₘᵢₙ*vₛ≧−s,s≧0 and v₄−cₘₐₓ*vₛ≦0. Details regarding these constraints and their derivations are provided in the examples.

The term “organism” refers both to naturally occurring organisms and to non-naturally occurring organisms, such as genetically modified organisms. An organism can be a virus, a unicellular organism, or a multicellular organism, and can be either a eukaryote or a prokaryote. Further, an organism can be an animal, plant, protist, fungus or bacteria. Exemplary organisms include, but are not limited to bacterial organisms, which include a large group of single-celled, prokaryote microorganisms, and archeal organisms, which include a group of single-celled microorganisms. Bacterial organisms also include gram negative bacteria, gram positive bacteria, pathogenic bacteria, electrosynthetic bacteria and photosynthetic bacteria. Additional examples of bacterial organisms include, but are not limited to, Acinetobacter baumannii, Acinetobacter baylyi, Bacillus subtilis, Buchnera aphidicola, Chromohalobacter salexigens, Clostridium acetobutylicum, Clostridium beijerinckii, Clostridium thermocellum, Corynebacterium glutamicum, Dehalococcoides ethenogenes, Escherichia coli, Francisella tularensis, Geobacter metallireducens, Geobacter sulfurreducens, Haemophilus influenza, Helicobacter pylori, Klebsiella pneumonia, Lactobacillus plantarum, Lactococcus lactis, Mannheimia succiniciproducens, Mycobacterium tuberculosis, Mycoplasma genitalium. Neisseria meningitides, Porphyromonas gingivalis, Pseudomonas aeruginosa, Pseudomonas putida, Rhizobium etli, Rhodoferax ferrireducens, Salmonella typhimurium, Shewanella oneidensis, Staphylococcus aureus, Streptococcus thermophiles, Streptomyces coelicolor, Synechocystis sp. PCC6803, Thermotoga maritima, Vibrio vulnificus, Yersinia pestis, Zymomonas mobilis, Halobacterium salinarum, Methanosarcina barkeri, Methanosarcina acetivorans, Methanosarcina acetivorans, Natronomonas pharaonis, Arabidopsis thaliana, Aspergillus nidulans, Aspergillus niger, Aspergillus oryzae, Cryptosporidium hominis, Chlamydomonas reinhardtii.

Organisms are ordinarily grown in media containing nutrients. Growth media is the media which provides the nutrients that an organism requires for growth. Generally, undefined growth media contains a source of amino acids and nitrogen (e.g., beef, yeast extract). This is an undefined medium because the amino acid source contains a variety of compounds with the exact composition being unknown. Nutrient media contain all the elements that most bacteria need for growth and are non-selective, so are used for the general cultivation and maintenance of bacteria kept in laboratory culture collections. An undefined medium (also known as a basal or complex medium) is a medium that contains a carbon source such as glucose for bacterial growth, water and various salts needed for bacterial growth. Minimal media are those that contain the minimum nutrients possible for colony growth, generally without the presence of amino acids. Minimal medium typically contains a carbon source for bacterial growth, which may be a sugar such as glucose, or a less energy-rich source like succinate; various salts, which may vary among bacteria species and growing conditions; these generally provide essential elements such as magnesium, nitrogen, phosphorus, and sulfur to allow the bacteria to synthesize protein and nucleic acid and water. The growth media may be supplemented with other factors such as amino acids, sugars and antibiotics for example.

In one aspect, the organism is a microbial organism. In one aspect, the organism is genetically modified. In non-limiting examples, the organism includes Thermotoga maritima (T. maritima) and Escherichia coli (E. coli).

In an additional aspect, the generation of the model comprises high-precision arithmetic by an optimization solver. Further, the model predicts the organism's maximum growth rate (μ*) in the specified environment, substrate uptake/by-product secretion rates at μ*, biomass yield at μ*, central carbon metabolic fluxes at μ*, and gene product expression levels (both in terms of mRNA and protein) at μ* or any combination thereof. High precision arithmetic is >64-bit computing or relying on an iterative refinement procedure.

As described in the examples, ME-Model for T. maritima simulates changes in cellular composition with growth rate, in agreement with previously reported experimental findings. Positive correlations were observed between in silico and in vivo transcriptomes and proteomes for the 651 genes in our ME-Model with statistically significant (p<1×10⁻⁵ t-test) Pearson Correlation Coefficients (PCC) of 0.54 and 0.57, respectively. And, when the subject ME-Model was used as an exploratory platform for an in silico comparative transcriptomics study, it was discovered putative transcription factor (TF) binding motifs and regulons associated with L-arabinose (L-Arab) and cellobiose metabolism, and improved functional and transcription unit (TU) architecture annotation. Further, a ME-Model for E. coli was used to simulate growth rates, substrate reuptake rates, oxygen uptake rates, central carbon fluxes, by-product secretion, phenotypic changes arising from adaptive evolution, macromolecular expression under nutrient limitation and nutrient excess, and demonstrated a correlation between effective in silico and in vivo codon usage. Overall, ME-Models provide a chemically and genetically consistent description of an organism, thus they begin to bridge the gap currently separating molecular biology and cellular physiology.

In another embodiment, the invention provides a model for determining the metabolic and macromolecular phenotype of an organism. The model includes a data storage device which contains a biochemical knowledgebase of the organism; a user input device wherein the user inputs perturbation of the organism or the organism's environment information; a processor having the functionality to compare the biochemical knowledgebase and the perturbation information, then apply at least one coupling constraint thereto to determine the metabolic and macromolecular phenotype of the organism; a visualization display which displays the results of the determination; and an output which provides the metabolic and macromolecular phenotype of the organism. The perturbation information includes metabolic and macromolecular changes.

A storage device is a device for recording (storing) information (data). Storing can be done using virtually any form of energy, spanning from manual muscle power in handwriting, to acoustic vibrations in phonographic recording, to electromagnetic energy modulating magnetic tape and optical discs. A storage device may hold information, process information, or both. A device that only holds information is a storing medium. Devices that process information (data storage equipment) may either access a separate portable (removable) recording medium or a permanent component to store and retrieve information. Electronic data storage requires electrical power to store and retrieve that data. Most storage devices that do not require vision and a brain to read data fall into this category. Electromagnetic data may be stored in either an analog or digital format on a variety of media. This type of data is considered to be electronically encoded data, whether or not it is electronically stored in a semiconductor device, for it is certain that a semiconductor device was used to record it on its medium. Most electronically processed data storage media (including some forms of computer data storage) are considered permanent (non-volatile) storage, that is, the data will remain stored when power is removed from the device. In contrast, most electronically stored information within most types of semiconductor (computer chips) microcircuits are volatile memory, for it vanishes if power is removed.

A user input device is device is any peripheral (piece of computer hardware equipment) used to provide data and control signals to an information processing system such as a computer or other information appliance. Examples of input devices include keyboards, mice, scanners, digital cameras and joysticks.

A processor is a device that performs calculations or other manipulations of data. Data processing is any process that uses a computer program to enter data and summarize, analyze or otherwise convert data into usable information. It involves recording, analyzing, sorting, summarizing, calculating, disseminating and storing data. Because data are most useful when well-presented and actually informative, data-processing systems are often referred to as information systems. Scientific data processing usually involves a great deal of computation (arithmetic and comparison operations) upon a relatively small amount of input data, resulting in a small volume of output. This refers to a class of programs that organize and manipulate data, usually large amounts of numeric data.

“Visualization device” is any device on which the results of the data analysis are displayed.

The output can be a graph, chart, list or any other output which describes the metabolic and molecular phenotype of the organism.

In one aspect of the invention, the biochemical knowledgebase includes information regarding the organism's genome, proteome, RNA, metabolic pathways and reactions, biochemical pathways and reactions, energy sources and uses, reaction by-products, protein complexes, macromolecular synthesis machinery, transcription units, lipid content, metalio-ions, amino acid content, prosthetic cofactors, covalent modifications, and non-covalent modifications, or any combination thereof. In another aspect, the biochemical knowledgebase includes calculation of a structural reaction using lipid content, metal ion content, energy requirements of the organism, ribosome production and doubling time, or any combination thereof. The relative composition of the structural reaction is derived from empirical measurements.

In an aspect, the perturbation of the organism or its environment is a change in genetic or environmental parameters. In one aspect, the change in genetic or environmental parameters includes changes in the composition of growth media, sugar source, carbon source, growth rate, ribosome production, antibiotic presence, forced overproduction of a network component, oxygen level, efficiency of macromolecular machinery, subjection to a chemical compound, genetic alteration and inhibition or hyperactivity of at least one enzyme, or any combination thereof. In one aspect, the efficiency of macromolecular machinery includes, but is not limited to transcription and translation rates, enzyme catalytic rates and transport rates, or any combination thereof. In an aspect, the inhibition or hyperactivity of an enzyme may be caused by an environmental change or genetic perturbation. Further, the environmental change may be the presence or absence of antibiotics and the genetic perturbation is directed protein engineering of specific chemical residues leading to modulated catalytic efficiency. In another aspect, the inhibition or hyperactivity of an enzyme is a decrease or increase to the efficiency parameter. In a further aspect, the change in genetic parameters is the addition of heterologous and/or synthetic genetic material.

In certain aspects, the perturbations are subsequently related to the endogenous regulatory network to determine regulators that may facilitate or interfere with the process of achieving a desired phenotype. In other aspects, the perturbations are related to the endogenous regulatory network to discover new regulatory capacities in the target organism.

Input device is any device in which information is inputted in to a system.

In an additional aspect, the metabolic and macromolecular changes include alterations in gene expression, protein expression, RNA expression, translation, transcription, pathway activation or inactivation, production of metabolic by-products, energy use, growth rate, proteome changes and transcriptome changes or any combination thereof. In specific aspects, the metabolic by-products include acetate secretion and hydrogen production; the proteome changes include amino acid incorporation rate, protein production, macromolecular synthesis, ribosomal protein expression, expression of peptide chains, enzyme expression, enzyme activity, RNA to protein mass ratio, protein degradation, post translational protein modification, proteome fluxes, translation and protein expression profile or any combination thereof; and the transcriptome changes include gene expression, transcription, functional RNA expression, transcriptome fluxes, transcription rate, gene expression profile or any combination thereof.

In a further aspect, the coupling constraints may be applied to system boundaries; maximal transcriptional rate for stable RNA and mRNA; relaxing of the requirement that all synthesized components need to be used within the network; mRNA dilution; mRNA degradation or complex dilution; hyperbolic ribosomal catalytic rate; ribosomal dilution rate; RNA polymerase dilution rate; hyperbolic mRNA rate; coupling of mRNA dilution, degradation and translation reactions; coupling of tRNA dilution and charging reactions; macromolecular synthesis machinery dilution rate; metabolic enzyme dilution rate, or any combination thereof. System boundaries include, but are not limited to the external environment, interfaces between cellular compartments, interfaces between multi-scale processes, and biophysical limits on the lifetime and efficiency for cellular machinery.

In specific non-limiting examples, the coupling constraint for mRNA dilution is V_{mRNA Dilution}≧aₘₐₓ*V_{mRNA Degradation}; wherein aₘₐₓ is T_{mRNA}/T_{d}; the coupling constraint for mRNA degradation is V_{mRNA Degradation}≧bₘₐₓ*V_{Translation}; wherein bₘₐₓ=1/kₜᵣₐₙₛₗₐₜᵢₒₙ*T_{mRNA}; the coupling constraint for complex dilution is V_{Complex Dilution}≧cₘₐₓ*V_{Complex Usage}; wherein cₘₐₓ=1/k_{cat}*T_{d}; the coupling constraint for the hyperbolic ribosomal catalytic rate is

$${k}_{ribo} = \frac{{C}_{ribosome} {κ}_{τ} μ}{μ + {r}_{o} {κ}_{τ}} ;$$

the coupling constraint of the ribosomal dilution rate is

$${V}_{Ribosome Dilution} \geq {\sum }_{i} ( \frac{length ( {peptide}_{i} )}{{k}_{ribo} / μ} * {V}_{Translation of {peptide}_{i}} ) ;$$

the coupling constraint of the RNA polymerase dilution rate is

$${V}_{RNAP Dilution} \geq {\sum }_{i} ( \frac{length ( {TU}_{i} )}{{l}_{rnap} / μ} * {V}_{Transcription of {TU}_{i}} ) ;$$

the coupling constraint of coupling of mRNA dilution, degradation and translation reactions is dil_{mRNA}≧α₁deg_{mRNA} and deg_{mRNA}≧α₂trsl_{mRNA}, wherein

$${α}_{1} = \frac{d {il}_{mRNA}}{d {eg}_{mRNA}} = \frac{μ [ mRNA ]}{{k}_{deg}^{mRNA} [ mRNA ]} = \frac{μ}{{k}_{deg}^{mRNA}}$$

$$and$$

$${α}_{2} = \frac{3 {deg}_{mRNA}}{{trsl}_{mRNA}} = \frac{3 {k}_{deg}^{mRNA} [ mRNA ] {m}_{aa}}{μ P} = \frac{3 {k}_{deg}^{mRNA} {Rf}_{mRNA} {m}_{aa}}{μ {Pm}_{nt}} ;$$

the coupling constraint of the hyperbolic mRNA rate is

$${k}_{mRNA} = \frac{{c}_{mRNA} {κ}_{τ} μ}{μ + {r}_{o} {κ}_{τ}} ;$$

the coupling constraint of the hyperbolic tRNA efficiency rate is

$${k}_{tRNA} = \frac{{c}_{τ RNA} {κ}_{τ} μ}{μ + {r}_{o} {κ}_{τ}} ;$$

the coupling constraint of the coupling of tRNA dilution and charging reactions is dil_{tRNA}≧αchg_{tRNA}, wherein

$$α = \frac{{dil}_{tRNA}}{{chg}_{tRNA}} = \frac{{Rf}_{tRNA} {m}_{aa}}{{Pm}_{tRNA}} ;$$

the coupling constraint of the macromolecular synthesis machinery dilution rate is

$${V}_{{Machinery}_{i} Dilution} \geq {\sum }_{i} ( \frac{1}{{k}_{cat} / μ} * {V}_{Use of {Machinery}_{i}} ) ;$$

and the coupling constraint of the metabolic enzyme dilution rate is

$${V}_{{MetabolicEnzyme}_{i} Dilution} \geq {\sum }_{i} ( \frac{1}{\frac{{sasa}_{Metabolic {Enzyme}_{i}}}{μ}} * {V}_{Use of Metabolic {Enzyme}_{i}} )$$

(where, T_{mRNA} is the measured, or assumed, half-life for the mRNA molecule; T_{d} is the organism's doubling time; kₜᵣₐₙₛₗₐₜᵢₒₙ is the rate of translation; k_{cat} is the enzyme's turnover constant; and, V_{mRNA} Dilution, V_{mRNA Degradation}, V_{Translation}, V_{Complex Dilution}, and V_{Complex Usage} are reaction fluxes whose values are determined during the simulation procedure; k_{ribo} is the effective ribosomal rate; c_{ribosome} is

$$\frac{{m}_{rr}}{{m}_{aa} {f}_{rRNA}} ;$$

rₒ is the value of the vertical intercept if growth rate and the RNA/protein ratio are plotted (growth on the x-axis and RNA/protein ratio on the y-axis); k_{cat} is the inverse of the slope of the relationship when growth and the RNA/protein ratio are plotted as for determination of rₒ; μ is growth rate; k_{RNAP} is RNA polymerase (RNAP) transcription rate; V_{Ribosome} Dilution is dilution of ribosome; V_{RNAP dilution} is the dilution of RNAP; V_{translation of peptide} is the translation of peptide; V_{transcription of TUi} is the transcription of TUᵢ; length (peptide)i is the length of peptideᵢ; length TUᵢ is the number of nucleotides in TUᵢ; dil_{tRNA} is μ[tRNA]; chg_{tRNA} is

$$\frac{μ P}{{m}_{aa}} ;$$

[tRNA] is

$$\frac{{Rf}_{tRNA}}{{m}_{tRNA}} ;$$

dil_{mRNA} is the dilution of mRNA; deg_{mRNA} is the degradation of mRNA; trsl_{mRNA} is translation of protein from mRNA; [mRNA] is mRNA concentration; is the mRNA catalytic rate; c_{mRNA} is

$$\frac{{m}_{nt}}{{f}_{mRNA} {m}_{aa}} ;$$

chg_{mRNA} is the charging of tRNA; dil_{tRNA} is the dilution of tRNA; [tRNA] is the tRNA concentration; k_{tRNA} is the tRNA catalytic rate; c_{tRNA} is

$$\frac{{m}_{tRNA}}{{m}_{aa} {f}_{tRNA}} ;$$

V_{machineryi dilution} is the flux of the reaction leading to dilution of machine i; V_{metabolic enzymei dilution} is the flux of the reaction leading to dilution of metabolic enzyme i, V_{use of machineryi} is the sum of all fluxes using machine i; V_{use of metabolic enzymei} is the sum of all fluxes using metabolic enzyme i). The coupling constraint is applied to one or more system boundary conditions resulting in a change in environmental conditions for the organism. The change in environmental conditions includes carbon source, sugar source, nitrogen source, metal source, phosphate source, oxygen level, carbon dioxide level, change in growth media, and the presence of another organism (of the same or different species) or any combination thereof.

In one aspect, the coupling constraints provide lower and/or upper bounds on flux ratios.

In a further embodiment, the present invention provides a method to determine the metabolic and macromolecular phenotype of an organism. The subject method includes generating a biochemical knowledgebase of the organism; introducing a perturbation to the organism or the organism's environment; using the biochemical knowledgebase to determine the metabolic and macromolecular changes associated with the perturbation and applying at least one coupling constraint; and determining of the metabolic and macromolecular phenotype of the target organism.

In one embodiment, the present invention provides a model for performing a cost estimate analysis of producing a value added product in an organism. The subject model includes a data storage device which contains a biochemical knowledgebase of the organism, costs associated producing the product and price of the product; a user input device wherein the user inputs parameters for producing the product; a processor having the functionality to compare the biochemical knowledgebase and the parameters to determine metabolic and macromolecular changes; apply at least one coupling constraint and perform cost benefit analysis thereto; a visualization display which displays the results of the analysis; and an output which provides the cost estimate analysis.

In a one aspect, the output is a graph or a chart depicting profitability estimate, estimates of key bioprocessing parameters such as feedstock consumption, reactor volume, production formation, copy number, catalytic efficiency, and cellular growth rate.

In a one aspect, the output is a graph or a chart depicting profitability estimate, estimates of key bioprocessing parameters such as feedstock consumption, reactor volume and production formation. In one aspect, the product is a naturally occurring or a recombinant protein. In another aspect, the product is a molecule, such as hydrogen or acetate.

As described in the examples, the subject ME-Model was used to determine the conditions for the best profitability for the production of spider silk. The model indicated that in the short term (less than 50 hr) maximum production and profitability occur when the organism is designed to dedicate most of its resources to spider silk production and specific growth rate is less than 0.01 hr⁻¹. There was also a substantial decrease in net profits at the higher specific growth rates over an extended period of time. It was determined that the reduction in profits is due to an exponential increase in the amount of feedstock required to support the microbial population at these later time points.

The following examples are intended to illustrate, but not limit the invention.

### Example 1

### Generation of a Biochemical Knowledgebase

The metabolic content for the biochemical knowledgebase was based on the previously published model (Zhang et al. (2009), Science 325:1544; Thiele et al. (2010), Nature Protocols 5:93) with updates to keep the network current with available literature. In associating metabolic reactions with protein complexes, cases were encountered where the metabolic model from Zhang et al. indicated a protein complex that hasn't been observed for T. maritima; these cases may have arisen from the Zhang et al. model using E. coli's metabolic model as the template. In these cases, a protein complex was assigned but denoted it low confidence. In addition to metabolism, the model contained reactions representing: transcription of TUs, TU degradation, translation, protein maturation, transcription, mRNA degradation, transcription, translation, protein maturation, RNA processing, protein complex formation, ribosomal assembly, rRNA modification, tRNA modification, tRNA charging, aminoacyl-tRNA synthetase charging, charging EF-TU, cleavage of polycistronic mRNA to release stable RNA products, demands, tRNA activation (EF-TU), and metabolism. Reversible reactions were split into two separate reactions representing each direction.

Macromolecular Synthesis Machinery

The molecular machines (e.g., proteins, genes, RNAs) involved in macromolecular synthesis were identified from the genome annotation, SEED subsystem analysis, comparative genomics analysis of the E. coli models, KEGG, and PubMed and Google Scholar searches for “T. maritima, or Thermotogales” and “transcription or translation.” The E. coli knowledgebase had 194 protein ORFs and SEED found 144 (74%) homologous proteins in T. maritima. Proteins used by T. maritima, but not E. coli, in transcription or translation were also identified (SI Table S5). Bi-directional best BLAST hits in T. maritima 's proteome to transcription/translation proteins from Bacillus subtilis were also used to prime specific literature searches to reduce bias introduced by using the E. coli model as a search parameter. Additionally, the annotation strings were manually checked for the remaining proteins to ensure no key transcription/translation machinery were omitted.

The functions of each of the 159 proteins associated with macromolecular synthesis in T. maritima were determined by primary literature when available. When no primary literature was available, the Uniprot and SEED databases (http://www.uniprot.org/ and http://www.theseed.org/) were used to infer function by homology. In a few instances, structural alignments were performed using the tool FATCAT to support the assessment of homologous function. The functions of 148 genes (˜93% of genes known to be involved in macromolecular synthesis in this organism) are linked in our final integrated model.

Protein Complexes

For each protein machine, primary literature and the RCSB Protein Data Bank (PDB) were used to determine whether the machine was a monomer or oligomer. The PDB entries also provided an opportunity to integrate 3-D structural data into the knowledgebase (this model includes structures for 32 additional ORFs compared to Zhang et al). When structures and states were unavailable for the protein of interest, orthologs in closely related organisms were considered when possible. Otherwise, the Uniprot database was consulted. When no information was available, the protein was assumed to act as a monomer and this assumption was noted in the model.

Transcription Unit Architecture

T. maritima has a genome organized by transcription units (TUs). Unfortunately, T. maritima 's TU architecture is far from being enumerated thus bioinformatics methods were required in addition to primary literature. The draft knowledgebase of the transcription unit architecture of T. maritima was achieved using ‘OR’ logic applied over a set of conditions. A TU would start with a gene and then proceed until one of the following conditions was met:

Rule 1: Two genes are found in convergent orientation on different strands.

Rule 2: Two genes are found in divergent orientation on different strands.

The convergent and divergent criteria were chosen because it is rare to see experimentally annotated TUs with these features. This procedure did not contradict any experimentally annotated TUs in T. maritima.

Rule 3: A high-confidence Rho-independent transcription terminator is found separating two genes oriented in series on the same strand.

Intrinsic terminators were predicted using the TransTermHP database (http://transterm.cbcb.umd.edu/). T. maritima uses the intrinsic RNA mechanism for transcriptional termination at many TU boundaries. Only terminator structures called with a “100%” confidence score were included.

Rule 4: More than 55 base pairs (bps) separate two genes in series on the same strand.

Among the many features used to predict operons, intergenic distance was found to be the best single predictor of operons in bacteria. Genes belonging to the same operon tend to exhibit small intergenic distance. In contrast, genes not in the same operon have a more uniform distribution of intergenic distance. In E. coli, the log-likelihood of finding two adjacent genes in a single TU plummets at an intergenic distance of 55 bp, thus 55 bp was chosen as the cutoff. For stable RNA operons this rule was not followed because stable RNAs frequently rely on the Rho protein for termination, and that could not be assessed for the current study. Additionally, in examining the distribution of intergenic distances around RNA genes, the distance metric does not appear to be of much use in these cases.

Rule 5: A high-confidence promoter region is found separating two genes oriented in series on the same strand.

It was assumed that there is no reason to keep two genes structurally linked if a promoter region is present. For prediction of promoters, we scanned 400 bp upstream of each ORF (or to the start of the previous gene) for the regular expression “TTGACA 16-18 bp TATAAT”. The spacer between these two boxes can be any sequence of the four nucleotides 16-18 bps in length. This regular expression corresponds a well-conserved bacterial promoter region.

Rule 6: An experimentally annotated stop is found after a gene.

TU prediction has only moderate statistical power. A few TUs determined experimentally were included.

All TUs are taken to be leaderless (no 51 extension) unless primary literature indicated the exact transcription start site and a TU would start with a gene and then proceed until one of the conditions was met.

Computational Methods

A custom Python (www.python.org) modules was built to construct an integrated model of Metabolism and Expression (ME-Model) from the previously published metabolic models, the T. maritima genome, and the rules described above. Because of numerical difficulties associated & with the range of parameters in our model precluded the use of inexact numerical solvers, we used an exact solver, QSopt_ex, with its default parameter settings. The LP problem file used for maltose minimal medium simulations, is provided as Supplement TMA_ME_v1.0_maltose_minimalJp.bz. Simulations involving only the metabolic portion from Zhang et al.'s were performed with the ILOG/CPLEX solver.

Derivation of the Coupling Constraints

a: mRNA Dilution

V_{mRNA Dilution}≧aₘₐₓ*V_{mRNA Degradation}

Coupling constraint #1 approximates the passage of intact transcription units to daughter cells during cell division. This constraint ensures that the in silica cell incurs a material cost for mRNAs; otherwise, the cell only pays the energetic cost of converting NMPs to NTPs. Here, are all of the assumptions required to arrive at the coupling constraint given above and derive a biological Interpretation of the coupling parameter aₘₐₓ:
Denote the mean lifetime of the mRNA molecule T_{mRNA} and the doubling time of the cell T_{d}. Assume that both are given in units of minutes.
An mRNA can cycle (undergo synthesis, degradation, and re-synthesis into the same mRNA) a maximum number of times during the fixed cell doubling time. Mathematically, the number of cycles is bounded above by the scalar T_{d}/T_{mRNA}
Coupling constraint #1 is readily imposed with aₘₐₓ=T_{mRNA}/T_{d}.

Coupling constraint a is interpreted to mean: “one mRNA must be removed from the cell for every T_{d}/T_{mRNA} times it is degraded”

b: mRNA Degradation

V_{mRNA Degradation}≧bₘₐₓ*V_{Translation}; wherein bₘₐₓ=1/kₜᵣₐₙₛₗₐₜᵢₒₙ*T_{mRNA}.

Coupling constraint b is to place an upper limit on the number of peptides produced per mRNA. In order to implement this constraint, we require an mRNA to pass through its degradation reaction once it has reached the limit. Here are all of the assumptions required to arrive at the coupling constraint given above and derive a biological interpretation of the coupling parameter bₘₐₓ.

The mean lifetime of an mRNA molecule is denoted T_{mRNA},
The maximum translation rate is denoted by kₜᵣₐₙₛₗₐₜᵢₒₙ with units proteins/min. Previous studies have bounded kₜᵣₐₙₛₗₐₜᵢₒₙ appropriately by using the amino acid incorporation rate, the physical number of ribosomes that can fit on the mRNA template, and the length of the protein being translated. For example, if a transcript is about 1000 nucleotides long, about 50 ribosomes can fit on it since the ribosome's footprint is about 20 nucleotides. The maximum translation rate is about 20 amino acids per second, so for a protein of length 500 amino acids, kₜᵣₐₙₛₗₐₜᵢₒₙ=50 ribosomes*(20 amino acids/sec ribosome)*(1 protein/500 amino acids)=(2 proteins/sec).
It is expected that the actual rate of translation to be far smaller since translation rates this high would cause queuing or ribosomes and ‘traffic jams’ on the mRNA. Nonetheless, this approach can generate an upper bound for kₜᵣₐₙₛₗₐₜᵢₒₙ
The maximum number of translations before a degradation event is given by: kₜᵣₐₙₛₗₐₜᵢₒₙ*T_{mRNA}
Therefore readily impose coupling constraint #2 can be readily imposed with:

bₘₐₓ=1/kₜᵣₐₙₛₗₐₜᵢₒₙ*T_{mRNA}.

Coupling constraint b is interpreted to mean: “one mRNA must be degraded every 1/(kₜᵣₐₙₛₗₐₜᵢₒₙ*T_{mRNA}) times it is translated”.

Bulk order of magnitude approximations for T_{mRNA} and kₜᵣₐₙₛₗₐₜᵢₒₙ (derived from omics sources) was employed to arrive at the coupling parameter bₘₐₓ used in this study.

Bulk Approximations for the Coupling Constraint Parameters.

Coupling Parameter Assumptions for the First Coupling Constraint:

T_{d}, the doubling time of the cell, was calculated as ln(2)/λ. Here, λ is the experimentally measured growth rate (in minutes) for the particular condition modeled.

τ_{mRNA}, the mean lifetime of all mRNAs in the cell, was assumed to be 5 minutes. We based this on a wide range of stabilities observed for individual mRNAs of E. coli. In that bacterium, ≈80% of all mRNAs had half-lives between 3 and 8 min (Bernstein et al., 2002, Proc Natl Acad Sci USA, 99, 9697-702).

Coupling parameter assumptions for the second coupling constraint:

kₜᵣₐₙₛₗₐₜᵢₒₙ is globally set to 4 proteins per minute. This value was tuned so that each mRNA will ultimately produce approximately 20 proteins during its effective lifetime. This mean yield (proteins/mRNA) was taken from a recent experiment which achieved simultaneous quantification of the E. coli Proteome and Transcriptome with Single-Molecule Sensitivity in Single Cells (Taniguchi et al., 2010, Science, 329, 533-8). It is important to note that literature sources disagree on the order of magnitude this parameter should take. The yield was reported as high as 300-600 in a separate quantitative study (Lu et al., 2007, Nat Biotechnol, 25, 117-24).

τ_{mRNA}, the mean lifetime of all mRNAs in the cell, was assumed to be 5 minutes. We based this on a wide range of stabilities observed for individual mRNAs of E. coli. In that bacterium, ≈80% of all mRNAs had half-lives between 3 and 8 min (Bernstein et al., 2002, Proc Natl Acad Sci USA, 99, 9697-702).

Coupling parameter assumptions for the third coupling constraint:

T_{d}, the doubling time of the cell, was calculated as ln(2)/λ. Here, is the experimentally measured growth rate (in seconds) for the particular condition modeled.

k_{cat} is globally set to 15 reactions per second per protein complex. Fluxes in metabolic models are on the order of 1 mmol/gDW h and less. Protein synthesis fluxes occur on the order of nmol/gDW h. This kcat parameter setting allows for feasible solutions by spanning the gap. Later, it can potentially be bounded using omics sources.

Special precautions are taken for the ribosome, RNA polymerases, and tRNAs as described below. Their rates can be confidently bounded using order of magnitude approximations:

RNA Polymerase (RNAP):

$${c}_{max} = \frac{1}{\begin{matrix}\frac{60 nucleotides}{{RNAP}_{transcribing} sec} * \frac{1 transcript}{2738 nucleotides} * \\ \frac{3 {RNAP}_{transcribing}}{10 RNAP} * {T}_{d} ( sec )\end{matrix}}$$

Ribosome:

$${c}_{ma x} = \frac{1}{\begin{matrix}\frac{20 amino acids}{{Ribosome}_{translating} sec} * \frac{1 protein}{315 amino acids} * \\ \frac{8 {Ribosome}_{translating}}{10 Ribosome} * {T}_{d} ( sec )\end{matrix}}$$

tRNAs:

$${c}_{ma x} = \frac{1}{\begin{matrix}\frac{2.6 million proteins}{200 \text{,} 000 tRNAs} * \frac{315 amino acids}{1 protein} * \\ \frac{1 tRNA use}{1 amino acid} * \frac{1}{6 hours} * \frac{1 hour}{3600 sec} * {T}_{d} ( sec )\end{matrix}}$$

c: Complex Dilution

V_{Complex Dilution}≧cₘₐₓ*V_{Complex Usage}; wherein

Coupling constraint c is used to approximate dilution of a complex to a daughter cell. Here are all of the assumptions required to arrive at the coupling constraint given above and derive a biological interpretation the coupling parameter cₘₐₓ
First, assume Michaelis-Menten kinetics, so V_{Complex Usage} is given as:

V_{Complex Usage}=(Vₘₐₓ[S])/(Kₘ+[S])
vₘₐₓ can be expressed as k_{cat}[E], where k_{cat} is the turnover number (expressed as the number of substrate molecules turned into product per complex per minute) and [E] is the complex's concentration. Now: V_{Complex Usage}=(k_{cat}[E][S])/(K_{M}+[S]).
The upper bound for enzyme usage is calculated by taking [S]>>K_{M} (the enzyme limited domain). Importantly, there is no scenario where more protein complex will be required than the enzyme limited domain. As this coupling constraint is ultimately applied as an inequality, it is not ruled out finding solutions from the other domains (substrate limited reactions and simultaneous substrate/enzyme limited reactions). Now:

V_{Complex Usage}=Kcat[E] [Equation 1].
At steady state: V_{Complex Synthesis}=V_{Complex Loss}=V_{Complex Dilution}±V_{Complex Degradation.}

It is assumed that on the order of the cell's doubling time V_{Complex Degradation}<<V_{Complex Dilution} and therefore: V_{Complex Synthesis}=V_{Complex Loss}=V_{Complex Dilution}.
The cell must synthesize one copy of the entire proteome per doubling time (T_{d}), and because the cell doubles exponentially we must have

V_{Complex Synthesis}=V_{Complex Loss}=V_{Complex Dilution}=(d[E]/dt)=(1/T_{d})[E] [equation 2]
Plugging equations 1 and 2 into the formula for Coupling Constraint #3 we arrive at:

V_{Complex Dilution}≧cₘₐₓ*V_{Complex Usage})=(1/T_{d})[E]≧cₘₐₓ*k_{cat}[E]
In the limiting case, cₘₐₓ=1/(k_{cat}*T_{d}) which has a physical interpretation.

cₘₐₓ is the inverse of the maximum number of complex uses in a doubling time.

Coupling constraint c is interpreted to mean: “one complex must be removed from the cell for every k_{cat}*T_{d} times it is used in the network”.

N-Terminal Methionine Cleavage Prediction

Predictions were made using the TermiNator program with protein sequences for T. maritima obtained from KEGG.

Genetic Code Determination.

From inspection of tRNA sequences and structures downloaded from the transfer RNA database (http://trna.bioinfuni-leipzig.de/DataOutput/), it was determined that T. maritima uses uniform-GUC decoding spread over 46 tRNA genes. In both Archaea and Bacteria, but not in Eukarya, the conversion of C34 of a CAU-anticodon to lysidine (k2C) or analogue generates an anticodon for isoleucine (ile). TMtRNA-Met-2 was assigned this role based on a strong sequence alignment to E. coli tRNAs containing k2C. The T. maritima genome encodes two additional tRNA genes with CAU anticodons. TMtRNA-Met-1 appears to be used for translation initiation while MARNA-Met-3 appears to be used during translation elongation. Evidence for distinguishing these two tRNA genes was based on the fact that TMtRNA-Met-1 has features that resemble those found in a crystal structure of formyl-methionyltRNAIMet from E. coli. Specifically, the presence of three consecutive G:C base pairs conserved in the anticodon stem of initiator tRNAs in initiation of protein synthesis in other organisms was relied on to make the final determination.

rRNA Modifications

For T. maritima, there was no organism-specific literature supporting modifications to the 5S and the 23S rRNA. No modifications of the 5S rRNA was assumed as modifications to 5S rRNA are infrequent in bacteria. Attempting to extrapolate 23S rRNA modifications from E. coli was relatively unsuccessful as alignment via ClustalW2 showed significant differences near many of the putative modification sites. The alignment also reveals that the 23S rRNA of T. maritima is significantly longer (>100 bp) than that of E. coli. Only three proteins with annotated roles in modifying the 23S rRNA were added to the model, TM0940, TM0462, and TM1715.

For 16S rRNA, there are experimental evidence for 10 modifications 15 in this organism. The locations of pseudouridines, which are mass silent, were not available, but an 1 lth modification, U to Y at position 516, was included in the knowledgebase based on the fact that it is well-conserved in bacteria and the alignment supports its inclusion. Finally, an unusual derivative of cytidine designated N-330 has been sequenced to position 1404 in the decoding region of the 16S rRNA. It was found to be identical to an earlier reported nucleoside of unknown structure at the same location in the 16S rRNA of the archaeal mesophile Haloferax volcanil. This modified nucleoside was excluded from the knolwedgebase since the exact chemical composition of the modification is unknown.

tRNA Modifications

Post-transcriptional modification of tRNA requires a significant investment in genes, enzymes, substrates, and energy. A variety of modifications were included in the model based on bioinformatics predictions and literature evidences.

RNaseP—

The Ribonuclease P Database2 (http://www.mbio.ncsu.edu/RNaseP/home.html) was used to locate the RNaseP gene at the genomic coordinates 752885-753222 on the + strand. This gene was absent from the T. maritima annotation in KEGG.

### Example 2

### Methods Used to Validate and Compare with ME-Model Predictions

T. maritima MSB8 (ATCC: 43589) was grown in an 500 mL serum bottles containing 200 mL of anoxic minimal media with 10 mM maltose, xylose, cellobiose, arabinose or glucose as the sole carbon source at 80° C. All samples were collected during log-phase growth. Substrate uptake and by-product secretion rates, and compositional analyses were performed as described below.

Samples were collected for gene and protein expression measurements after the growth was stopped with 20 mL of stopping solution comprised of 5 parts Trizol and 95 parts 200-proof ethanol (Sigma-Aldrich, St. Louis, Mo., USA). Uptake and secretion measurements were performed by the continuous sampling of the growth medium and assessing the depletion or accumulation of extracellular metabolites using the HPLC (Waters Corp., Milford, Mass., USA) as previously described (Johnson et al. (2006), Appl Environ Microbiol 72:811).

Transcriptome Analysis

RNA isolation and transcriptome measurements were performed as previously described. Briefly, RNA was extracted using RNAeasy mini kit protocol with DNaseI treatment (Qiagen, Valencia, Calif., USA). Total RNA yields were measured by using a NanoDrop (Thermo Fisher Scientific, Waltham, Mass., USA) at wavelength of 260 nm and quality was checked by measuring the sample A260/A280 ratio (>1.8). Amino-allyl cDNAs were reverse transcribed from 10 μg of purified total RNA and then labeled with Cy3 Monoreactive dyes (Amersham, GE HealthCare, UK). Labeled cDNA samples were fragmented to 50-300 by range with DNaseI (Epicentre Biotechnologies, Madison, Wis., USA) and interrogated with high-density four-plex oligonucleotide tiling arrays consisting of 4×71548 probes of variable length spaced across the whole T. maritima genome were used (Roche-NimbleGen, Madison, Wis., USA). Hybridization, wash and scan were performed according to the manufacturer's instructions. Probe level data were normalized using Robust Multiarray Analysis without background correction as implemented in NimbleScan™ 2.4 software (Roche-NimbleGen). The mean value across all replicates was used in the comparison to model predicted expression levels.

Proteomic Analysis

Cell pellets were stored at −80° C. prior to proteomic sample preparation. Individual frozen pellets ˜0.75 g each from midlog phase cultures were thawed and resuspended in 2 mL of 100 mM NH₄HCO₉ (pH 8.0) and lysis was achieved by passing the samples through a pre-chilled French pressure cell press (SLM Aminco) at 8000 lb/in² for four cycles. Lysed samples were centrifuged at 500×g (10 min, 4° C.) to remove cell debris, and the supernatants were divided into two aliquots per sample: one for global (whole cell lysate) sample preparation, and the other for soluble/insoluble fractionation. Ultracentrifugation (100,000 RPM, 10 min, 4° C.) was used to prepare insoluble protein/pellets and soluble protein/supernatant fractions. Cell pellets were washed once and the supernatants were combined with the soluble protein samples. Insoluble pellets were solubilized in 1% CHAPS in 50 mM NH₄HCO₃ (pH 7.8). Protein concentrations for global, soluble, and insoluble protein fractions were determined by the BCA protein assay (Sigma-Aldrich).

Following protein quantitation, lysate was denatured and reduced by incubation with 8 M urea and 0.1 M Bond Breaker TCEP (Pierce, Thermo Fisher Scientific) for 30 min at 6° C. Samples were diluted 10-fold with 50 mM ammonium bicarbonate (pH 7.8), and CaCl₂ was added to achieve a 1 mM final concentration. Proteins were digested with trypsin (1:50, trypsin to protein wt/wt) (Sequencing grade modified trypsin, Promega, Madison, Wis., USA) for 4 h at 37° C. Digested peptide samples were cleaned-up with Discovery C18 SPE (global and soluble samples) or Discovery SCX (insoluble samples) columns (Supelco, St. Louis, Mo., USA) according to manufacturer recommendations and concentrated using a Speed-Vac (ThermoSavant, San Jose, Calif., USA).

Peptides (0.5 μg/μL) from the global, soluble, and insoluble preparations were separated by a custom-built automated reverse-phase capillary HPLC system. Briefly, peptides were separated on a slurry-packed Jupiter 3 μm C18 resin (Phenomenex, Torrance, Calif., USA) fused silica capillary column (60 cm length 175 μm ID) at constant 10K psi pressure, exponential gradient (100% A to 60% A over 100 min), flow rate 500 nL/min. Mobile phase consisted of A) 0.1% formic acid in water and B) 0.1% formic acid in acetonitrile. The eluate was directly analyzed by electrospray ionization using an LTQ Orbitrap Velos mass spectrometer (Thermo Fisher Scientific) operated in data-dependent mode with m/z range of 400-2000, collision energy of 35 eV, and the 10 most intense peaks were selected for fragmentation.

Data were processed by DeconMSn and the SEQUEST peptide identification software was used to match MS/MS fragmentation spectra with potential protein sequences derived from a six frame translation of the Thermotoga maritima genome (minimum length 30 amino acids). The parent mass tolerance used for matching was set to ±3 Da and fragment ion tolerance was set to ±1 Da. Peptides were searched with a dynamic oxidized methionine modification and no enzyme was specified. Peptide identifications were retained based upon the following criteria: 1) SEQUEST DelCn2 value ≧0.10 and 2) SEQUEST correlation score (Xcorr) ≧1.77 for charge state 1+ for fully tryptic peptides and Xcorr ≧3.04 for 1+ for partially tryptic peptides; Xcorr ≧1.98 for charge state 2+ and fully tryptic peptides and Xcorr ≧3.35 for charge state 2+ and partially tryptic peptides; Xcorr ≧2.84 for charge state 3+ and fully tryptic peptides and Xcorr ≧4.34 for charge state 3+ and partially tryptic peptides. Proteins used in the semi-quantitative analysis were required to have ≧2 unique peptides for identification or 1 peptide with a minimum of two observations. Redundant peptides (i.e., peptides mapping to multiple protein entries), comprising <0.30% of all peptide identifications, were excluded from the analysis to minimize potential ambiguity. Using the reverse database approach, the false discovery rate was calculated to be 0.08% at the spectrum level. Spectral counts were calculated as the sum of all peptide observations corresponding to a given protein. A normalized abundance score was calculated for each protein by dividing the total spectral count by the number of possible tryptic peptides (400-6000 m/z). For each protein, missing values were zero-filled and the mean of the normalized spectral count across all fractions was used for downstream analyses.

In Vitro Vs. In Silico Omics.

The predicted transcription level of a gene was determined by summing across the demand fluxes of the TUs containing that gene. Translation levels were reported as the sum across the relevant translation initiation fluxes as many TUs can contribute to the production of a given protein. These values were compared to the values reported experimentally.

### Example 3

### Simulation of Cellular Physiology and Efficient Molecular Phenotypes

The RNA-to-protein mass ratio (r) has been observed to increase as a function of specific growth rate (μ) (Schaechter et al., 1958, J Gen Microbiol, 19, 592-606; Scott et al., 2010, Science, 330, 1099-102) and decreases as a function of translation efficiency Scott et al., 2010, Science, 330, 1099-102). Schaechter et al. also observed an increase in the number of ribonucleoprotein particles with increasing μ, whereas the translation rate per ribonucleoprotein particle was relatively constant (Schaechter et al., 1958, J Gen Microbiol, 19, 592-606).

To ascertain whether the subject ME-Model recapitulated the observed increases in r, ribosomal RNA and proteins with increasing μ, a range of growth rates were simulated in a defined minimal medium (Rinker and Kelly, 1996, Appl Environ Microbiol, 62, 4478-85). To simulate the molecular physiology of T. maritima for a particular μ, FBA (Orth et al., 2010, Nat Biotechnol, 28, 245-8) was used subject to linear programming optimization (Applegate et al., 2007, Operations Research Letters, 35, 693-699) to identify the minimum ribosome production rate required to support a given μ (FIG. 3b). Ribosome production has been shown to be linearly correlated with growth rate in E. coli (Gupta and Schlessinger, 1976, J Bacteriol, 125, 84-93; Thiele et al., 2009, PLoS Comput Biol, 5, e1000312; Scott et al., 2010, Science, 330, 1099-102).

FIGS. 3(a-b) show characteristics of M- and ME-Models objective functions and assumptions. FIG. 3 (a) M-Models simulate constant cellular composition (biomass) as a function of specific growth rate GO, whereas ME-Models simulate constant structural composition with variable composition of proteins and transcripts. FIG. 3 (b) Linear programming simulations with M-Models are designed to identify the maximum μ that is subject to experimentally measured substrate uptake rates. Only biomass yields are predicted as μ enters indirectly as an input through the supplied substrate uptake rate (see the measurement column for M-Models). Importantly, the substrate uptake rate is derived by normalizing to biomass production. Linear programming simulations with ME-Models aim to identify the minimum ribosome production rate required to support an experimentally determined μ. μ enters into the coupling constraints and so it must be supplied (or sampled) as the problem would otherwise be a Nonlinear Program (NLP). As all M-Models reactions are contained within the ME-Models, ME-Models can simulate all M-Models objectives in addition to the broad range of objectives associated with macromolecular expression.

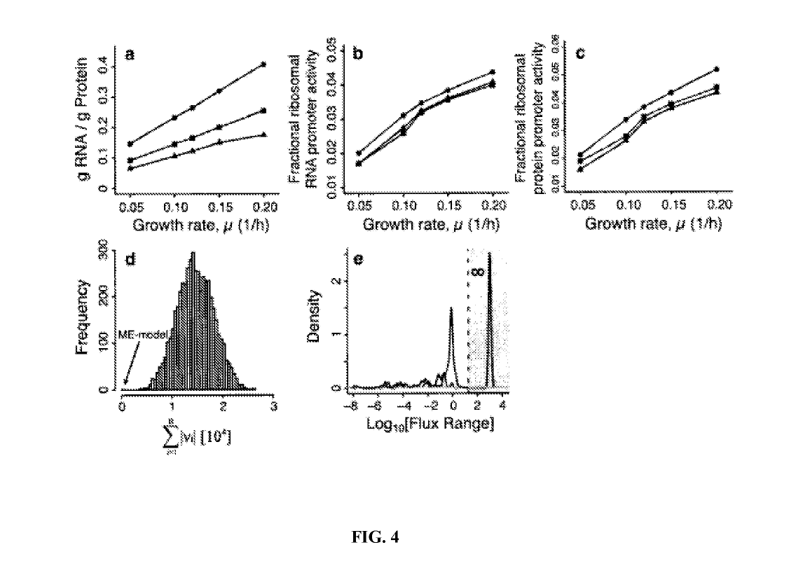

FIGS. 4 (a-e) show that the ME-Model accurately simulates variable cellular composition and efficient use of enzymes. FIG. 4 (a) With our ME-model, the RNA/protein ratio increases linearly with growth rate and with a slope proportional to translational capacity in amino acids per second (circles: 5 AA/s, squares: 10 AA/s, triangles: 20 AA/s). FIG. 4 (b) Ribosomal RNA (rRNA) synthesis increases, relative to total RNA synthesis, with growth rate (symbols as in a). FIG. 4 (c) Ribosomal protein promoter activity increases, relative to total RNA synthesis, with growth rate (symbols as in a). FIG. 4 (d) Random sampling of the M-Model solution space indicates that the M-Model solution space contains numerous internal solutions with a broad range of total network flux. The probability of finding an M-Model solution as efficient as an ME-Model simulation is 2.1×10−5; the probability was calculated from a normal distribution constructed from the M-Model sample space. The M-Model sample contains 5,000 flux vectors randomly sampled from the M-Model solution space. FIG. 4 (e) Smooth estimate of the density of the flux ranges for the metabolic enzymes that may be simulated while maintaining the objective for efficient growth with a 1% tolerance (M-Model: lower line, ME-Model: upper line). The shaded area denotes biologically unrealistic flux values. All simulations were performed with an in silico minimal medium with maltose as the sole carbon source.

Consistent with experimental observations (Schaechter et al., 1958, J Gen Microbiol, 19, 592-606; Scott et al., 2010, Science, 330, 1099-102), the ME-Model simulated an increase in r with increasing μ and with decreasing translation efficiency (FIG. 4a). It was observed that the fraction of the transcriptome associated with ribosomal RNA in silico increased with μ (FIG. 4b). Additionally, the ribosomal proteins account for a larger proportion of the total proteome as μincreases (FIG. 4c).

With M-Models, the cellular macromolecular composition is constant, ergo they cannot reproduce the observed increases in r or ribosomes with increasing μ (FIG. 3a-b). Although it is possible to empirically determine a relationship between gross biomass composition and μ and then use this relationship to study variable composition in M-Models (Pramanik and Keasling, 1997, Biotechnol Bioeng, 56, 398-421), the M-Models will compute a solution space where the range of activity for a number of enzymes may be rather broad and even infinite (Reed and Palsson, 2004, Genome Res, 14, 1797-805) if not specifically constrained. The biologically implausible sections of the M-Model solution space are due, in large part, to unconstrained thermodynamically infeasible internal loops that can operate at an arbitrary flux level (Schellenberger et al., 2011, Biophys J, 100, 544-53). These arbitrary activities contradict previous observations that efficient organisms should maintain a minimal total flux through their biochemical network (Holzhutter, 2004, Eur J Biochem, 271, 2905-22; Lewis et al., 2010, Mol Syst Biol, 6, 390).

By explicitly accounting for enzyme expression and activity, ME-Model simulations should identify the set of proteins that will result in optimally efficient conversion of growth substrates into cells. To determine if the ME-Model was more economic in terms of enzyme usage than the M-Model, the ME-Model simulation was compared to a random sampling of the M-Model solution space (Reed and Palsson, 2004, Genome Res, 14, 1797-805). After normal distribution was fit to the sampled M-Model space it was found that there is a small (2.1×10⁻⁵) probability of finding an M-Model solution as efficient as the ME-Model solution (FIG. 4d). Because ME-Models explicitly account for the costs of enzyme expression and dilution to daughter cells, the most efficient growth simulations will minimize the materials required to assemble the cell; i.e., ME-Models will efficiently use enzymes when simulating a μ.

To compare the range of permissible, i.e., computationally feasible, activity for each metabolic enzyme in the ME-Model versus the M-Model we performed flux variability analysis (FVA). FVA identifies the flux range that each reaction may carry given that the model must also simulate the specified objective value, such as μ, with a set tolerance. The permissible enzyme activities for simulating efficient growth with a 1% tolerance tended to have smaller ranges in the ME-Model compared to the M-Model (FIG. 4e), highlighting the sharply reduced flexibility in the ME-Model solution space when simulating optimal growth.

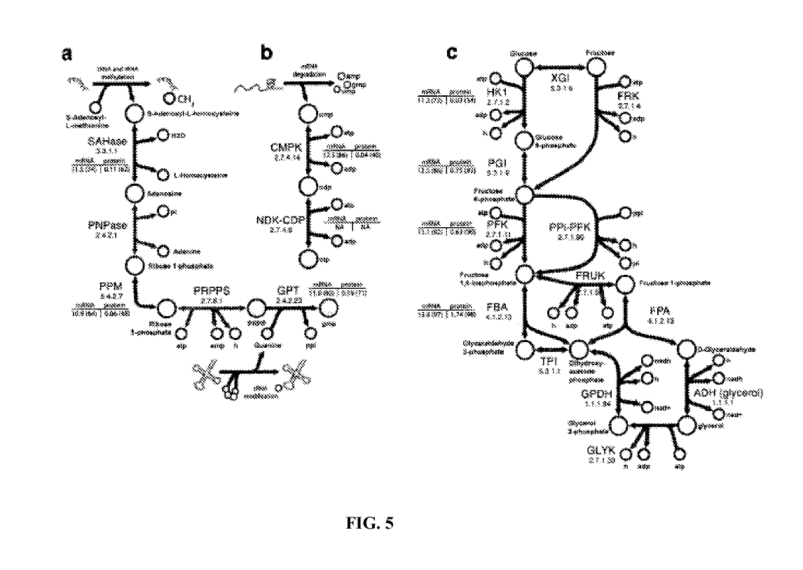

In addition to simulating variable cellular composition and effectively eliminating the infinite catalysis problem, there are a number of metabolic activities that are required for optimally efficient growth with the ME-Model but not with the M-Model (FIG. 5a-c). These differences are due to the ME-Model producing small metabolites as by-products of gene expression and explicitly accounting for the material and energy costs of macromolecule production and turnover. The ME-Model includes metabolic activities for recycling S-adenosylhomocysteine, which is a by-product of rRNA and tRNA methylation, and guanine, which is byproduct of queuosine modification of various tRNAs (FIG. 5a). The ME-Model, also, produces CTP from CMP that is produced during mRNA degradation (FIG. 5b). Interestingly, the M-Model does not require CDP production to simulate growth, whereas CDP production is essential in the ME-Model. The ME-model exhibits frugality with respect to central metabolic reactions (FIG. 5c) and proposes the canonical gylcolytic pathway during efficient growth whereas the M-Model indicates that alternate pathways are as efficient.

These differences highlight the interplay between macromolecular synthesis and degradation, metabolism and salvage, and optimal use of the proteome. The ME-models allow a fine resolution view of these processes and their simultaneous reconciliation.

### Example 4

### Simulation of Metabolic by-Product Secretion and Systems Level Molecular Phenotypes

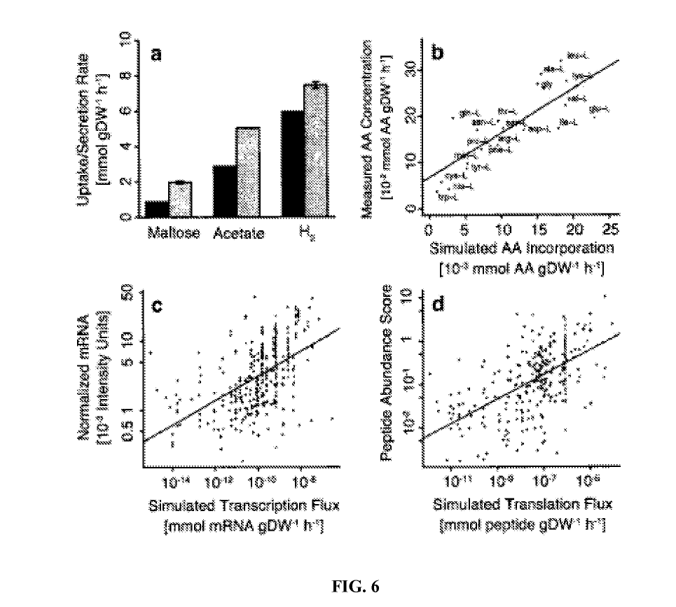

To assess the subject ME-Model's ability to simulate systems-level molecular phenotypes, model were compared to predictions to substrate consumption, product secretion, AA composition, transcriptome, and proteome measurements. With the only external constraints for the ME-Model being the experimentally-determined μduring log-phase growth in maltose minimal medium at 80° C., the model accurately predicted maltose consumption and acetate and H₂ secretion (FIG. 6a). Predicted AA incorporation was linearly correlated (0.79 PCC; p<4.1×10⁻⁵ t-test) with measured AA composition (FIG. 6b). The ME-Model, with all the biochemical and genetic information that it represents, was able to compute approximately the gross AA composition of T. maritima solely from sugar uptake and T_{d} measurements thus obviating the need for AA measurements.

FIGS. 6 (a-d) show that the ME-Model accurately simulates molecular phenotypes during log-phase growth. FIG. 6 (a) The ME-Model accurately simulates H2 and acetate secretion with maltose uptake when constrained with a measured growth rate (n=2). Experiment: light bars, simulation: dark bars. FIG. 6 (b) The in silico ribosome incorporates the 20 amino acids at rates proportional (Pearson correlation coefficient=0.79; P<4.1×10−5 t-test) to the bulk amino-acid composition of a T. maritima cell as measured by high-performance liquid chromatography (n=1). FIG. 6 (c) Simulated transcriptome fluxes are significantly (P<2.2×10−16 t-test) and positively correlated (Pearson correlation coefficient=0.54) with semiquantitative in vivo transcriptome measurements (n=4). RNAs containing ribosomal proteins (light circles) were expressed stoichiometrically in simulations but exhibited variability in measurements. FIG. 6 (d) Simulated translation fluxes are significantly (P<2.2×10−16 t-test) and positively correlated (Pearson correlation coefficient=0.57) with semiquantitative in vivo proteomic measurements (n=3). Ribosomal proteins (light circles) were expressed stoichiometrically in simulations but exhibited variability in measurements.

Interestingly, when we compared the simulated transcriptome and proteome fluxes to transcriptome and proteome measurements, respectively, there were statistically significant (p<2.2×10⁻¹⁶ t-test) positive correlations for both the transcriptome (0.54 PCC; FIG. 6c) and the proteome (0.57 PCC; FIG. 6d). This degree of concordance was unexpected because the model does not account for transcriptional regulation or transcript-specific RNA degradation rates. However, this concordance may be the result of our simulation objective being aligned with T. maritima 's regulatory program whereas a decreased concordance would be expected if the regulatory network was responding to a stress.

Within the transcriptome and proteome scatterplots (FIGS. 2c-d) there are some irregularities. Discrepancies arise from incomplete knowledge of T. maritima 's transcription unit architecture and regulatory circuits. For instance, in the case of ribosomal proteins (FIGS. 2c-d), the model predicts that they are expressed at the same level, whereas experimental measurements show variability in expression. The model was designed based on the evidence that ribosomal protein synthesis is very well coordinated, and does not account for complex degradation and translational feedback circuits that have yet to be fully elucidated. This discrepancy highlights the need for expanding our knowledge of regulatory features associated with ribosomal protein production and degradation. In spite of these few discrepancies due to incomplete knowledge, the ME-Model is remarkably accurate in computing the molecular phenotype in detail and on a genome-scale.

FIGS. 2 (a-d) show genome-scale modeling of metabolism and expression. FIG. 2 (a) Modern stoichiometric models of metabolism (M-models) relate genetic loci to their encoded functions through causal Boolean relationships. The gene and its functions are either present or absent. The dashed arrow signifies incomplete and/or uncertain causal knowledge, whereas solid arrows signify mechanistic coverage. FIG. 2 (b) ME-Models provide links between the biological sciences. With an integrated model of metabolism and macromolecular expression, it is possible to explore the relationships between gene products, genetic perturbations and gene functions in the context of cellular physiology. FIG. 2 (c) Models of metabolism and expression (ME-Models) explicitly account for the genotypephenotype relationship with biochemical representations of transcriptional and translational processes. This facilitates quantitative modeling of the relation between genome content, gene expression and cellular physiology. FIG. 2 (d) When simulating cellular physiology, the transcriptional, translational and enzymatic activities are coupled to doubling time (Td) using constraints that limit transcription and translation rates as well as enzyme efficiency. τmRNA, mRNA half-life; kcat, catalytic turnover constant; ktranslation, translation rate; ν, reaction flux.

Although there is a positive correlation (PCC of 0.54) between the simulated transcriptome fluxes and semiquantitative transcriptome data there was still a substantial amount of dispersion (FIG. 6c). When comparing in silico and in vivo transcriptome measurements it is important to realize that both are approximations of the transcript levels in an organism, and that omics technologies have been inherently noisy to date). Incomplete knowledge, such as a lack of specific translation efficacy and degradation rates for each mRNA, will contribute to deviations from reality by ME-Model simulations. Similarly, probe-binding and sample-labeling efficacies, as well as other technical issues serve as barriers to absolute quantitative transcriptome measurements.

While it is a non-trivial endeavor to identify the source of all variation between the simulated and measured transcriptomes, it is possible to use the ME-Model for comparative transcriptomics approaches similar to two-channel DNA microarray studies. Despite the early technological limitations of DNA microarrays, biological discovery was enabled by performing comparative transcriptomics. Large-scale gene expression profiling has been used extensively to identify genes that are differentially regulated as a function of genetics and environment. Analysis of differentially expressed genes has contributed to the identification of gene product responsible for unannotated enzymatic activities. In combination with sequence analysis, differential gene expression data can be used to investigate transcriptional regulation.

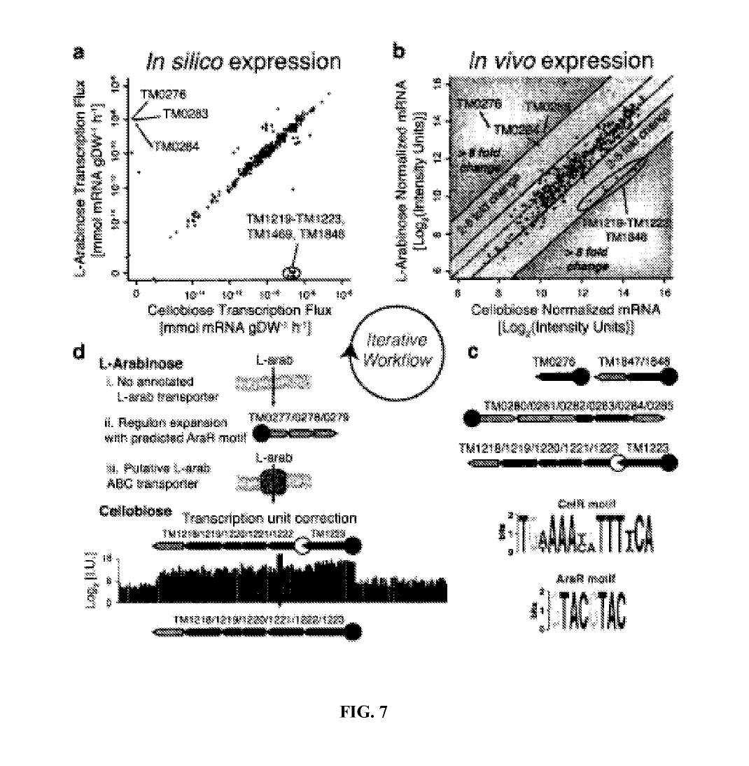

A workflow was devised and implemented for in silico comparative transcriptomics which resulted in the discovery of new regulons and improved both genome and TU annotation (FIG. 7 a-d). The similarities between the comparative transcriptomics in silica (FIG. 7 a) and in vivo (FIG. 7b) studies are rather striking, given the variation observed between the simulated and measured transcriptomes (FIG. 6c)—this emphasizes that, in spite of any shortcomings, the ME-Modeling framework is a powerful tool for biological research.

FIGS. 7 (a-d) demonstrate In silico transcriptome profiling drives biological discovery. FIG. 7 (a) In silico comparative transcriptomics identifies sets of genes that are differentially regulated for growth in L-arabinose (L-Arab) versus growth in cellobiose minimal media. TM0276, TM0283 and TM0284 are essential for metabolizing L-Arab, whereas TM1219-TM1223, TM1469 and TM1848 are essential for metabolizing cellobiose. FIG. 7 (b) In vivo transcriptome measurements (n=2) confirm the in silico transcriptomics predictions for differential expression of genes when metabolizing L-Arab or cellobiose. FIG. 7 (c) Two distinct putative TF-binding motifs are present upstream of the TUs containing genes differentially expressed in silico when simulating growth in L-Arab versus cellobiose minimal media. The motif upstream of the genes upregulated during growth in L-Arab medium is termed AraR, whereas the motif of the genes upregulated during growth in cellobiose medium is termed CelR. Genes (light: not in the model, dark: upregulated by L-arabinose, very dark: upregulated by cellobiose) organized into TUs involved in the shift are shown. Each TU contains a promoter region (circle) arbitrarily taken to be 75 base pairs upstream of the first gene in the TU. Promoters found to contain the AraR or CelR motifs are dark circles and light circles, respectively. FIG. 7 (d) Searching T. maritima 's genome for additional AraR and CelR motifs results in new biological knowledge. Although T. maritima can metabolize L-Arab, there is no annotated transporter in the current genome. A putative AraR motif was identified in a single TU (TM0277/0278/0279) not contained in the ME-Model. Analysis of the TM0277/0278/0279 TU with the SEED RAST server indicated that the genes are likely components of an ABC transporter that may be associated with L-Arabtransport. The CelR motif was not present in the promoter region upstream of the cellobiose transporter operon (TM1218/1219/1220/1221/1222); however, the CelR motif was present in the promoter of the TU (TM1223) directly upstream of the cellobiose transport operon. Examination of the in vivo transcriptome measurement indicates that the cellobiose transporter operon belongs to the same TU as that of TM1223.

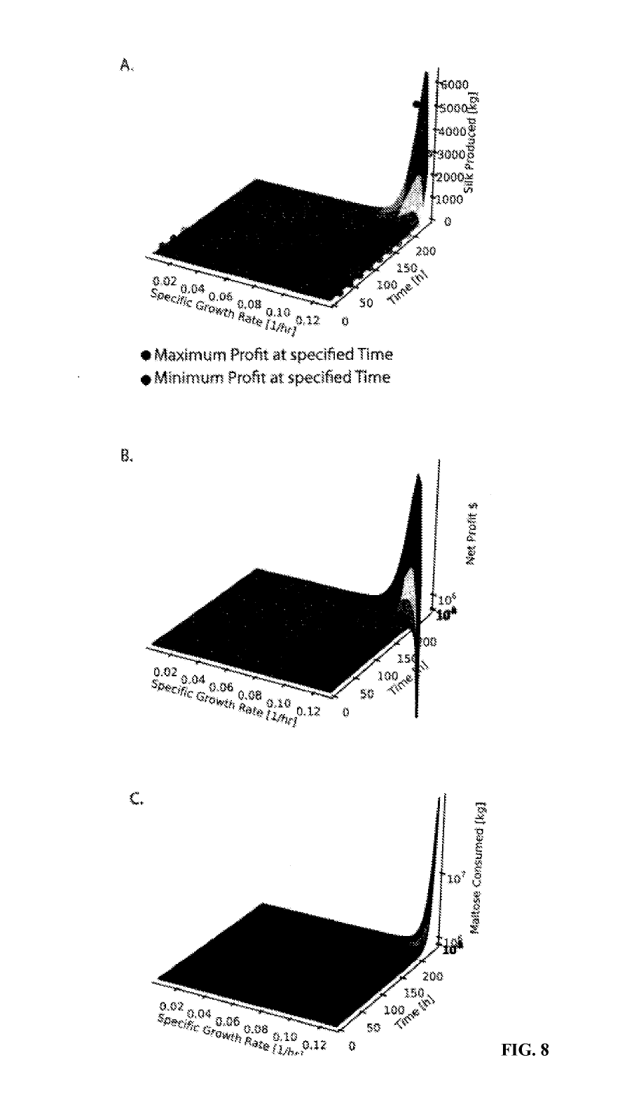

FIGS. 8 (a-c) show the profitability estimate graph for the production of spider silk. FIG. 8(a) shows that in the short term (less than 50 hr) maximum production and profitability occur when the organism is designed to dedicate most of its resources to spider silk production and specific growth rate is less than 0.01 hr⁻¹. FIG. 8(b) shows a substantial decrease in net profits at the higher specific growth rates over an extended period of time. FIG. 8(c) shows that the reduction in profits is due to an exponential increase in the amount of feedstock required to support the microbial population at these later time points.

### Example 5

### Cost/Profitability Analysis

A procedure was developed for cost estimate analysis for production of a value-added product in a genetically manipulated organism.

First all the necessary mutations were introduced (additions, subtractions, and/or modifications to the genome, transcriptome, proteome and/or reactome) in the computer representation of the target organism to provide it with a functioning pathway for converting feedstock into the desired valued added product.

The above described method was used to calculate the minimum ribosome production rate that is capable of supporting the maximum experimentally measured growth rate for the wild type organism in the defined growth medium (i.e., feedstocks). Term this ribosome production rate as the economically efficient ribosome production rate (R). In subsequent simulations, R is used as the upper bound constraint for ribosome production rate.

A growth rate was specified in the model and the above method was used to identify the maximum production rate for the value added product that can be supported while maintaining the specified growth rate. If data for substrate uptake as a function of growth rate are available then they can be used as additional constraints and the upper bound constraint for ribosome production can be relaxed.

For each simulation, information on sugar consumption, product formation, ribosome formation, and other parameters relevant to the growth medium and economic analysis was collected.

The collected consumption and production rates with current market estimates for feedstock and product prices was used to construct a profitability estimate graph and graphs for estimates of key bioprocessing parameters, such as feedstock consumption, reactor volume, and product information. These graphs will guide the selection of the most economically attractive operating conditions for a given bioprocessing plant design.

This method was applied to the production of spider silk protein by. T. maritima growing in maltose minimal medium (FIG. 8). Spider silk is under investigation as a stronger and lighter alternative to Teflon for military and commercial applications; the current barrier to adaptation of spider silk is the production cost. Computer aided re-design of microbes will aid in identifying optimally efficient designs and providing guidance on implementation of production strains. Cost analysis excludes bioprocessing plan equipment and is based on a price of $0.000171095 per millimole of maltose and $1.56 per millimole of spider silk. Maximum productivity and profitability are taken as the cumulative product formation or profit made up to the specified time point. FIG. 8 (a) shows that the short term (less than 50 hr) maximum production and profitability occur when the organisms is designed to dedicate most of its resources to spider silk production and specific growth rate is less than 0.01 hr⁻¹. But in the longer term (>50 hr), maximum productivity occurs when more resources are dedicated to cellular growth; at specific growth rates greater than 0.11 hr⁻¹. However, at longer time periods (greater than 200 hr) maximum profitability occurs at a lower specific growth rate than required for maximum productivity. This phenomenon is due to a substantial decrease in net profits at the higher specific growth rates over an extended period of time that is depicted in FIG. 8 (b). FIG. 8 (c) shows that the reduction in profits is due to an exponential increase in the amount of feedstock required to support the microbial population at these later time points. Thus, the method identified the specific growth rate range of 0.10-0.11 hr⁻¹ as being more profitable that the higher yield slower growing strains (specific growth rate <0.01 hr⁻¹) and more profitable than the lower yield faster growing strains (specific growth rate >0.11 hr⁻¹).

### Example 6

### Integration of Genome-Scale Reaction Networks of Protein Synthesis and Metabolism

Experimental Procedures

Network Knowledgebase

The two primary reaction networks used to create the ME-Model were the most recent metabolic knowledgebase (Orth et al., 2011), and a network detailing the reactions of gene expression and functional enzyme synthesis (Thiele et al., 2009). The gene expression knowledgebase is formalized as a set of ‘template reactions’ that can be applied to different components (e.g. gene, peptide, set of peptides) to generate balanced reactions. Merging the E. coli metabolic network knowledgebase with the gene expression knowledgebase required a conversion of the Boolean Gene-Protein-Reaction associations (GPRs) to protein complexes. EcoCyc's annotation was used to map gene sets to functional enzyme complexes. The network knowledgebase procedure is similar to that described in Example 1. Non-limiting modifications to the network knowledgebase procedure include mechanistic accounting for protein prosthetic group synthesis, integration with enzymes, and degradation, and implementation of variable coupling constraints based on empirical observations.

TABLE 1

| | | 2. Physicochemical | |
|---|---|---|---|
| | 1. Reaction | and Evolutionary | |
| | Network | Limitations | 3. Phenotype |
| | (Topology) | (Constraints) | (Behavior) |
| Starting point for this | Genome-scale | Metabolite flux | Metabolic fluxes |
| study | knowledge bases of | balance, energy | |
| | metabolic (Orth et | parameters, coupling | |
| | al., 2011) and | constraints from | |
| | macromolecular | previous models | |
| | synthetic pathways | (Lerman et al., 2012; | |
| | (Thiele et al., 2009) | Thiele et al., 2010), | |
| | | maximization of μ | |
| Refinements and | Catalytic unit | Refined methods to | Functional |
| expansions | knowledge base for | approximate | proteome, ability to |
| | metabolic reactions, | component | simulate batch and |
| | curation to | efficiencies, minimal | nutrient-limited |
| | integrate/update | set of μ-dependent | growth conditions |
| | networks | parameters (necessary | |
| | | only for quantitative | |
| | | agreement) | |

The scope and coverage of cellular processes in the integrated network is extensive. The integrated network mechanistically links the functions of 1541 unique protein-coding open reading frames (ORFs) and 109 RNA genes; it thus accounts for ˜35% (of the 4420) protein-coding ORFs, ˜65% of the functionally well-annotated ORFs (Riley et al., 2006), and 53.7% of the non-coding RNA genes identified in E. coli K-12 (Keseler et al., 2013). In total, 1295 unique functional protein complexes are produced. Taken together, these complexes account for 80-90% of E. coli's proteome by mass.

The integrated reaction network covers and accurately predicts a large proportion of essential cellular functions. It includes 223 of the 302 (73.8%) genes classified as essential for cell growth under any condition (Kato and Hashimoto, 2007), and 166 of the 206 functions (80.6%) estimated as essential for a minimal organism (Gil et al., 2004).

TABLE 2
Model parameters

| | Symbols | | |
|---|---|---|---|
| | used | Default Value | |
| Parameter | throughout | (Source or Derivation) | Units |
| Growth rate | μ | no default | h⁻¹ |
| | | (optimized for through binary search | |
| | | process) | |
| Growth- | GAM | 35 | mmol ATP gDW⁻¹ |
| associated | | (reduced from the amount in (Feist et al., | |
| maintenance | | 2007) to account for the portion directly | |
| requirement | | modeled) | |
| Non-growth- | NGAM | 1 | mmol ATP gDW⁻¹ |
| associated | | (reduced from the amount in (Feist et al., | h⁻¹ |
| maintenance | | 2007) to account for the portion directly | |
| requirement | | modeled. A non-zero number of | |
| | | ribosomes is required to achieve a 0 | |
| | | growth rate) | |
| Unmodeled | Q | 0.45 | unitless |
| protein proportion | | (based on a rough approximation and | |
| of proteome | | (Scott et al., 2010), includes modeled | |
| | | machinery used to synthesize non- | |
| | | modeled machinery) | |
| proportion of | f_{mRNA} | 0.02 | unitless |
| RNA that is | | ((Bremer and Dennis, 1996) as 1 − fₛ and | |
| mRNA | | constant according to (Rosset et al., | |
| | | 1966)) | |
| proportion of | f_{tRNA} | 0.12 | unitless |
| RNA that is tRNA | | (Calculated using the formula 1 − | |
| | | (1 − fₛ) − (1 − fₜ) with symbols taken from | |
| | | (Bremer and Dennis, 1996) and constant | |
| | | according to (Rosset et al., 1966)) | |
| proportion of | f_{rRNA} | 0.86 | unitless |
| RNA that is rRNA | | ((Bremer and Dennis, 1996) as 1 − fₜ and | |
| | | constant according to (Rosset et al., | |
| | | 1966)) | |
| Mean enzyme | | 65 | s⁻¹ |
| efficiency | | (In the range of the average enzyme | |
| | | from data in (Bar-Even et al., 2011). | |
| | | Roughly tuned to the range of | |
| | | acceptable growth rates after short- and | |
| | | long-term adaptive laboratory | |
| | | evolutions.) | |
| Flux ratio | | 1:1 (NDH-1:NDH-2) | unitless |
| between the two | | (As assumed in (Feist et al., 2007)) | |
| NADH | | | |
| dehydrogenases | | | |
| mRNA | k_{deg}^{mRNA} | 1/5 | min¹ |
| degradation | | (≈80% of all mRNAs had half-lives | |
| constant | | between 3 and 8 min in (Bernstein et al., | |
| | | 2002)) | |
| Average | mₙₜ | 324 | Da |
| molecular mass | | (Bionumbers Database (Phillips and | |
| of RNA | | Milo, 2009) ID 104886) | |
| nucleotide | | http://bionumbers.hms.harvard.edu/ | |
| Average | mₐₐ | 109 | Da |
| molecular mass | | (Bionumbers Database (Phillips and | |
| of amino acid | | Milo, 2009) ID 104877) | |
| Molecular mass | mᵣᵣ | 1700 | kDalton |
| of RNA | | (Bionumbers Database (Phillips and | |
| component of | | Milo, 2009) ID 100119) | |
| ribosome | | | |
| Characteristic | m_{tRNA} | 25000 | Da |
| (average) | | (Bionumbers Database (Phillips and | |
| molecular mass | | Milo, 2009) ID 101177) | |
| of a tRNA | | | |
| GC fraction for E. | | 0.507896997096 (Calculated from | unitless |
| coli genomic DNA | | genome sequence given in (Blattner et | |
| | | al., 1997)) | |
| # ATP molecules | | 0.25 | ATP molecules |
| hydrolyzed per | | (Assumed average as in (Thiele et al., | |
| nucleotide for | | 2009)) | |
| RNA degradation | | | |
| # nucleotides | | 16 | nucleotides |
| transcribed from | | (Assumed average as in (Thiele et al., | |
| DNA template | | 2009)) | |
| before sigma | | | |
| factor | | | |
| dissociation | | | |
| # ATP molecules | | 3 | ATP molecules |
| hydrolyzed per | | (Assumed as in (Thiele et al., 2009)) | |
| rho-dependent | | | |
| transcription | | | |
| termination event | | | |

Growth Demands and Constraints on Molecular Catalytic Rates

The reconstructed network can be converted into a genome-scale computational model to compute phenotypic states in a defined environment. Genome-scale models formally relate reaction network structure and governing constraints, which limit the range of functional states the network can achieve (Doyle and Csete, 2011; Milo and Last, 2012). Here, constraints on growth and gene expression were developed that allow for meaningful computation with the ME-Model.

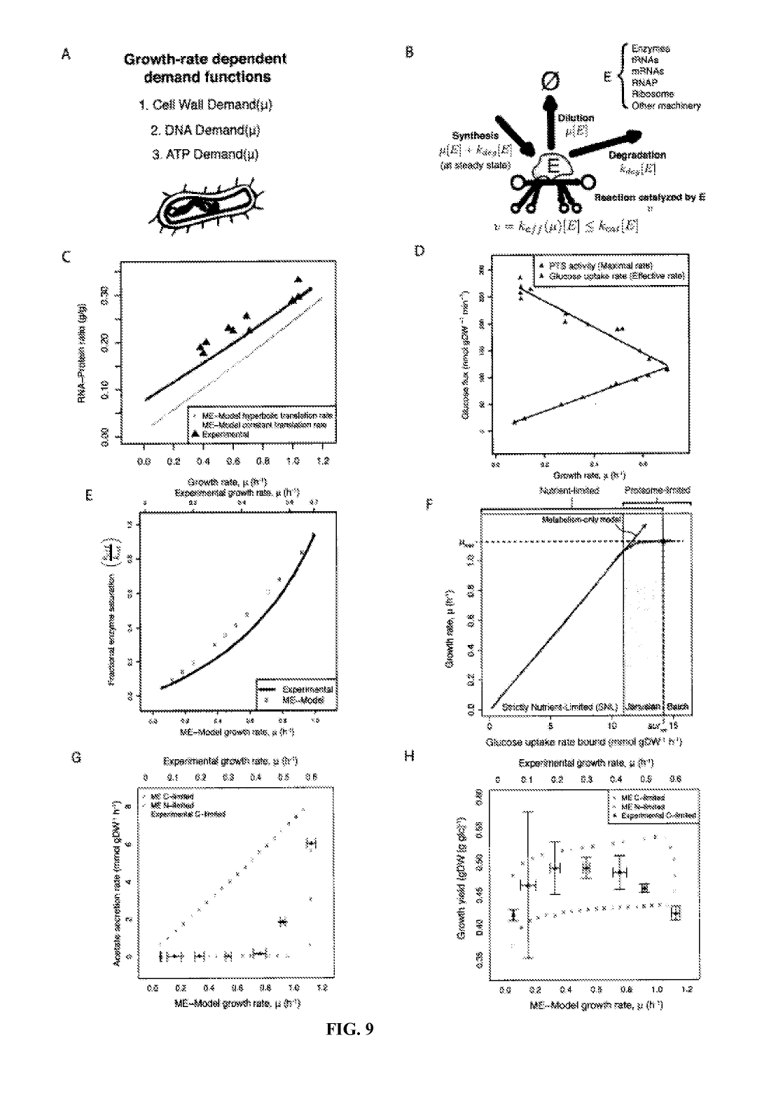

To compute functional states of the integrated network, growth demands are first imposed. Growth requires the replication of the organism's genome and synthesis of a new cell wall to contain the replicated DNA. In the ME-Model, growth rate-dependent DNA and cell wall demand functions formalize these requirements (FIG. 9a; Table 3). These demand functions were derived from growth rate-dependent trends in cell size (Donachie and Robinson, 1987) and DNA content (Bremer and Dennis, 1996; Meyenburg and Hansen, 1987) (Table 3). In addition, growth-associated and non-growth-associated ATP utilization demands (Pirt, 1965) are imposed as the ostensible energy requirements (Neijssel et al., 1996; Zhuang et al., 2011).

TABLE 3
Growth rate-dependent demand reactions-DNA

| | # in | | | |
|---|---|---|---|---|
| | genome given | | | |
| | a total length | grams/mol | | |
| | of 4639675 | (removed | | |
| | with a GC | leaving | | |
| base | fraction 0.5078 | group) | mol | grams |
| A | 2283648.035 | 312.202 | 3.79209E−18 | 1.1839E−15 |
| T | 2283648.035 | 303.187 | 3.79209E−18 | 1.14971E−15 |
| C | 2356026.965 | 286.16 | 3.91227E−18 | 1.11954E−15 |
| G | 2356026.965 | 328.201 | 3.91227E−18 | 1.28401E−15 |
| | | | | Taking the sum, It |
| | | | | was found there are |
| | | | | 4.73716E−15 |
| | | | | grams of DNA per |
| | | | | genome |

RNA and protein are not included as demand functions as they are in M-Models (Feist and Palsson, 2010); instead, expression of specific RNA and protein molecules are free variables determined during ME-Model simulations. ‘Coupling constraints’ (Lerman et al., 2012; Thiele et al., 2010) relate the synthesis of RNA- and protein-based molecules to their catalytic functions in the cell (FIGS. 9A-B). The coupling constraints are based on parameters that define the effective catalytic rate (k_{eff}) and degradation rate constant (k_{deg}) of molecular machines.

A nutritional environment is then defined by setting constraints on the availability and uptake of nutrients. For a particular nutritional environment, there is a maximum growth rate at which the cell can no longer produce enough RNA and protein machinery to meet the demands of growth. The computed cellular state (biomass composition, substrate uptake and by-product secretion, metabolic flux, and gene expression) at this maximum growth rate is the predicted response of the cell to the specified nutritional environment.

TABLE 4

| growth | | gDNA | | | |
|---|---|---|---|---|---|
| rate | | (given 4.73716E−15 | | | |
| (doubling | genome | grams of DNA per | micrograms/ | | |
| per hour) | equivalents | genome) | 10⁹ cells | g_per_cell | % cell DNA |
| 0 | 1* | 4.73716E−15 | 80** | 8E−14 | 5.921446222 |
| 0.6 | 1.6 | 7.57945E−15 | 148 | 1.48E−13 | 5.121250787 |
| 1 | 1.8 | 8.52688E−15 | 258 | 2.58E−13 | 3.30499324 |
| 1.5 | 2.3 | 1.08955E−14 | 433 | 4.33E−13 | 2.51627276 |
| 2 | 3 | 1.42115E−14 | 641 | 6.41E−13 | 2.217078149 |
| 2.5 | 3.8 | 1.80012E−14 | 865 | 8.65E−13 | 2.081063181 |

*This data point was assumed (not from (Bremer and Dennis, 1996)) given the fact that the number of genome equivalents in any given cell cannot be lower than 1.
**80 fg per cell (and therefore 80 micrograms/10⁹ cells) comes from slowest growing cell in FIG. 2b of (Burg et al., 2007). In this work, the mass of E. coli was measured to be 110 +/− 30 fg in excess of the displaced buffer.

A sigmoid function was then fit to the ‘% cell DNA’ column of Table 4 above. The values from this function represent the final growth rate-dependent DNA demand requirements. The constraint was imposed as in genome-scale models of metabolism (Orth et al., 2011).

Cell Wall

Biomass demand-like constraints were added to account for lipid/murein/LPS. These demands were formulated to be growth-rate-dependent, but the composition itself was assumed constant. The ‘base shell composition’ was constrained to be as shown in Table 5:

TABLE 5

| Component | | | | | |
|---|---|---|---|---|---|
| Abbreviation | Component Name | Molecular Weight | | Demand Value | |
| murein5px4p_Periplasm | two disacharide linked | 1892.848 | mg mmol⁻¹ | 0.01389 | mmol |
| | murein units, | | | | gDW⁻¹ |
| | pentapeptide | | | | |
| | crosslinked tetrapeptide | | | | |
| | (A2pm->D-ala) (middle | | | | |
| | of chain) | | | | |
| kdo2lipid4_Extra- | KDO(2)-lipid IV(A) | 1840.033 | mg mmol⁻¹ | 0.01945 | mmol |
| organism | | | | | gDW⁻¹ |
| pe160_Cytosol | phosphatidylethanolamine | 691.972 | mg mmol⁻¹ | 0.01786 | mmol |
| | (dihexadecanoyl, n- | | | | gDW⁻¹ |
| | C16:0) | | | | |
| pe160_Periplasm | phosphatidylethanolamine | 691.972 | mg mmol⁻¹ | 0.04594 | mmol |
| | (dihexadecanoyl, n- | | | | gDW⁻¹ |
| | C16:0) | | | | |
| pe161_Cytosol | phosphatidylethanolamine | 687.94 | mg mmol⁻¹ | 0.02105 | mmol |
| | (dihexadec-9enoyl, | | | | gDW⁻¹ |
| | n-C16:1) | | | | |
| pe161_Periplasm | phosphatidylethanolamine | 687.94 | mg mmol⁻¹ | 0.05415 | mmol |
| | (dihexadec-9enoyl, | | | | gDW⁻¹ |
| | n-C16:1) | | | | |

To arrive at growth-rate-dependent cell wall dilution constraints, the cell surface area (SA) is calculated assuming that the cell is a cylinder with hemispherical caps:

Volume of the cell as a function of μ in μm³,

$$v ( μ ) = ( \text{?} ( μ ) - 2 r ( μ ) ) \text{?} π \text{?} {r ( μ )}^{2} + ( 4 / 2 ) \text{?} π {r ( μ )}^{3} . \\ \text{?} \text{indicates text missing or illegible when filed}$$

An empirical relation for

$$v ( μ ) = 1.5 \text{?} 0.4 \text{?} {2}^{μ} . \\ \text{?} \text{indicates text missing or illegible when filed}$$

Given these 2 functions for volume, and also an empirical function for cell length as a function of μ in μm,

$$\text{?} ( μ ) = 1.5 \text{?} 2.6 \text{?} \text{?} , \\ one can obtain r ( μ ) = 1.5 \text{?} 0.15204137 \text{?} \text{?}$$

$$\text{?} \text{indicates text missing or illegible when filed}$$

through a least-squares optimization problem. A similar approach was taken in (Pramanik and Keasling, 1997), with the form of equations and numerical parameters taken from (Donachie and Robinson, 1987).

SA (in in μm²) can then be calculated as function of μ using the equation:

$$\text{?} A ( μ ) = 2 \text{?} π \text{?} r ( μ ) \text{?} ( I ( μ ) \cdot 2 r ( μ ) ) + 4 \text{?} π \text{?} {r ( μ )}^{2} . \\ \text{?} \text{indicates text missing or illegible when filed}$$

Next it was assumed as in (Pramanik and Keasling, 1997) that phosphatidylethanolamine makes up ˜77% of the lipids, phosphatidylglycerol 18%, and cardiolipin 5%. It was also assumed that an individual lipid has an area ˜0.5 nm² and that 50% of the surface area is created by lipids (vs. proteins or other macromolecules). We also take into account that there are 4 individual lipid layers (2 lipid bilayers).

To calculate the grams of lipid per volume of cell as a function of growth rate, the following formula is used:

$$grams of lipid per volume ( μ ) = \text{?} lipid layers ( 4 ) \text{?} traction of surface area lipid ( 0.5 ) \text{?} … \text{?} A ( μ ) \text{?} {10}^{6} \text{?} ( 1 \text{/} 0.5 {nm}^{2} ) \text{?} ( 1 / 6.02 \text{?} {10}^{23} ) \text{?} wm \text{?} ( g \text{/} mol ) , \\ \text{?} \text{indicates text missing or illegible when filed}$$

where wmw_{lipid}=: is the weighted molecular weight (in g/mol) using the assumed composition and individual molecular weights of the lipids as follows: 734.03 g/mol for phosphatidylethanolamine, 827.11 g/mol for phosphatidylglycerol, and 1546 g/mol for cardiolipin. The 10⁶ term is to correct the units, as SA(μ) is given in μm² (1 μm²=10⁶ nm²).

Next, we convert this to lipid grams per gDW using an assumed cell density of 1.105 g/mL cell and an assumption that the dry weight of the cell is roughly 30% of its total weight.

Finally, we scale the demand reactions from the ‘base shell composition’ by a scalar that causes the bottom components listed in the table above to match this calculated growth-dependent demand for lipids.

Glycogen

The glycogen content of the cell was assumed constant in all simulations (independent of growth rate) performed in this study. It was set to 0.023 grams Glycogen per gDW of biomass based on the biomass objective function in (Feist et al., 2007).

The molecular weight for glycogen was taken to be 162.141 mg mmol⁻¹.

TABLE 6
In silico growth media composition

| | Maximum Source Reaction Flux |
|---|---|
| Growth Nutrient (model identifier) | (mmol gDW⁻¹ h⁻¹) |
| Chloride (cl) | 1000 |
| Magnesium (mg2) | 1000 |
| Molybdate (mobd) | 1000 |
| Nickel (ni2) | 1000 |
| Selenate (sel) | 1000 |
| Carbon Dioxide (co2) | 1000 |
| Calcium (ca2) | 1000 |
| Zinc (zn2) | 1000 |
| Phosphate (pi) | 1000 |
| Oxygen (o2) | 1000 |
| Manganese (mn2) | 1000 |
| Ammonium (nh4) | 1000 |
| Cob(l)alamin (cbl1) | 1000 |
| Sulfate (so4) | 1000 |
| Selenite (slnt) | 1000 |
| Copper (cu2) | 1000 |
| H+ (h) | 1000 |
| Potassium (k) | 1000 |
| D-Glucose (glc_DASH_D) | 10 |
| Cobalt (cobalt2) | 1000 |
| Water (h2o) | 1000 |
| Sodium (na1) | 1000 |
| Iron(II) (fe2) | 1000 |
| Iron(III) (fe3) | 1000 |
| Tungstate (tungs) | 1000 |
| Cesium (cs) | 1000 |

All of these nutrients have the potential to be limiting for growth. An upper bound of 1000 mmol gDW⁻¹ h⁻¹ is used to simulate growth in batch culture whereas lower values are used in nutrient-limited simulations. The upper bound for D-Glucose uptake is set to 1000 for all nutrient-limited simulations except when simulating D-Glucose limitation.

### Example 7

### E. coli ME-Model Coupling Constraints

Coupling constraints may be represented with different mathematical formulae that are constructed from available data

Variables and Parameters Used in Derivations

To estimate the growth rate-dependent catalytic rates of enzymes we use the following variables and parameters.

P=total cellular protein mass (g gDW⁻¹)

R=total cellular RNA mass (g gDW⁻¹)

μ=specific growth rate (s⁻¹)

f_{rRNA}=fraction of RNA that is rRNA

f_{mRNA}=fraction of RNA that is mRNA

f_{tRNA}=fraction of RNA that is tRNA

m_{αα}=molecular weight of average amino acid (g mmol⁻¹)

mₙₜ=molecular weight of average mRNA nucleotide (g mmol⁻¹)

m_{tRNA}=molecular weight of average tRNA (g mmol⁻¹)

mᵣᵣ=mass of rRNA per ribosome (g)

k_{deg}^{mRNA}=first-order mRNA degradation constant (s⁻¹)

Other than μ and P and R (which are functions of μ (equation 1)), the others parameters are constants in derivations and their numerical values are listed in Example 6. To derive the catalytic rates of molecular machines, we rely on average values (e.g. average molecular weight of mRNA, protein). However, when transforming these into coupling constraints in the ME-Model, actual molecular weights of specific molecular species are used. For computations, all coupling parameters are computed to 4 significant digits for numerical purposes. In derivations, seconds were used as the time unit, though these were converted into hours for ME-Model computations.

Empirical RNA-to-Protein ratio

In (Scott et al., 2010) the RNA-to-Protein ratio was shown to increase linearly with growth rate, regardless of the specific environmental condition:

$$\frac{R}{P} = \frac{μ}{{κ}_{t}} + {r}_{o}$$

For E. coli grown at 37° C., (Scott et al., 2010) empirically found rₒ=0.087 and κₜ=4.5 h⁻¹. We use these values in our derivations throughout.

70S Ribosomes

Ribosomal Translation Rate and Dilution

Assume all rRNA is incorporated into ribosomes. Then:

$${n}_{r} = number of ribosomes = \frac{{Rf}_{rRNA}}{{m}_{rr}}$$

Assume proteins are stable and not degraded. Then:

$${P}_{s} = Protein synthesis rate ( aa \text{/} s ) = \frac{μ P}{{m}_{aa} }$$

Hyperbolic Ribosomal Catalytic Rate

### Let:

k′_{ribo}=average translation rate of active ribosome (aa s⁻¹)
fᵣ=fraction of ribosomes that are active
k_{ribo}=effective ribosomal translation rate (aa s⁻¹)

k_{ribo}=k′_{ribo}fᵣ

$${c}_{ribosome} = \frac{{m}_{rr}}{{m}_{aa} {f}_{rRNA}}$$

### Then:

$${k}_{ribo} = \frac{{P}_{s}}{{n}_{r}} = \frac{{c}_{ribosome} μ P}{R}$$

### Using,

$${k}_{ribo} = \frac{{c}_{ribosome} \text{?} μ}{μ + \text{?} \text{?}}$$

$$\text{?} \text{indicates text missing or illegible when filed}$$

Thus, translation rate is hyperbolic with respect to growth rate:
Vₘₐₓ=κ_{τ}c_{ribosome} and Kₘ=rₒκ_{τ}.
Using, parameters from Example 6, we get:
Vₘₐₓ=22.7 aa ribosome⁻¹ s⁻¹
Kₘ=0.391 h⁻¹.

Ribosomal Coupling

An inequality constraint was derived setting a lower bound on ribosomal dilution (to daughter cells)

The inequality is imposed in a manner that takes into account the length of each particular peptide that needs to be translated. Said another way, ribosomal machinery demands depend on the precise number of amino acids incorporated for each peptide in the model.

### Let:

V_{Ribosome Dilution}=dilution of ribosome (mmol ribosome gDW⁻¹ s⁻¹)

V_{Translation of peptide}_{ᵢ}=translation of peptidei (mmol peptidei gDW⁻¹ s⁻¹)
length(peptideᵢ)=number of amino acids in peptidei

### Then:

$${V}_{Ribosome Dilution} \geq {\sum }_{i} ( \frac{length ( {peptide}_{i} )}{{k}_{ribo} / μ} * {V}_{Translation of {peptide}_{i}} )$$

RNA Polymerase

### Let:

kᵣₙₐₚ=RNAP transcription rate (nucleotide RNAP⁻¹ s⁻¹)
The transcription rate, kᵣₙₐₚ, is taken to be exactly 3 times the translation rate at all growth rates based on data from Table 1 from (Proshkin et al., 2010).

### Then:

kᵣₙₐₚ=3k_{ribo}

Using equation, an inequality constraint was derived setting a lower bound on ribosomal dilution (to daughter cells)
The inequality was imposed in a manner that takes into account the length of each particular transcription unit (TU) that needs to be transcribed. Said another way, RNA polymerase machinery demands depend on the precise number of nucleotides transcribed for each RNA in the model.

### Let:

V_{RNAP Dilution}=dilution of RNAP (mmol RNAP gDW⁻¹ s⁻¹)
V_{Transcription of TU}_{ᵢ}=transcription of TUᵢ (mmol gDW⁻¹ s⁻¹)
length(TUᵢ)=number of nucleotides in

### Then:

$${V}_{RNAP Dilution} \geq {\sum }_{i} ( \frac{length ( \text{?} \text{?} )}{\text{?} / μ} * {V}_{Transcription of \text{?}} )$$

$$\text{?} \text{indicates text missing or illegible when filed}$$

mRNA Coupling

Dilution, Degradation, Translation Reaction Rates

For the derivation, assume that mass of mRNA transcribed, translated, degraded, and diluted is only in coding regions. In actuality, the molecular weight of mRNA will be higher due to untranslated regions, which is reflected in the values used in the ME-Model. Let:

dil_{mRNA}=dilution of mRNA (mmol nucleotides gDW⁻¹ s⁻¹)
deg_{mRNA}=degradation of mRNA (mmol nucleotides gDW⁻¹ s⁻¹)
trsl_{mRNA}=translation of protein from mRNA (mmol amino acids gDW⁻¹ s⁻¹)
[mRNA]=mRNA concentration (mmol nucleotides gDW⁻¹)

### Then:

$${dil}_{mRNA} = μ [ mRNA ]$$

$${deg}_{mRNA} = {k}_{deg}^{mRNA} [ mRNA ]$$

$${trsl}_{mRNA} = \frac{μ P}{{m}_{aa }} \\ [ mRNA ] = \frac{{Rf}_{mRNA}}{{m}_{n t}}$$

Coupling

The mRNA dilution, degradation, and translation reactions are coupled in the ME-Model with linear inequalities as followed:

dil_{mRNA}≧α₁deg_{mRNA}

deg_{mRNA}≧α₂trsl_{mRNA}

The inequality formulation allows for some mRNA transcribed to not be translated, but it still must be diluted and degraded.
When the inequality constraints are operating at their bounds, α₁ and alpha₂ will then be:

$${α}_{1} = \frac{{dil}_{mRNA}}{{deg}_{mRNA}} = \frac{μ [ mRNA ]}{{k}_{deg}^{mRNA} [ mRNA ]} = \frac{μ}{{k}_{deg}^{mRNA}}$$

$${α}_{2} = \frac{3 {deg}_{mRNA}}{{trsl}_{mRNA}} = \frac{3 {k}_{deg}^{mRNA} [ mRNA ] {m}_{aa}}{μ P} = \frac{3 {k}_{deg}^{mRNA} {Rf}_{mRNA} {m}_{aa}}{μ {Pm}_{n t}}$$

Note: The factor of 3 above is to account for 3 nucleotides per amino acid.

Hyperbolic mRNA Catalytic Rate

The above formulation also results in a hyperbolic mRNA catalytic rate.

### Let:

k_{mRNA}=mRNA catalytic rate (mmol protein (mmol mRNA)⁻¹ hr⁻¹)

$${c}_{mRNA} = \frac{{m}_{n t}}{{f}_{mRNA} {m}_{aa} } . \\ Then \text{:}$$

$${k}_{mRNA} = \frac{{trsl}_{mRNA}}{[ mRNA ]} = \frac{{c}_{mRNA} μ P}{R} .$$

### Using:

$${k}_{mRNA} = \frac{{c}_{mRNA} \text{?} \text{?}}{μ + \text{?} \text{?}}$$

$$\text{?} \text{indicates text missing or illegible when filed}$$

Using parameters in Example 6, we get:
Vmax=0.5 protein mRNA⁻¹ s⁻¹
Kₘ=0.391 h⁻¹.

Rates of Charging and Dilution of tRNA

### Let:

chg_{mRNA}=charging of tRNA (mmol tRNA gDW⁻¹ s⁻¹)
dil_{rRNA}=dilution of tRNA (mmol tRNA gDW⁻¹ s⁻¹)
[tRNA]=tRNA concentration (mmol tRNA gDW⁻¹)

### Then:

$${dil}_{tRNA} = μ [ tRNA ]$$

$${chg}_{tRNA} = \frac{μ P}{{m}_{aa} } \\ [ tRNA ] = \frac{{Rf}_{tRNA}}{{m}_{tRNA}}$$

Coupling

The tRNA dilution and charging reactions are coupled in the ME-Model with linear inequalities as followed:

dil_{tRNA}≧αchg_{tRNA}

At the bound of equality,

$$α = \frac{{dil}_{tRNA}}{{chg}_{tRNA}} = \frac{{Rf}_{tRNA} {m}_{aa}}{{Pm}_{tRNA}}$$

Hyperbolic tRNA Efficiency

The above formulation also results in a hyperbolic tRNA catalytic rate.

### Let:

k_{tRNA}=tRNA catalytic rate (mmol protein (mmol tRNA)⁻¹ hr⁻¹)

$${c}_{tRNA} = \frac{{m}_{tRNA}}{{m}_{aa} {f}_{tRNA}}$$

### Then:

$${k}_{tRNA} = \frac{{chg}_{tRNA}}{[ tRNA ]} = \frac{μ {Pm}_{tRNA}}{{m}_{aa} {Rf}_{tRNA}} = \frac{{c}_{tRNA} μ P}{R}$$

### Using:

$${k}_{tRNA} = \frac{{c}_{tRNA} \text{?} \text{?}}{μ + \text{?} \text{?}}$$

$$\text{?} \text{indicates text missing or illegible when filed}$$

Using parameters in Example 6, we get:
Vmax=C_{tRNA}κ_{τ}=2.39 aa tRNA⁻¹ s⁻¹.
Kₘ=0.391 h⁻¹.

Remaining Macromolecular Synthesis Machinery

For the remaining macromolecular synthesis machinery, we set k_{cat}=65 (s⁻¹) across all growth rates:

$${V}_{{Machinery}_{i} Dilution} \geq {\sum }_{i} ( \frac{1}{{k}_{cat} / μ} * {V}_{Use of {Machinery}_{i}} )$$

Metabolic Enzymes

For metabolic enzymes, the catalytic rate is set to be proportional to the enzyme solvent accessible surface area (SASA).

### Calculation of Solvent Accessible Surface Area (SASA):

$$SASA Enzyme i = {( Molecular Weight Enzyme i )}^{\frac{3}{4}}$$

based on the empirical fit from (Miller et al., 1987).
The specific enzyme efficiency value received for a given enzyme/complex was assumed to be linearly dependent on its SASA value. The mean of all the kinetic constants was centered at k_{eff}=65 (s⁻¹). Let sasa denote a particular value after centering.

$${V}_{Machinery {Enzyme}_{i} Dilution} \geq {\sum }_{i} ( \frac{1}{\frac{{sasa}_{Metabolic {Enzyme}_{i}}}{μ}} * {V}_{Use of Metabolic {Enzyme}_{i}} )$$

This coupling is a gross approximation for an enzyme's kinetic information. Its purpose is to reward expression of large complexes (such as pyruvate dehydrogenase which is composed of 12 AceE dimers, a 24-subunit AceF core, and 6 LpdA dimers), given these complexes have many more active sites (on average) than smaller enzymes. In the future, these values can be parameterized further using condition-specific multi-omics data.

### Example 8

### Optimization Procedure Details

By definition, the total biomass produced must be equal to the growth rate. In metabolic models, this constraint is imposed by the definition of the biomass objective function: the total mass in the biomass objective function sums to 1 g/gDW and the flux through the biomass reaction is equal to the growth rate (h⁻¹). As biomass is now split up into many dilution reactions for individual peptides, RNAs, and enzymes (to allow for variable biomass composition through gene expression) in addition to the DNA, Cell Wall, and Glycogen demand functions, this constraint is no longer explicitly enforced. The difference between Strictly Nutrient-Limited and Janusian and Batch (FIG. 9f) simulations lies in how this constraint is enforced.

For simulations in the Batch and Janusian regions (when proteome limitation is active and enzymes are saturated), an additional ‘biomass capacity constraint’ is added. This additional row appended to the stoichiometric matrix enforces that the sum of the masses of all biomass production (component dilution plus demand function fluxes) equals the growth rate. With this additional constraint, a simple binary search for the maximum feasible growth rate determines the final solution where growth rate is maximized. While the objective of the overall optimization is growth rate, the production of a random peptide is chosen to be the objective of each LP problem in the process. As expression of this random peptide is unnecessary as far as the model is concerned, the production of this peptide is 0 at the maximum growth rate.

For simulations in the Strictly Nutrient-Limited (SNL) region, a simple ‘biomass capacity constraint’ is insufficient. This is because enzymes are not saturated in nutrient-limited conditions; however, these trends are not fully understood so cannot be modeled a priori. If a direct 1:1 relationship between activity and abundance is assumed for enzymes, at low growth rates the in silico cell will produce hardly any protein or RNA. On the other hand, if the biomass capacity constraint is imposed, unnecessary RNA is produced simply to satisfy the biomass capacity requirement (as it is cheaper metabolically than protein) and enzymes are fully saturated, which is not accurate. Thus, it was assumed that the cell makes as much protein as possible (as it is generally the functional machinery of a cell); then it was assumed that this protein is all metabolic protein and the proteins are not saturated (so do not operate at keat). This is accomplished through two binary search procedures. In the first, the production of a ‘dummy protein’ is maximized, and a growth rate, μ*, is searched for where growth rate is equal to biomass dilution. The solution after this initial binary search will generally have a non-zero dummy protein production. Then, the growth rate, μ*, is fixed and a binary search for the minimal fractional enzyme saturation (k_{eff}/k_{cat}) is found. At minimal fractional enzyme saturation and μ*, the dummy protein production will be 0. The qualitative shape of k_{eff}/k_{cat} vs. μ obtained matches empirical trends for individual enzymes and small-scale kinetic models (FIG. 9e), supporting the validity of the simulation procedure. However, this is only an approximation as the scaling of metabolite levels will be specific to the nature of the nutrient limitation and that other proteins not directly used for growth are upregulated at lower growth rates.

For most simulations (unless all uptakes are unbounded), it is not known if the specific uptake bounds will result in a solution that lies in the Strictly Nutrient-Limited, Janusian, or Batch growth region. For these cases, they are first solved as SNL. If no feasible solution is found where growth rate is equal to biomass dilution, the biomass capacity constraint is added and the problem is solved using the proteome-limited procedure.

With ME-Models, linear optimization begins to encounter scaling and/or infeasibility issues. To mitigate this problem, we used the SoPlex LP solver (freely available at http://soplex.zib.de/ http://soplex.zibde) (Roland, 1996), which provides for solving the individual LPs using extended precision floating point numbers (80 bits) on x86 processors.

### Example 9

### Simulation of Growth, Uptake, and Yield with Variable Coupling Constraints

As an initial validation of the E. coli ME-Model, we compare the computationally predicted and experimentally measured total RNA and protein content of the cell. The ratio of RNA to protein biomass in E. coli (and other microbes) has been shown to follow consistent ‘growth laws’ in which the RNA-to-protein ratio increases linearly with growth rate, independent of the specific medium (Scott et al., 2010) (FIG. 9c). It was found that the effective ribosomal translation rate (amino acids per ribosome per second) must systematically change with growth rate in order to quantitatively match the experimentally observed trend in the RNA-to-protein ratio (FIG. 9c). Specifically, it was found that the effective translation rate increases with growth rate hyperbolically, approaching ˜20 amino acids per second. This maximum translation rate is consistent with previous estimates and occurs around the cell's fastest observed growth rate (Bremer and Dennis, 1996).

Metabolic enzymes also display lower effective catalytic rates at lower growth rates. Experiments suggest that the effective catalytic rates of metabolic enzymes are specific to a given nutritional environment (Boer et al., 2010) (i.e., the identity of the limiting nutrient matters). This phenomenon is well-recognized for transporters under nutrient limitation—enzyme kinetics dictate that at a lower external nutrient concentration, transporters will have a lower effective catalytic rate (O'Brien et al., 1980) (FIGS. 9d-f).

What is less well appreciated, though, is that many internal enzymes also display lower effective catalytic rates under nutrient limitation. Quantitative metabolomics data shows that internal enzymes become less saturated when external nutrients are limited. In nutrient-excess conditions (i.e., batch culture), [S]˜Kₘ (Bennett et al., 2009); however, in nutrient-limited conditions (i.e., chemostat culture), internal metabolites ‘related’ to the limiting nutrient have a lower concentration ([S]<Kₘ) (Boer et al., 2010). These trends also occur in a small-scale kinetic model (Molenaar et al., 2009).

These changes were accounted for in metabolic enzyme catalysis in the ME-Model with two minimal assumptions: (1) that when the cell is nutrient limited, protein content is maximized (at a given growth rate) and, (2) that this protein mass is metabolic enzymes not operating at their maximal catalytic rate (i.e., k_{eff}/k_{cat}<1). This procedure results in a calculated nutrient limitation-dependent effective catalytic rate with the same qualitative shape as experimental data (FIG. 9e). As a first approximation, changes were distributed in effective catalytic rate evenly across the metabolic network. In actuality, changes are likely more dramatic in a subset of metabolic enzymes ‘related’ to the limiting nutrient for growth (Boer et al., 2010).

Prediction of Growth Rate, Nutrient Uptake, and Yield

Growth, nutrient uptake, and by-product secretion rates are some of the most informative and concise descriptions of the physiological state of a microbial cell (Monod, 1949; Neidhardt, 1999). However, the underlying determinants of growth, uptake, and secretion are not generally understood. The ME-Model was used to predict the relationship between growth rate, nutrient uptake, and secretion under varying external nutrient availability. Importantly, the interplay between external (nutrient) and internal (proteome) growth limitations can be simultaneously reconciled using the ME-Model.

In nutrient-excess conditions, growth in the ME-Model is limited by internal constraints on protein production and catalysis—the cell is ‘proteome-limited’—resulting in a corresponding maximal growth rate (FIG. 9f). The ME-Model predicts optimal substrate uptake rates corresponding to the maximal growth rate (FIG. 9f).

The ME-Model-predicted response to glucose limitation was detailed. When the uptake of glucose is restricted below the amount required for optimal growth in batch culture, the cell's growth is carbon-limited. Growth rate linearly increases with glucose uptake when glucose availability is low (FIG. 9f region denoted as Strictly Nutrient-Limited (SNL)), the capabilities of the proteome are not fully utilized as the proteome could process more incoming glucose if it were available. By varying the uptake rate of glucose, it was found that a region exists in which the cell is both nutrient- and proteome-limited (FIG. 9f region denoted as Janusian) (Button, 1991). ME-Model computations thus reveal three distinct microbial growth regions (FIG. 9f).

Simulating small molecular by-product yield (FIG. 9g) and biomass yield (FIG. 9f) as a function of growth rate in defined medium can identify linear and non-linear regions. Under Nitrogen (Ammonium) limitation with glucose in excess, the ME-Model predicts that acetate will be secreted and that carbon metabolism will again operate ‘wastefully’ (FIG. 9g). This secretion phenotype is seen experimentally (Hua et al., 2004) and can be explained as follows: protein ‘saved’ by utilizing low-yield carbon metabolism is diverted to protein involved in nitrogen metabolism, which is not operating at its maximal catalytic capacity (due to low nitrogen metabolite levels). In other words, carbon metabolism is proteome-limited, whereas nitrogen metabolism is nutrient-limited.

As nutrient levels are varied, the balancing of proteomic resources to maximize growth results in intricate behavior and trade-offs. With integrated treatment of metabolism and protein synthesis, a ME-Model can compute this interplay and the optimal allocation of cellular processes.

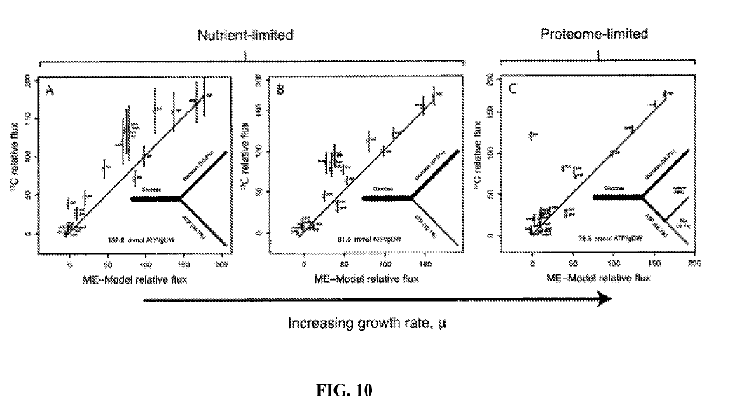

FIGS. 9 (a-h) show that applying empirically-derived growth demands and coupling constraints leads to accurate predictions of growth rate-dependent changes in ribosome efficiency, qualitatively accurate changes in growth rates as a function of substrate uptake, and qualitatively accurate product yields as a function of growth rate. FIG. 9 (a) Three growth rate-dependent demand functions derived from empirical observations determine the basic requirements for cell replication. FIG. 9 (b) Coupling constraints link gene expression to metabolism through the dependence of reaction fluxes on enzyme concentrations. FIG. 9 (c) RNA:protein ratio predicted by the ME-Model with two different coupling constraint scenarios, one for variable translation rate vs. growth rate (upper line) and one for constant translation rate (lower line). Experimental data in obtained from (Scott et al., 2010, Science, 330, 1099-102). [0043] FIG. 10 (a-c) show how ME-Model predictions may be compared to fluxomics data and to assess the flux of substrate carbon source directed towards specific biological processes. FIG. 9 (d) Phosphotransferase system (PTS) transient activity following a glucose pulse in a glucose-limited chemostat culture (upper triangles) and glucose uptake before the glucose pulse (lower triangles) is plotted as a function of growth rate. The data shown was obtained from (O'Brien et al., 1980, J Gen Microbiol, 116, 305-14). Data from μ>0.7 h⁻¹ was omitted. FIG. 9 (e) Data from FIG. 9 (d) is used to plot glucose uptake as a fraction of PTS activity. The resulting value is the fractional enzyme saturation (solid line). The fractional enzyme saturation predicted by the ME-Model is plotted as a function of growth rate under carbon-limitation (dotted line). FIG. 9 (f) shows predicted growth rate is plotted as a function of the glucose uptake rate bound imposed in glucose minimal media. Three regions of growth are labeled Strictly Nutrient-Limited (SNL), Janusian, and Batch (i.e., excess of substrate) based on the dominant active constraints (nutrient- and/or proteome-limitation). The proteome-activity constraint inherent in the ME-Model results in a maximal growth rate and substrate uptake rate. The behavior of a genome-scale metabolic model (M-Model) is depicted with an arrow. FIG. 9 (g) Experimental (triangle) and ME-Model-predicted (circle) acetate secretion in Nitrogen-(light) and Carbon- (dark) limited glucose minimal medium are plotted as a function of growth rate. Data obtained from (Zhuang et al., 2011, Mol Syst Biol, 7, 500). FIG. 9 (h) Experimental (triangle) and ME-Model-predicted (circle) predicted carbon yield (gDW Biomass/g Glucose) in Carbon- (dark) and Nitrogen- (light) limited glucose minimal medium are plotted as a function of growth rate. Data obtained from (Zhuang et al., 2011, Mol Syst Biol, 7, 500).

### Example 10

### Central Carbon Fluxes Reflect Growth Optimization Subject to Catalytic Constraints

At a more detailed level, the ME-Model predicts genome-scale changes in metabolic fluxes. Previous studies have evaluated the ability of M-Models (which do not include protein synthesis) together with assumed optimality principles to predict metabolic fluxes as inferred from ¹³C fluxomic datasets (Nanchen et al., 2006; Schuetz et al., 2007; Schuetz et al., 2012). These studies concluded that no single ‘objective function’ applied to M-Models can accurately represent fluxomic data from all environmental conditions studied (Schuetz et al., 2007). Instead, metabolic fluxes can be understood as being ‘Pareto optimal’: multiple objectives are simultaneously optimized and their relative importance varies depending on the environmental condition (Schuetz et al., 2012). The three objectives needed to explain most of the variation in the data from Schuetz et al. were: (1) maximum ATP yield, (2) maximum biomass yield, and (3) minimum sum of absolute fluxes (which is a proxy for minimum enzyme investment). These three objectives formed a Pareto optimal surface that was valuable for interpreting fluxomic data; however, the surface was large and it was not possible to predict the importance of each of the objectives a priori.

FIG. 10 (a) compares nutrient-limited model solutions to chemostat culture conditions. FIG. 10 (b) compares nutrient-limited model solutions to chemostat culture conditions for faster growth. FIG. 10 (c) compares the batch ME-Model solution to batch culture data. All simulations and experiments correspond to growth in glucose minimal media. Fluxes are normalized so that glucose uptake is 100. Insets show the main flux changes under increasing glucose concentrations. The only model parameter that is modulated is the glucose uptake rate bound. Data obtained from (Nanchen et al., 2006, Appl Environ Microbiol, 72, 1164-72; Schuetz et al., 2007, Mol Syst Biol, 3, 119). The ME-Model flux for the reaction ‘pyk’ is taken to include phosphoenolpyruvate (PEP) to pyruvate (PYR) conversion via the phosphotransferase system (PTS). Flux splits shown as insets were computed using the ME-Model. The percentages indicate the percent carbon (Glucose) converted to CO2 (for branch labeled ‘TCA’), acetate, and biomass. Both the TCA and acetate branches contribute to ATP production. The total mmol ATP per gDW biomass produced is indicated.

By explicitly accounting for variable growth demands, enzyme expression, and constraints on enzymatic activity, the ME-Model eliminates the need for multiple objectives. Using the E. coli ME-Model we show that growth rate optimization alone is sufficient to predict the fluxes through central carbon metabolism (FIGS. 10a-c). The three original objectives chosen by Schuetz et al. are biologically meaningful dimensions and required for interpreting fluxomic data when using an M-Model. In contrast, ME-Model simulations account for all three of these dimensions implicitly during growth rate maximization without adjusting any model parameters. Accordingly, ME-Models can precisely determine the importance and weighting of the ‘objectives’ for growth in a given environment. Ultimately, the primary changes in flux through central carbon metabolism can be understood as responses to the same constraints causing the observed relationship in biomass yield (FIGS. 10a-c): at low growth rates under carbon limitation, the dominant changes are due to a changing ATP demand, and in the transition from carbon-limited to carbon-excess (proteome-limited) conditions, the primary changes are due to the switch to lower yield carbon catabolism. Outliers of these comparisons may be used to drive model improvement; for example, because the measured flux for lpd does not correlate well with the predicted flux (FIG. 10c) it is possible that the k_{cat} ME-Model parameter for lpd should be altered.

### Example 11

### In Silico Gene Expression Profiling from Nutrient-Limited to Batch Growth Conditions

Gene expression changes were analyzed in the context of the ME-Model to provide a wider view of the molecular response to glucose limitation. The ME-Model was used to simulate the transcriptome and proteome as a function of growth rate and then examine the relative differences in transcriptome and proteome for different growth rates. We identify groups of proteins that change their expression concertedly from low to high growth rates under glucose limitation, and provide new insight into why certain proteins have characteristic profiles. We also identify how these concerted changes might be regulated.

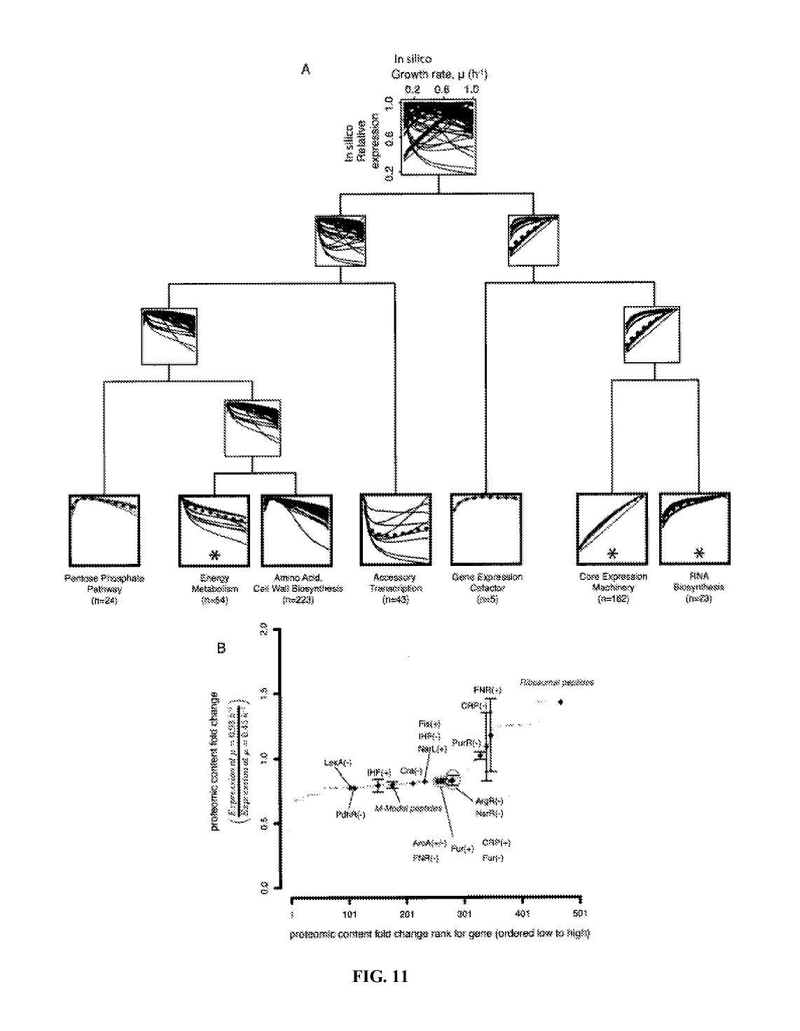

FIGS. 11 (a-b) show predictions of dynamic changes in gene expression as a function of cellular phenotypes and how these predictions may be investigated to identify coordinated changes in biological functions and proteome composition. FIG. 11 (a) shows ME-Model-computed relative gene-enzyme pair expression is plotted as a function of growth rate; the normalized in silico expression profiles are clustered hierarchically. Solid lines are expression profiles of individual gene-enzyme pairs and dotted black lines are the centroid of each cluster. Each leaf node is qualitatively labeled by function. Asterisks indicate clusters with monotonic expression changes that significantly match the directionality observed in expression data (Wilcoxon signed-rank test, p<1×10⁴). Expression data was obtained from a previous study (Ranno et al., 2010, Journal of Biotechnology, 145, 60-65) in which E. coli was cultivated in a chemostat at dilution rates 0.3 h⁻¹ and 0.5 h⁻¹. FIG. 11 (b) ME-Model-computed fold changes (as a fraction of total proteome content) for all genes expressed in glucose minimal media from growth rates of 0.45 h⁻¹ to 0.93 h⁻¹ (chosen to span the Strictly Nutrient-Limited region) are plotted in rank order (grey points). Transcriptionally regulated gene groups (regulons) were obtained from RegulonDB and split up into separate activation (+) and repression (−) components. The median fold change of all genes in a given component of a regulon was computed and those with 10 or more genes are displayed diamonds). The error bar for each indicates the median absolute deviation (MAD) from the median fold change, provided this error is at least 2% of the median. Grey labels denote gene groups that are not regulons.

In the Strictly Nutrient-Limited region, the expression of most proteins decreases as growth rate increases (FIG. 11a). The largest group of proteins includes those responsible for amino acid and cell wall synthesis; the growth rate-dependent decrease in expression of these proteins is due to the combined effects of a decrease in cell wall and protein biomass (g/gDW) and an increase in the effective catalytic rate of enzymes. Proteins involved in energy metabolism also decrease in expression with increasing growth rate due to changes in catalytic rate. Surprisingly, the predicted expression levels of several accessory transcription proteins, including four stress-associated sigma factors (RpoS, RpoH, RpoE, RpoN), are elevated at very low growth rates, reflecting an association with metabolic proteins needed for slow growth.

A smaller number of proteins show increases in their relative expression levels at higher growth rates (FIG. 11a). These proteins include those responsible for protein synthesis (ribosome, RNAP, and accessory proteins such as elongation factors) and proteins involved in RNA biosynthesis. The increase in expression of RNA biosynthetic machinery is necessary for de novo synthesis of ribonucleotides and to ensure flux through nucleotide salvage pathways (mainly to support an increase in rRNA biomass). Lastly, the expression profile of the pentose phosphate pathway can be understood as an interplay between the increasing demand for ribonucleotide precursors and the decreasing demand for amino acid precursors.

The simulated expression profiles can be related to molecular mechanisms known to control growth rate-dependent gene expression in vivo. In addition to direct transcription factor (TF) interactions, in vivo gene expression levels are influenced by the physiological state of the cell (Berthoumieux et al., 2013). Growth rate-dependent regulation of translation machinery has been extensively characterized (Dennis et al., 2004; Condon et al., 1995); however, there have been few studies describing such control mechanisms for other genes. It was previously shown that the steady-state expression of a constitutively expressed gene decreases as growth rate increases (Klumpp et al., 2009) due to a decrease in the availability of free RNAP as cells grow faster (Klumpp and Hwa, 2008). We predict that most metabolic proteins decrease in expression at higher growth rates (FIG. 11b) and could therefore be regulated by this global mechanism. Regulation via TFs can oppose or strengthen the global effects caused by growth rate-dependent RNAP availability, depending on mode (i.e., activator or repressor) and regulatory topology of the TF (Klumpp et al., 2009). It was found that genes in the PurR regulon maintain relatively high expression levels as growth rate increases (FIG. 11b), raising the possibility that PurR (an autorepressor) has a dual role in vivoto respond to exogenous signals (such as the external adenine concentration) and to respond to internal demands that vary with growth rate. This role for PurR has not been proposed even though it has been characterized extensively (Cho et al., 2011).

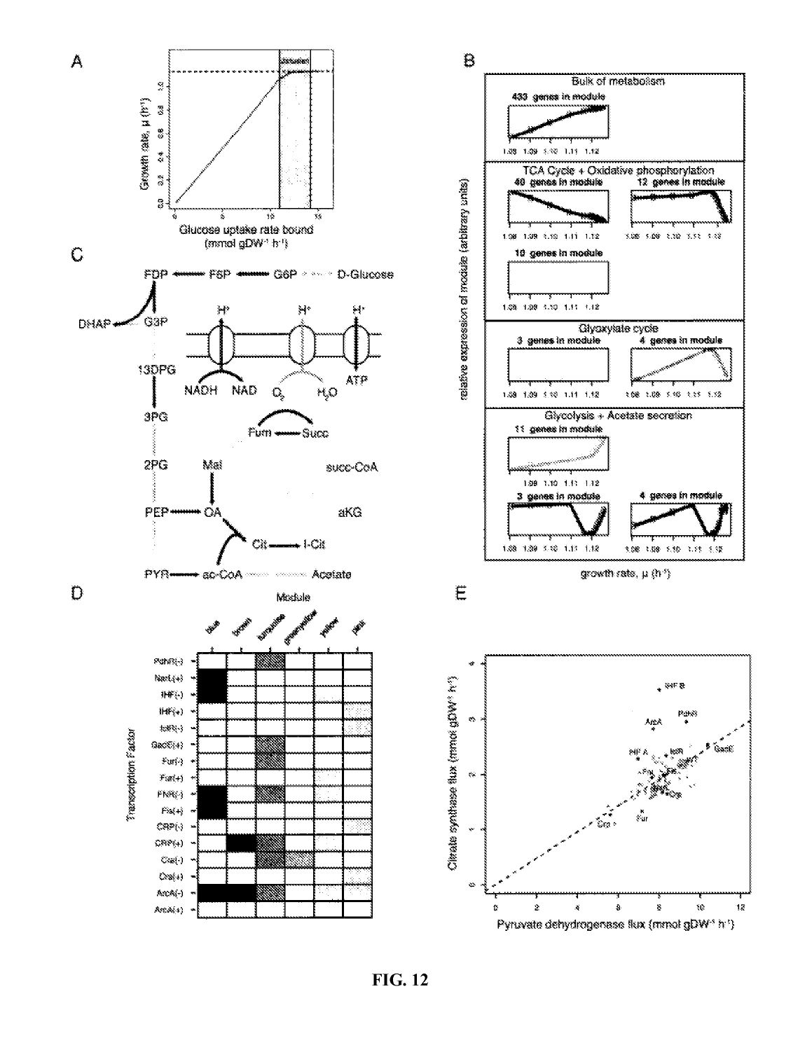

In the Janusian region of growth (FIG. 12a), the cell transitions from carbon-limited to proteome-limited constraints, resulting in a distinct transcriptional response. At the beginning of this transition, the cell has reached a nutrient level where enzymes are saturated; as growth rate increases, the total demand of anabolic processes increases, causing a global increase in the bulk of metabolism and gene expression machinery (FIG. 12b). In order to meet these proteome demands, energy metabolism is altered to favor lower yield catabolic pathways that require less protein (so that the protein can instead be used for anabolic processes); this is accomplished through a decrease in TCA Cycle and Oxidative Phosphorylation expression in favor of a transient increase in the Glyoxylate Cycle followed by a large increase in Glycolysis and acetate secretion (FIGS. 12b-c).

FIGS. 12 (a-e) show how predicted changes in gene expression as a function of time can be visualized to show coordinated changes in biological processes, provide a graphical representation of dynamic changes to specific pathways, and identify transcription factors that may be responsible for shaping the changes in gene expression. FIG. 12 (a) Gene expression changes predicted by the ME-Model to occur in the Janusian growth region indicated in the shaded region under glucose limitation in minimal media are analyzed. FIG. 12 (b) Simulated expression profiles are clustered using signed power (13=25) correlation similarity and average agglomeration. A freely available R package was used (Langfelder and Horvath, 2008, BMC Bioinformatics, 9, 559). Eleven clusters resulted. Two small clusters were removed because they represented stochastic expression of alternative isozymes. The first principal component of the remaining nine clusters are displayed and grouped qualitatively by function. FIG. 12 (c) Many of the expression modules correspond to genes of central carbon energy metabolism. FIG. 12 (d) Hypergeometric test results for over-representation of transcriptional regulators within a given module compared to a background of all expressed model genes. Each regulator is tested separately for Activation (+) and/or Repression (−). FIG. 12 (e) Measured changes in the citrate synthase-pyruvate dehydrogenase flux split from ¹³C experiments after transcription factor knockout in glucose batch culture are plotted (data obtained from (Haverkorn van Rijsewijk et al., 2011, Mol Syst Biol, 7, 477)). Grey points are all experimental values and black points correspond to transcription factors significantly associated with modules in (d). The grey star denotes the wild type flux split.

The gene modules that change during the transition to nutrient-excess growth can be related known transcriptional regulatory interactions. Several TFs regulate genes predicted to significantly change in the shift (FIG. 12d). We compared changes in the flux split leading to acetate secretion (taken to be a general indicator of the carbon-limited to carbon-excess transition) after TF knockouts in batch culture (Haverkorn van Rijsewijk et al., 2011) and found the identified TFs to cause some of the largest changes in the flux split (FIG. 12e).

The ability of the ME-Model to compute high-resolution molecular phenotypes reveals network-wide patterns in gene expression under glucose limitation. Even though regulatory constraints and interactions are beyond the scope of the ME-Model, the patterns it predicts are highly consistent with our knowledge of broad-acting TFs.

### Example 12

### Prediction of Gene Expression Shifts Following Adaptive Laboratory Evolution

Here we show that the ME-Model can be used to identify changes in biological parameters that occur during adaptive evolution. In the ME-Model, evolution to higher growth rates under nutrient-excess conditions can be simulated by relaxing at least one model constraint. Parameters related to various growth demands and the efficiency of the proteome were investigated. The ME-Model can simulate changes in gene expression (and other phenotypic properties) after the parameter change leading to a higher growth rate.

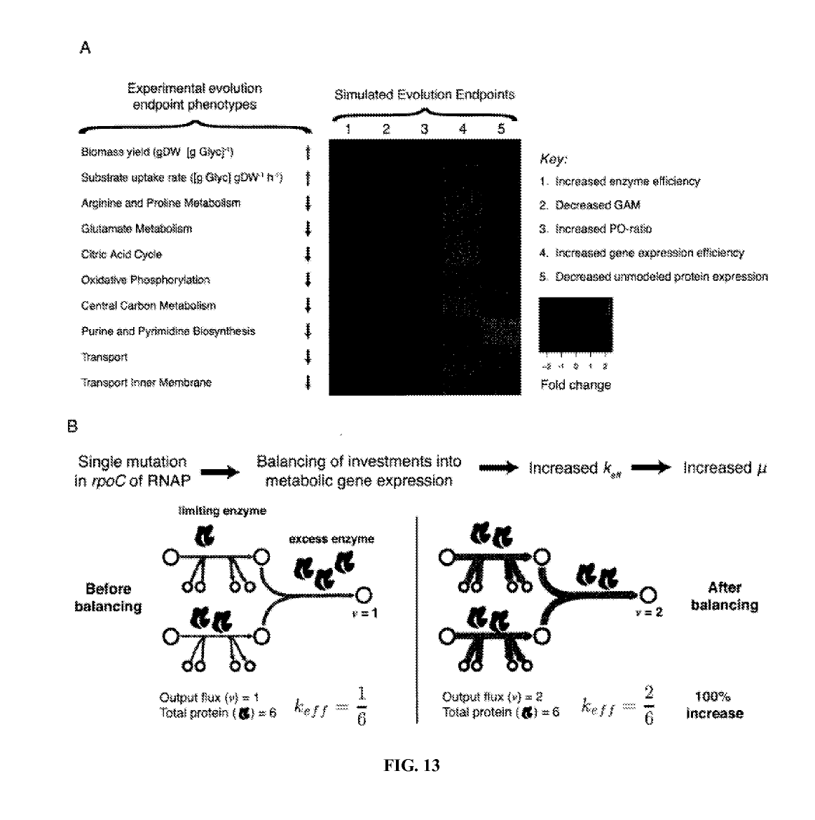

When E. coli is grown in glycerol in batch culture (Conrad et al., 2010), mutations in rpoC leading to gene expression changes consistently occur. In silico changes in substrate uptake rate, biomass yield, and expression of cellular subsystems to measurements from evolved strains were compared. It was found that increasing the effective catalytic rate of enzymes in the ME-Model results in phenotypic changes that are consistent with experiments (FIG. 13a). The ME-Model thus provides a systems-level hypothesis for the mechanism of evolution: The altered gene expression caused by the mutated RNA polymerase results in a rebalancing of the proteome (FIG. 13b).

FIGS. 13(a-b) show how perturbing ME-Model parameters can aid the development of hypotheses to explain discrepancies between the ME-Model and experimental data. FIG. 13 (a) shows how ME-Model parameter analyses can be used to identify biological parameters that explain transcriptome remolding after evolution. Evolution results in changes in biomass yield, substrate uptake rate, and the differential expression of genes in the subsystems listed (Conrad et al., 2010, Proc Natl Acad Sci USA, 107, 20500-5). The directionality of the change during evolution is shown with arrows. Five different global parameters that affect the maximum growth rate achievable in ME-Model simulations were simulated. For each parameter, changes in the identified phenotypes are calculated after a change in the parameter that would increase the maximum growth rate in the ME-Model. The fold change of subsystems in the ME-Model is calculated based on the change in the fractional proteome mass of all genes in that subsystem. Increasing k_{eff} produces results most consistent with experimental data. FIG. 13 (b) Simulation results combined with gene expression and physiological data from wild-type and evolved strains support an increase in whole-cell k_{eff}. In vivo, the increase in k_{eff} is likely achieved by balancing investments into metabolic gene expression to achieve the maximal growth rate. k_{enff}, enzyme efficiency

### Example 13

### Procedure for Evaluating Product Secretion Rate, Yield, and Sensitivity Under Evolution

Identify the environmental and/or organismal constraints corresponding to two conditions of interest C1 and C2. The environmental constraints are defined by media composition and the organismal constraints are defined by the production/activity of specific model components (e.g. genes, reactions, metabolites).

Use our optimization method to find the maximum feasible value for the selected trait, T, (e.g growth rate) subject to the environmental and organismal constraints C1 and C2.

Determine the changes in the phenotype(s) of interest (e.g. gene expression levels) between the results of C1 and C2.

If desired, identify regulators that promote and/or interfere with the computed shift between C1 and C2 based on known or computationally predicted regulatory interactions.

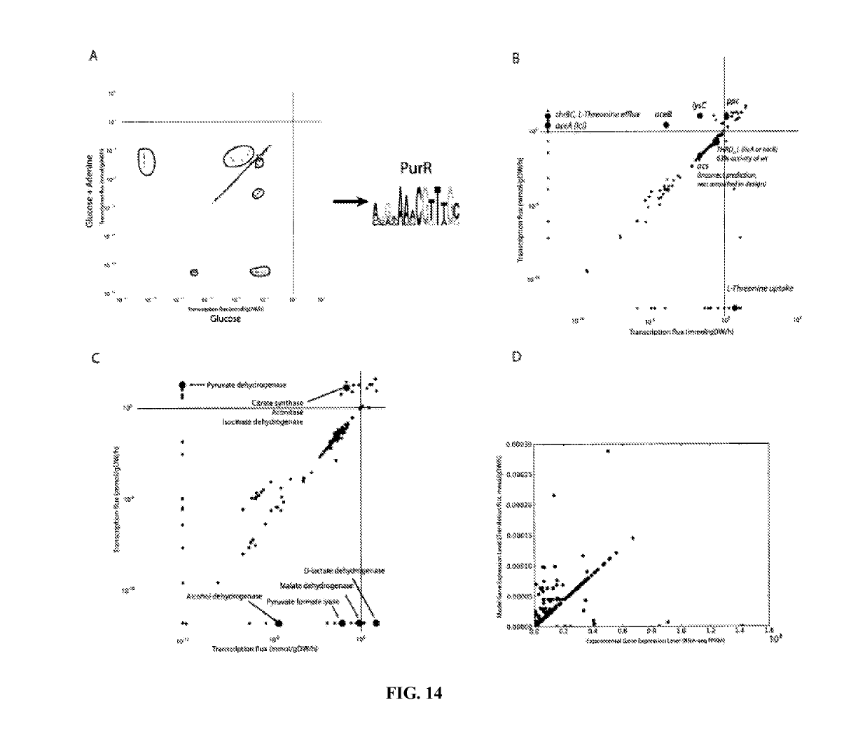

As a demonstration, we use the above method both to both look at environmental perturbations (FIG. 14a) and the forced production of natural (FIG. 14b) and non-natural chemicals (FIG. 14c). In each plot, we compare two conditions; the conditions that are off of the diagonal are indicative of genes and/or reactions that change during the shift.

The method can also be extended to include the parameter sensitivity analysis or the inclusion of a organismal state determined with omics data The method can also be extended to simulate the whole transition between C1 and C2 (instead of just the end points).

Procedure for using omics data to constrain the functional state of an organism.

Constrain the growth rate of the organism as predicted or measured experimentally.

Optionally, constrain substrate uptake, secretion, and/or metabolic fluxes as measured experimentally.

Determine a suitable set of kinetic parameters for enzymes, or sample a range of parameters to account for their uncertainty.

Subject to the imposed constraints in 1, 2, and 3, minimize the (relative) error between measured and modeled gene expression. For example, this can be achieved with the objective, minimize: |v_{model}/v_{data}−1|.

As a demonstration, we have applied the procedure to determine the state of wild-type E. coli grown in glucose minimal medium in aerobic batch culture (FIG. 14d). We fixed the growth rate as measured and minimized the relative error between gene translation flux and measured gene expression by RNA sequencing.

The method is not limited to the particular measure of gene expression and multiple measures (e.g. RNA abundance and protein abundance) of gene expression can be simultaneously accounted for.

FIGS. 14 (a-d) show how perturbations to environmental and organismal parameters reshape the metabolic and macromolecular phenotypes and how the simulations can be compared to data or omics data can be used to constrain the simulations. FIG. 14(a) shows simulated changes in fluxes in two different growth media. The environmental shift associated with the addition of a small-molecule, adenine, to glucose minimal medium was simulated. The genes predicted to change in this shift were used to search for a regulator that could cause this shift (based on the genome sequence upstream of the genes). It was found that purR, which is known to sense and respond to adenine, to be the dominant regulator, validating the simulation predictions. FIG. 14(b) shows simulated changes in fluxes when simulating production of threonine, a natural compound synthesized by E. coli. gene expression was simulated from a cell producing threonine and a wild-type cell maximizing it's growth rate in glucose minimal medium; threonine was added as an available nutrient to the wild-type cell in order to detect pathways that uptake and utilize threonine. Large dots indicate genes that were modulated in a previously engineered strain that produces threonine, validating a number of our predictions, and revealing a number of new targets to increase production. FIG. 14(c) shows simulated changes in fluxes when simulating production of a non-natural compound (1,4-butanediol (BDO)) by genetically manipulated E. coli. Gene expression was simulated from a cell producing BDO and a wild-type cell maximizing its growth rate in glucose minimal medium. Large dots indicate enzymes that were modulated in a previously engineered strain that produces BDO, validating a number of our predictions, and revealing a number of new targets to increase production. FIG. 14 (d) shows the resulting comparison of the modeled and measured gene expression levels. Genes that are off of the diagonal indicate genes that cannot match measured experimental values with the enzyme kinetic parameters used. These predictions can then be used to determine in vivo efficiency of enzymes in a given environmental condition. The organismal state predicted by the model can also be used to identify pathways or genes whose activity or use is not optimal for a desired phenotype.

Although the invention has been described with reference to the above example, it will be understood that modifications and variations are encompassed within the spirit and scope of the invention. Accordingly, the invention is limited only by the following claims.

1-65. (canceled)

66. A method of generating a model to determine the metabolic and macromolecular phenotype of an organism comprising:
(a) generating a biochemical knowledgebase of an organism that includes both metabolic and macromolecular synthetic pathways;
(b) generating a computational model from the knowledgebase of (a) by applying at least one coupling constraint;
(c) using the model of (b) to determine the metabolic and macromolecular phenotype of the organism as a function of genetic and environmental parameters; and
(d) computing metabolic and macromolecular changes associated with a perturbation of the organism or organism's environment, thereby generating a model.

67. The method of claim 66, wherein the biochemical knowledgebase includes a growth rate-dependent calculation of a structural reaction using lipid content; metal ion content; energy requirements of the organism; dNTP requirements for the production of the organism's genome; ribosome production; information regarding the organism's genome, proteome, RNAs, metabolic pathways and reactions, macromolecular synthesis pathways and reactions, energy sources and uses, reaction by-products, protein complexes, reactions to post-translationally modify/functionalize protein complexes, macromolecular synthesis machinery, transcription units, lipid content, metal ion requirements, amino acid content, or any combination thereof.

68. The method of claim 66, wherein the perturbation of the organism or its environment is a change in genetic or environmental parameters.

69. The method of claim 68, wherein the change in genetic or environmental parameters is selected from the group consisting of: change in the composition of growth media; sugar source; carbon source; nitrogen source; phosphorous source; growth rate; ribosome production; presence, absence or change in concentration of an antibiotic; oxygen level; efficiency of macromolecular machinery; subjection to a chemical compound; genetic alteration; forced overproduction of a network component; introduction of heterologous genetic material; introduction of synthetic genetic material; inhibition or hyperactivity of at least one enzyme; protein engineering of specific chemical residues leading to modulated catalytic efficacy and any combination thereof.

70. The method of claim 66, wherein the perturbations are subsequently related to the endogenous regulatory network to determine regulators that may facilitate or interfere with the process of achieving a desired phenotype to discover new regulatory capacities in the organism.

71. The method of claim 66, where perturbation is at least one change in basic model parameters to determine the most relevant parameters.

72. The method of claim 66, wherein the metabolic and macromolecular changes are selected from the group consisting of: alterations in gene expression, alterations in protein expression, alterations in RNA expression, translation, transcription, pathway activation or inactivation, production of metabolic by-products, energy use, growth rate, proteome changes and transcriptome changes or any combination thereof.

73. The method of claim 72, wherein the metabolic by-products are selected from the group consisting of acetate secretion and hydrogen production.

74. The method of claim 72, where in the proteome changes are selected from the group consisting of amino acid incorporation rate, protein production, macromolecular synthesis, ribosomal protein expression, expression of peptide chains, enzyme expression, enzyme activity, RNA to protein mass ratio, protein degradation, post translational protein modification, proteome fluxes, translation and protein expression profile or any combination thereof.

75. The method of claim 72, wherein the transcriptome changes are selected from the group consisting of: gene expression, transcription, functional RNA expression, transcriptome fluxes, transcription rate, gene expression profile or any combination thereof.

76. The method of claim 66, wherein the coupling constraints are applied to system boundaries, maximal transcriptional rate for stable RNA and mRNA, relaxing of the requirement that all synthesized components need to be used within the network, mRNA dilution, mRNA degradation or complex dilution, hyperbolic ribosomal catalytic rate, ribosomal dilution rate, RNA polymerase dilution rate, hyperbolic mRNA rate, coupling of mRNA dilution, degradation and translation reactions, coupling of tRNA dilution and charging reactions, macromolecular synthesis machinery dilution rate, metabolic enzyme dilution rate or any combination thereof.

77. The method of claim 76, wherein the coupling constraint for mRNA dilution is V_{mRNA Dilution}≧aₘₐₓ*V_{mRNA Degradation}; wherein aₘₐₓ is T_{mRNA}/T_{d}; the coupling constraint for mRNA degradation is V_{mRNA Degradation}≧bₘₐₓ*Vₜᵣₐₙₛₗₐₜᵢₒₙ; wherein bₘₐₓ=1/kₜᵣₐₙₛₗₐₜᵢₒₙ*T_{mRNA}; the coupling constraint for complex dilution is V_{Complex Dilution}≧cₘₐₓ*V_{Complex Usage}; wherein cₘₐₓ=1/k_{cat}*T_{d}; the hyperbolic ribosomal catalytic rate is
$${k}_{ribo} = \frac{{c}_{ribosome} \text{?} μ}{μ + \text{?} \text{?}} ;$$
$$\text{?} \text{indicates text missing or illegible when filed}$$
the ribosomal dilution rate is
$${V}_{Ribosome Dilution} \geq {\sum }_{i} ( \frac{length ( {peptide}_{i} )}{{k}_{ribo} / μ} * {V}_{Translation of {peptide}_{i}} ) ;$$
the RNA polymerase dilution rate is
$$\text{?} \geq {\sum }_{i} ( \frac{length ( \text{?} )}{\text{?} / μ} * \text{?} ) ;$$
$$\text{?} \text{indicates text missing or illegible when filed}$$
the coupling of mRNA dilution, degradation and translation reactions is dil_{mRNA}≧α₁deg_{mRNA} and deg_{mRNA}≧α₂trsl_{mRNA}, wherein
$${α}_{1} = \frac{{dil}_{mRNA}}{{deg}_{mRNA}} = \frac{μ [ mRNA ]}{{k}_{deg}^{mRNA} [ mRNA ]} = \frac{μ}{{k}_{deg}^{mRNA}} and$$
$${α}_{2} = \frac{3 {deg}_{mRNA}}{{trsl}_{mRNA}} = \frac{3 {k}_{deg}^{mRNA} [ mRNA ] {m}_{aa}}{μ P} = \frac{3 {k}_{deg}^{mRA} {Rf}_{mRNA} {m}_{aa}}{μ {Pm}_{n t}} ;$$
the hyperbolic mRNA rate is
$${k}_{mRNA} = \frac{{c}_{m RNA} \text{?} μ}{μ + \text{?} \text{?}} ;$$
$$\text{?} \text{indicates text missing or illegible when filed}$$
the hyperbolic tRNA efficiency rate is k_{tRNA}=c_{tRNA}κ_{τ}μ/μ+rₒκ_{τ}; the coupling of tRNA dilution and charging reactions is dil_{tRNA}≧αchg_{tRNA}, wherein
$$α = \frac{{dil}_{tRNA}}{{chg}_{tRNA}} = \frac{{Rf}_{tRNA} {m}_{aa}}{{Pm}_{tRNA}} ;$$
the macromolecular synthesis machinery dilution rate is
$${V}_{{Machinery}_{i} Dilution} \geq {\sum }_{i} ( \frac{1}{{k}_{cat /} / μ} * {V}_{Use of {Machinery}_{i}} ) ;$$
and/or the metabolic enzyme dilution rate is
$${V}_{Metabolic {Enzyme}_{i} Dilution} \geq {\sum }_{i} ( \frac{1}{\frac{{sasa}_{Metabolic {Enzyme}_{i}}}{μ}} * {V}_{Use of Metabolic {Enzyme}_{i}} ) .$$

78. The method of claim 76, wherein the coupling constraint is applied to one or more boundary conditions resulting in a change in environmental conditions for the organism.

79. The method of claim 66, wherein the coupling constraint is a component's efficiency of use.

80. The method of claim 79, wherein the efficiency of use is determined by relating the rate of use of a component by the integrated network to its rate of dilution or degradation; using properties of the component selected from the group consisting of: molecular weight, solvent-accessible surface area, number of catalytic sites, kinetic parameters of its catalytic and allosteric sites, and elemental composition or any combination thereof, and/or using the macromolecular composition of the cell.

81. The method of claim 80, where the component is a constraint selected from the group consisting of: the ribosome, RNA Polymerase, mRNA, tRNA, or metabolic enzymes.

82. The method of claim 81, wherein the mRNA constraint is selected from the group consisting of the ratio of mRNA dilution/mRNA degradation, the ratio of mRNA degradation/translation rate, and the ratio of mRNA dilution/translation rate, or any combination thereof.

83. The method of claim 82, wherein the efficiency of use for the mRNA is determined using mRNA half-life data, proteomics and transcriptomics data, a ribosome flow model, and ribosome profiling, or any combination thereof.

84. The method of claim 66, wherein the coupling constraints provide lower and/or upper bounds on flux ratios.

85. The method of claim 66, wherein the organism is microbial.

86. The method of claim 85, wherein the organism is selected from the group consisting of T. maritima and E. coli.

87. The method of claim 66, wherein the generation of a computational model comprises the addition of degradation and/or dilution reactions for network components and/or high-precision arithmetic by an optimization solver.

88. The method of claim 66, wherein model predicts the organism's maximum growth rate (μ*) in the specified environment, substrate uptake/by-product secretion rates at μ*, biomass yield at μ*, central carbon metabolic fluxes at μ*, and gene product expression levels at μ* or any combination thereof.

89. A model for determining the metabolic and macromolecular phenotype of an organism, comprising:
(a) a data storage device which contains an integrated knowledgebase of the organism;
(b) a user input device wherein the user inputs information regarding perturbation of the organism or the organism's environment;
(c) a processor having the functionality to compare the metabolic knowledgebase of (a) and the information from (b) to determine metabolic and macromolecular changes and to apply at least one coupling constraint thereto to determine the metabolic and macromolecular phenotype of the organism;
(d) a visualization display which displays the results of the analysis in (c); and
(e) an output which provides the metabolic and macromolecular phenotype of the organism.

90. The model of claim 89, wherein the integrated knowledgebase a growth rate-dependent calculation of a structural reaction using lipid content; metal ion content; energy requirements of the organism; dNTP requirements for the production of the organism's genome; ribosome production; information regarding the organism's genome, proteome, RNAs, metabolic pathways and reactions, macromolecular synthesis pathways and reactions, energy sources and uses, reaction by-products, protein complexes, reactions to post-translationally modify/functionalize protein complexes, macromolecular synthesis machinery, transcription units, lipid content, metal ion requirements, amino acid content, or any combination thereof.

91. The model of claim 89, wherein the perturbation of the organism or its environment is a change in genetic or environmental parameters.

92. The model of claim 91, wherein the change in genetic or environmental parameters is selected from the group consisting of, change in the composition of growth media; sugar source; carbon source; nitrogen source; phosphorous source; growth rate; ribosome production; presence, absence or change in concentration of an antibiotic; oxygen level; efficiency of macromolecular machinery; subjection to a chemical compound; genetic alteration; forced overproduction of a network component; introduction of heterologous genetic material; introduction of synthetic genetic material; inhibition or hyperactivity of at least one enzyme; protein engineering of specific chemical residues leading to modulated catalytic efficacy and any combination thereof.

93. The model of claim 89, wherein the metabolic and macromolecular changes are selected from the group consisting of: alterations in gene expression, alterations in protein expression, alterations in RNA expression, translation, transcription, pathway activation or inactivation, production of metabolic by-products, energy use, growth rate, proteome changes and transcriptome changes or any combination thereof.

94. The model of claim 93, wherein the metabolic by-products are selected from the group consisting of: acetate secretion and hydrogen production.

95. The model of claim 93, where in the proteome changes are selected from the group consisting of amino acid incorporation rate, protein production, macromolecular synthesis, ribosomal protein expression, expression of peptide chains, enzyme expression, enzyme activity, RNA to protein mass ratio, protein degradation, post translational protein modification, proteome fluxes, translation and protein expression profile or any combination thereof.

96. The model of claim 93, wherein the transcriptome changes are selected from the group consisting of: gene expression, transcription, functional RNA expression, transcriptome fluxes, transcription rate, gene expression profile or any combination thereof.

97. The model of claim 89, wherein the coupling constraints are applied to exchange reactions; maximal transcriptional rate for stable and mRNA; relaxing of the requirement that all synthesized components need to be used within the network; mRNA dilution; mRNA degradation or complex dilution; hyperbolic ribosomal catalytic rate;
ribosomal dilution rate; RNA polymerase dilution rate; hyperbolic mRNA rate; coupling of mRNA dilution, degradation and translation reactions; coupling of tRNA dilution and charging reactions; macromolecular synthesis machinery dilution rate; metabolic enzyme dilution rate or any combination thereof.

98. The model of claim 89, wherein the organism is microbial.

99. The model of claim 89, wherein the organism is selected from the group consisting of T. maritima and E. coli.

100. A model for performing a cost estimate analysis of producing a value added product in an organism, comprising
(a) a data storage device which contains a biochemical knowledgebase of the organism, costs associated producing the product and price of the product;
(b) a user input device wherein the user inputs parameters for producing the product;
(c) a processor having the functionality to compare the metabolic knowledgebase of (a) and the parameters from (b) to determine metabolic and macromolecular changes; apply at least one coupling constraint and perform cost benefit analysis thereto;
(d) a visualization display which displays the results of the analysis in (c); and
(e) an output which provides the cost estimate analysis.

101. The model of claim 100, wherein the parameters for producing the product is selected from the group consisting of: composition of growth media, sugar source, carbon source, growth rate, change in ribosome production, subjection to a chemical compound and genetic alteration or any combination thereof.

102. The model of claim 100, wherein the output is a graph or a chart depicting profitability estimate, estimates of key bioprocessing parameters such as feedstock consumption, feeding strategy, reactor volume and product formation.

103. The model of claim 100, wherein the product is a naturally occurring or a recombinant protein.

104. The model of claim 100, wherein the product is a molecule.

105. The model of claim 104, wherein the molecule is hydrogen or acetate.
